(19) United States
(12) Patent Application Publication
(10) Pub. No.: US 2024/0016173 A1
(43) Pub. Date: Jan. 18, 2024

(54) METHOD, APPARATUS, AND SYSTEM FOR EXTRACTING ESSENTIAL FLAVORANTS FROM PRODUCE

(71) Applicant: Trade Secret Chocolates, Indianapolis, IN (US)

(72) Inventors: Matthew Rubin, Indianapolis, IN (US); Adam Ambrecht, Kennesaw, GA (US); Jessica Halstead, Indianapolis, IN (US)

(21) Appl. No.: 18/465,941

(22) Filed: Sep. 12, 2023

Related U.S. Application Data
(63) Continuation-in-part of application No. 17/168,304, filed on Feb. 5, 2021, now Pat. No. 11,758,918.
Application No. 17/168,304 is a continuation of application No. 15/989,840, filed on May 25, 2018, now Pat. No. 10,925,294.
(60) Provisional application No. 62/511,720, filed on May 26, 2017.
(60) Provisional application No. 62/534,715, filed on Jul. 20, 2017.

(51) Int. Cl. A23G 1/00; A23G 1/06

(52) U.S. Cl. CPC A23G 1/002; A23G 1/0026; A23G 1/06; A23G 1/003

(57) ABSTRACT

A single ingredient dehydrated spice, having a monoterpene level of greater than 100 ppm and a water activity of 0.2-0.6. The single ingredient dehydrated spice is selected from the group consisting of ginger, turmeric, and garlic. For single ingredient dehydrated ginger spice, the monoterpene level is typically greater than 250 ppm and the water activity is typically between 0.2-0.3. The single ingredient dehydrated ginger spice is characterized by RGB values of R of 230, G of 203 and B of 141 and L*a*b values of L of 83, a of 1.834 and b of 35. The single ingredient ginger spice product is further characterized by an average gingerol content of 4588 μg/gr ginger and an average shogaol content of 3203 μg/gr ginger, and the novel ginger spice product may have a 6-gingerol content of 6200 μg/gr ginger and a 10-gingerol content of 675 and a 6-shogaol content of 3750 μg/gr ginger and a 10-shogaol content of 500 μg/gr ginger.

### CROSS-REFERENCE TO RELATED APPLICATIONS

This application is a continuation-in-part of co-pending U.S. patent application Ser. No. 17/168,304, filed on Feb. 5, 2021, which claimed priority to then co-pending U.S. patent application Ser. No. 15/989,840, filed on May 25, 2018, which claimed priority to then co-pending U.S. Provisional Patent Application No. 62/511,720, filed May 26, 2017, and to then co-pending U.S. Provisional Patent Application No. 62/534,715, filed Jul. 20, 2017, each of which are incorporated herein by reference.

### TECHNICAL FIELD

The present disclosure relates generally to the field of agricultural product processing, and, more specifically, to removing water from liquid and solid agricultural products such as herbs and spices. Aspects of the disclosure relate to food products from which water has been removed that retain one or more desirable properties or features associated with the starting food product and to systems and methods for removing adverse congeners, from food compositions, resulting in food products with improved organoleptic properties.

### BACKGROUND

Agricultural products such as natural or fermented juices and milk are typically concentrated for ease of transport and storage by removal of water via evaporation. Evaporation is done through the application of heat and/or vacuum to the food product. After removal of most of the water, juice concentrate is typically frozen and maintained at about −10 degrees Celsius until it is reconstituted into juice through the addition of water or pasteurized to maintain an aseptic environment. Products such as sauerkraut juice, where there is a need to maintain temperature conditions that ensure viability of microorganisms that are part of the fermented require dehydration under room temperature conditions which are not possible under current techniques of high temperature evaporation of agricultural products.

In addition to efficiently removing water, the evaporation and pasteurization process also indiscriminately degrades and/or removes vitamins, oils, and flavor essences from the product. It becomes necessary to reintroduce these elements back into the concentrate in order for the reconstituted product to approximate the flavor of freshly harvested produce.

While useful, current fresh juice concentrate and other agricultural product concentrates have several drawbacks. First, they must be kept refrigerated, thus consuming energy and having the drawback of being damaged if there is an interruption of power to the refrigeration equipment. Second, it is inefficient to remove and then reintroduce essential flavor elements and oils. Such reintroduction almost never results in a reconstituted product that matches the original freshly harvested product in flavor. Finally, the evaporation and pasteurization process can often damage the flavor elements by introducing them to temperatures high enough to break down and destroy some of the more fragile flavor elements and may introduce or result in the creation of byproducts that negatively impact the flavor profile of the end product.

Some products could also be best utilized in a dehydrated powder or crystalline form for use, or after reconstitution, if they could be converted into such dehydrated forms. Dehydrating plant and animal derived liquids to create dehydrated powders require the use of significant amounts of heat and chemicals. As an example, under conventional sugar processing, a massecuite supersaturated sugar solution is heated to between 104° F. to 176° F., seeded with microcrystals, and cooled to stimulate crystallization. The suspension is then centrifuged to discharge the glucose and other remaining molasses components, washed, and finally dried resulting in a crystalline sugar. Under the Massecuite method, molasses is heated above 104° F. to stimulate crystallization; however, temperatures above 104° F., more typically above 115° F. may organoleptically harm the supernatant or molasses quality. Similar issues apply to tree syrups, milk and milk alternatives like oat milk powders. The present method overcomes this limitation. Similar issues exist for other raw materials such as plant syrups and dairy products such as whey and other pharmaceutical and nutraceutical products.

Batch dehumidification, such as freeze drying for whole or partial agricultural goods, typically relies on pulling a vacuum on the food products (e.g., whole and cut plant and animal products—fruits, vegetables, herbs, spices, flowers, seeds, leaves, cannabis, hops, and meat) typically below 1 torr to forcibly pull moisture from the food products and/or baking at elevated temperatures, such as vacuum assisted hot air drying. While these processes may be fast and effective at removing the moisture, the resulting dried products tend to be far inferior to the source materials due to the indiscriminate drying process driving or cooking off desirable aromatics and volatile flavor compounds and introducing off flavor compounds, leaving the dried goods bland or altered and far less desirable than the original, undried product. What is needed therefore are methods and systems to remove moisture from such products without adversely affecting the inherent quality.

Cannabis is of great commercial interest for homeopathic and pharmaceutical applications. During cannabis production the flower bearing stems are typically detached from their roots and dried to a water activity of 0.55 to 0.62 prior to storage in order to preserve the CBD and THC content and prevent mold. Conventionally, cannabis is gradually dried in temperature and humidity-controlled rooms with a temperature of 18° C. to 25° C. and a relative humidity of 50% to 65%, more typically 58% to 62% for a period of three to five days, and then transitioned to a cure phase with a temperature of 18° C. to 25° C. at a reduced relative humidity of 50% to 62%, more typically 55% to 60% for an additional period of one to four days prior to packaging or long term storage at a relative humidity of approximately 60% and a storage temperature of approximately 20° C. Unfortunately, conventional methods may result in the degradation of the drying plants as a result of oxidation and mold or mildew during the long duration drying and curing phase of the process resulting in lost product. Losses may further be compounded by mold or mildew formation on dewpoint surfaces potentially in contact with the drying product. Another challenge with conventional cannabis drying method is the inability to effectively dehydrate/cure at temperatures below 15° C. While the vapor pressure of terpenes is lower at lower temperatures, conventional air conditioners ice over at low temperatures, limiting their effectiveness at dew points below 13° C. As a result, previous attempts to dehydrate at refrigerator temperatures have resulted in mold and loss of product. Relative humidity is a function of dewpoint and temperature: a lower dewpoint results in lower relative humidity. Conventional air conditioning units have a dewpoint of around 13° C. and risk icing over at a lower dewpoint; as such, there remains a need for a new technology that allows for a significantly lower dewpoint for a cannabis dehydration method without risking the apparatus or product. Similar challenges apply to products like hops and dehydrated meat products and the present technology addresses that need.

Flavoring compounds such as terpenes, are a class of generally unsaturated hydrocarbon compounds that are naturally present in cannabis. Terpenes strongly influence the aroma of cannabis and, more importantly, are said to have therapeutic properties that improve the cannabis user's experience. One such desirable property is known as the “entourage effect”, in which terpenes and cannabinoids synergize to enhance the psychoactive properties of the cannabis plant. As such, terpenes are generally desirable in the final cannabis product. However, many terpenes present in cannabis are volatile and experience natural biological degradation. At typical drying conditions (approximately 15° C. and 60% relative humidity), said terpenes naturally biologically degrade over two days. Similar flavor components are part of many other plant and animal products and here remains a strong and unresolved need for a new technology that retards the biological degradation of such flavor enhancing molecules. The present technology addresses that need.

A variety of seeds need to be preserved in agriculture by reducing moisture content for storage while preserving germination rates for future planting. Seed may be dried using natural drying, on floors or on the fields, but direct sun light can adversely affect seed germinability owing to high temperatures and ultraviolet radiation, especially if the moisture content of the seed is high. Artificial drying, also known as forced air drying, uses heated or unheated air that is forced mechanically through a layer of seed until drying is completed. The general recommendation for field crops is to dehydrate the seed at temperature of no more than 40° C. to 45° C. for moisture contents of not more than 18%, and preferably 5% for small seeds and 7% for large seeds, to prevent mold and insect damage while retaining viability. Rapid drying can cause the seed coat to split and seed viability may be decreased by drying at temperature above 45° C. What is needed therefore are alternative methods and systems, to rapidly reduce the moisture content of seeds under low temperature conditions to preserve the viability and germination ratio of seed. The present disclosure addresses these needs.

### BRIEF DESCRIPTION OF THE DRAWINGS

FIG. 1 is a cutaway section view of a pressure treatment system according to a first embodiment of the present invention.

FIG. 2 is a cutaway section view of a pressure treatment system according to a second embodiment of the present invention.

FIG. 3 is a cutaway section view of a pressure treatment system according to a third embodiment of the present invention.

FIG. 4A is a first perspective view of a pressure treatment system according to a fourth embodiment of the present invention.

FIG. 4B is a second perspective view of the pressure treatment system of FIG. 4A.

FIG. 4C is a front view of the pressure treatment system of FIG. 4A.

FIG. 4D is a first cutaway view of the pressure treatment system of FIG. 4A having a smooth interior wall.

FIG. 4E is a second cutaway view of the pressure treatment system of FIG. 4A having a raced interior wall.

FIG. 4F is a third perspective view of the pressure treatment system of FIG. 4A.

FIG. 5 is a schematic view of a pressure treatment system according to a fifth embodiment of the present invention.

FIG. 6A is a schematic view of a seventh embodiment pressure treatment system according to the present invention.

FIG. 6B is a schematic view of the system of FIG. 6A but having multiple treatment chambers.

FIG. 7A is a partial cutaway top plan view of an eighth embodiment pressure treatment system according to the present invention.

FIG. 7B is an exploded perspective view of FIG. 7A.

FIG. 7C is a partial cutaway top plan view of the system of FIG. 7A.

FIG. 8 schematically illustrates a ninth embodiment pressure treatment system of the present invention having a semi-permeable membrane between the condenser side and the fruit concentrate side.

FIGS. 9A-9H are various views of a first embodiment sealed pouch containing fruit juice concentrate produced via the above vacuum treatment systems.

FIGS. 10A-10B are views of a second embodiment sealed pouch containing fruit juice concentrate produced via the above vacuum treatment systems.

FIGS. 11A-11B are views of a third embodiment sealed pouch containing fruit juice concentrate produced via the above vacuum treatment systems.

FIGS. 12A-12G are views of a fourth embodiment sealed pouch containing fruit juice concentrate produced via the above vacuum treatment systems.

FIG. 13 is a side elevation view of a fifth embodiment sealed pouch containing fruit juice concentrate produced via the above vacuum treatment systems.

FIG. 14 illustrates a representative optical scale, of the kind provided with high-Brix analog optical refractometers, that correlates Brix values to water content.

FIG. 15 depicts the measured water activities of different inventive and comparative food compositions.

FIG. 16 depicts a graph of water activity versus shelf stability and flavor preservation.

FIGS. 17A-C illustrate a first embodiment of a vertical dehydration chamber.

FIGS. 18A-18F illustrate a second embodiment of a vertical dehydration chamber.

FIGS. 19A-19E illustrate an embodiment of a falling film evaporator system.

FIG. 20 illustrates an embodiment of a spray dryer.

FIGS. 21A-21D illustrate fruit nectar embodiments.

FIG. 22 illustrates dehydration methods for reducing mold.

FIGS. 23A-23J illustrates trough designs for evenly distributing nectar during dehydration.

FIGS. 24A-24C illustrate a flat tray drying system for agricultural material.

Like reference numbers and designations in the various drawings indicate like elements.

The details of one or more embodiments of the subject matter described in this specification are set forth in the accompanying drawings and the description below. Other features, aspects, and advantages of the subject matter will become apparent from the description, the drawings, and the claims.

### DETAILED DESCRIPTION

Before the present methods, implementations, final and intermediate compositions, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance may occur often, although there may be circumstances where it may not occur, and that the description includes instances where said event or circumstance occurs and instances where it does not.

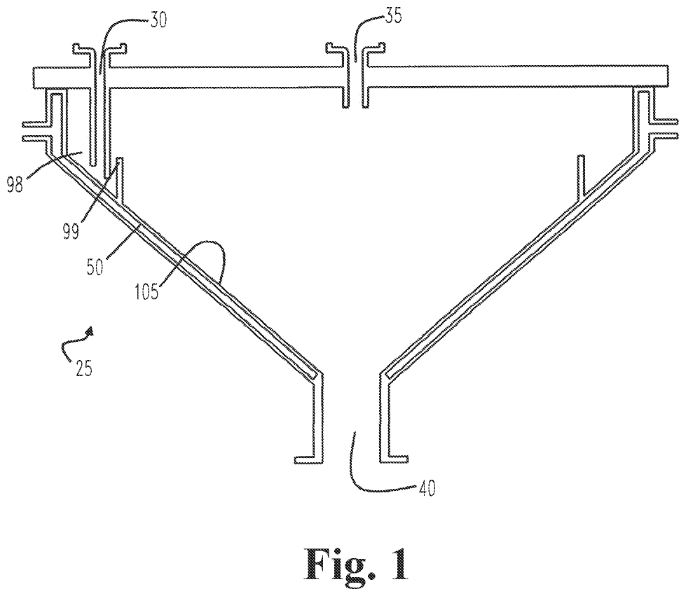

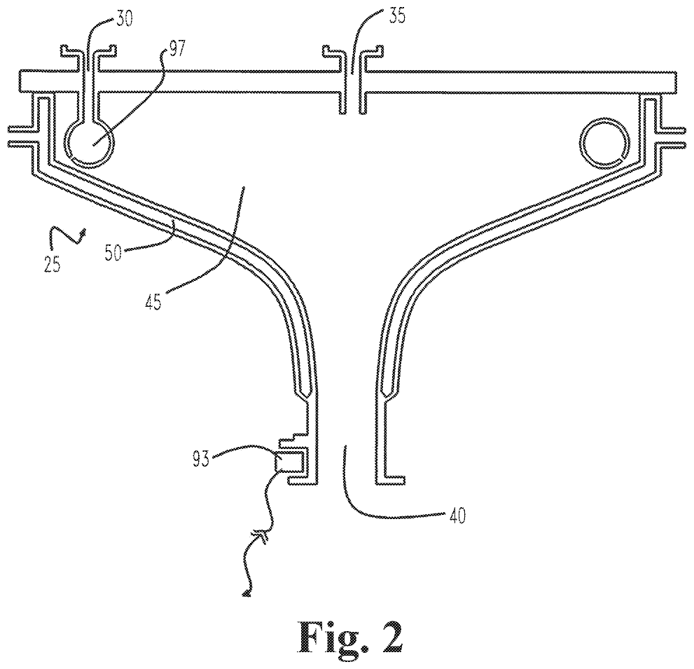

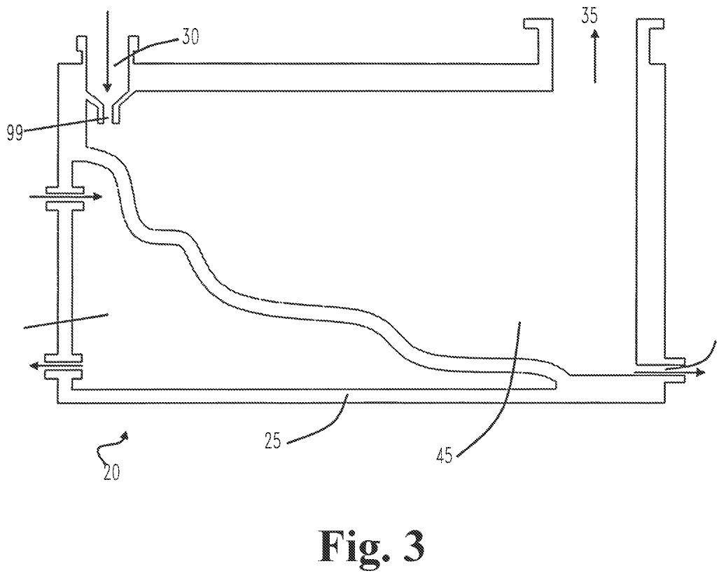

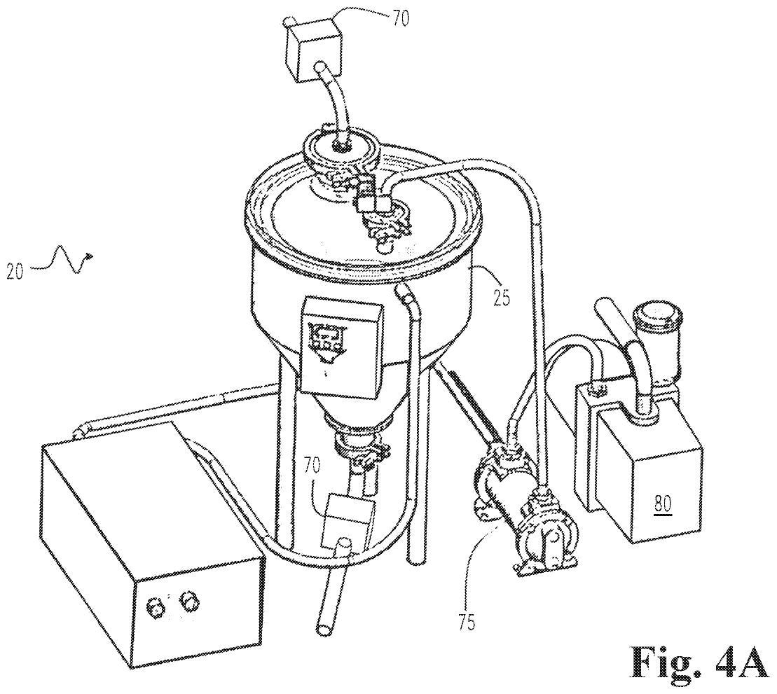

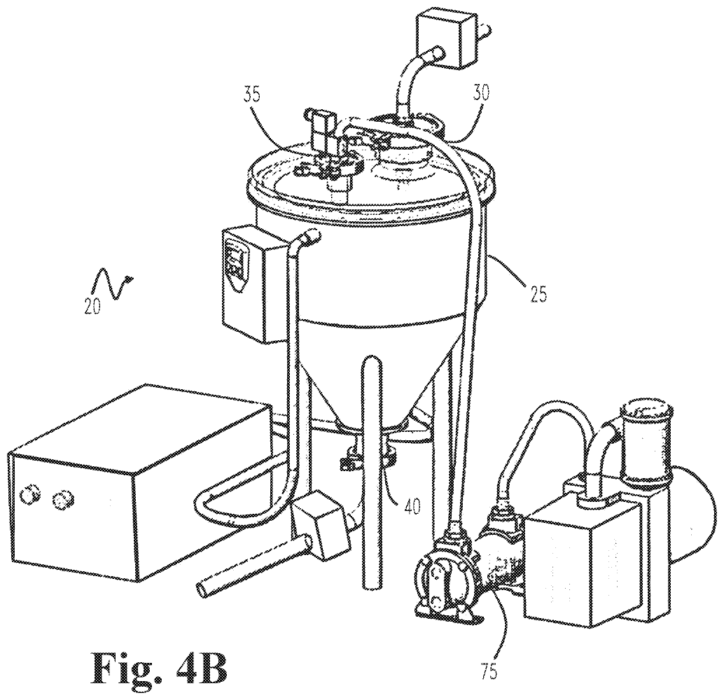

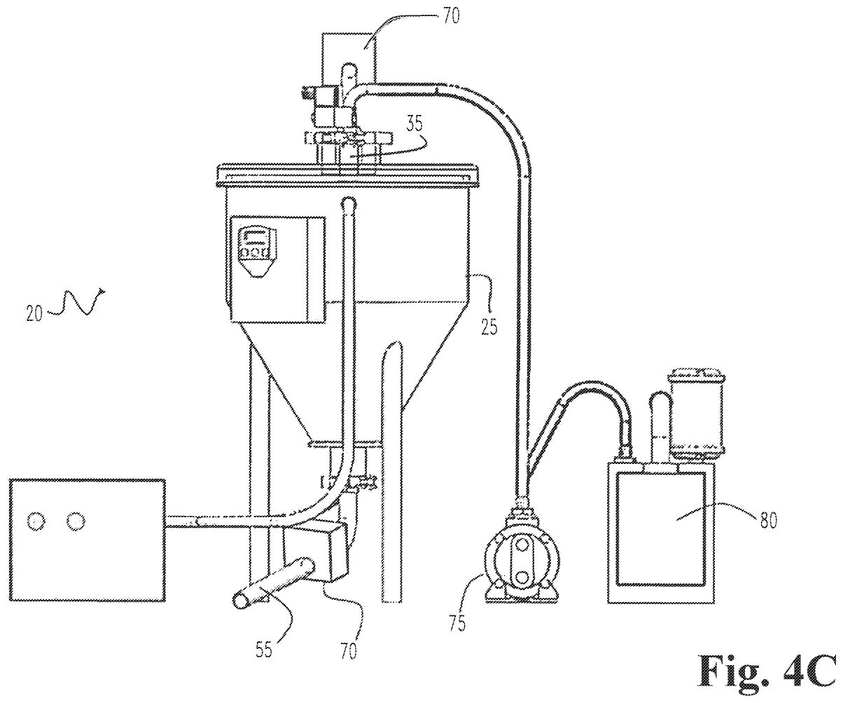

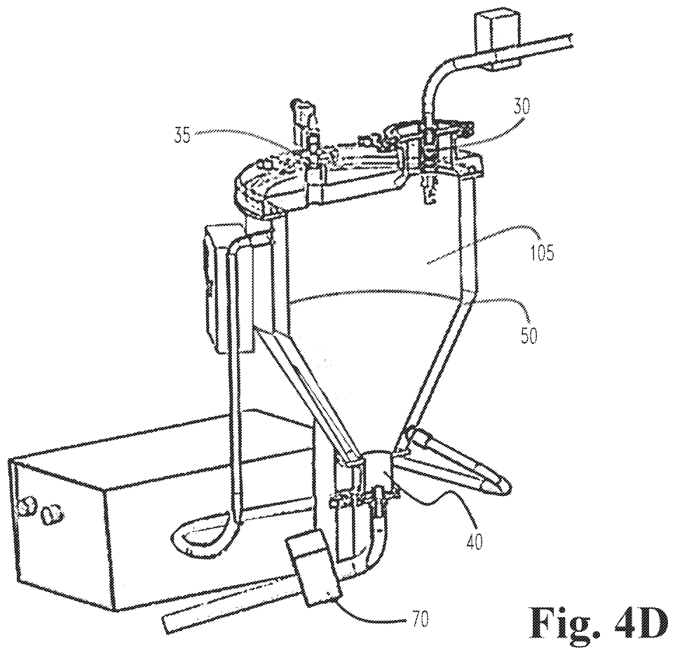

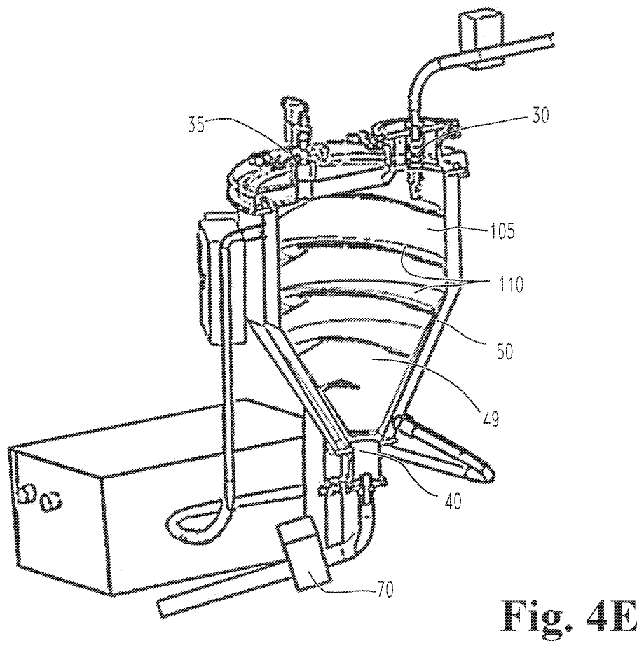

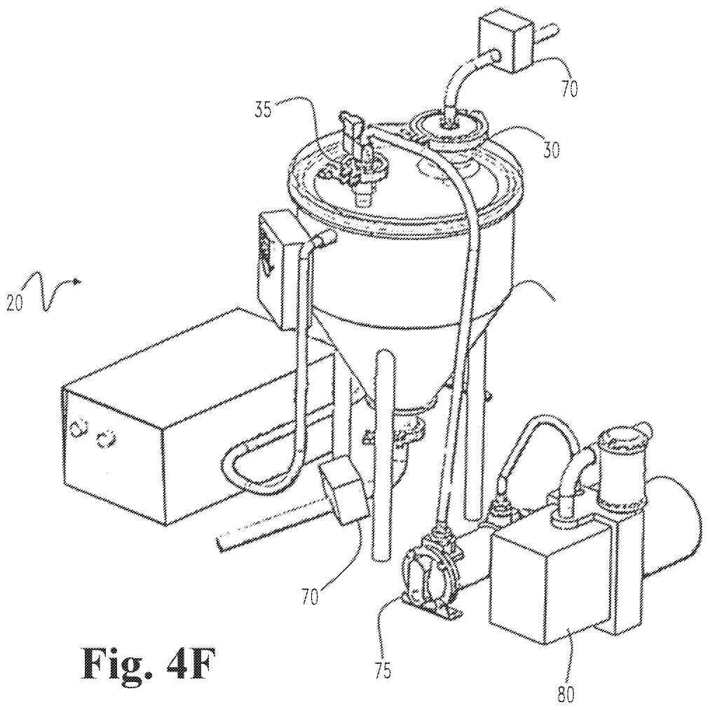

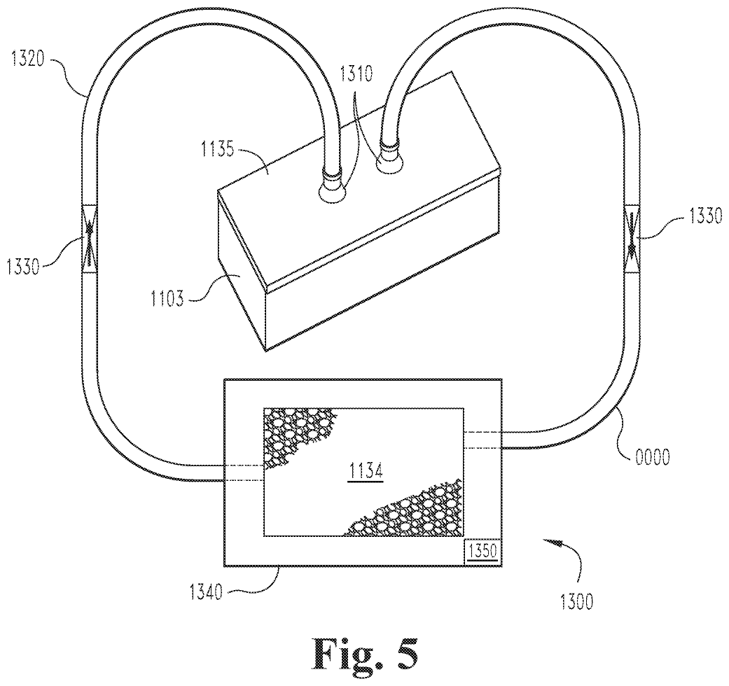

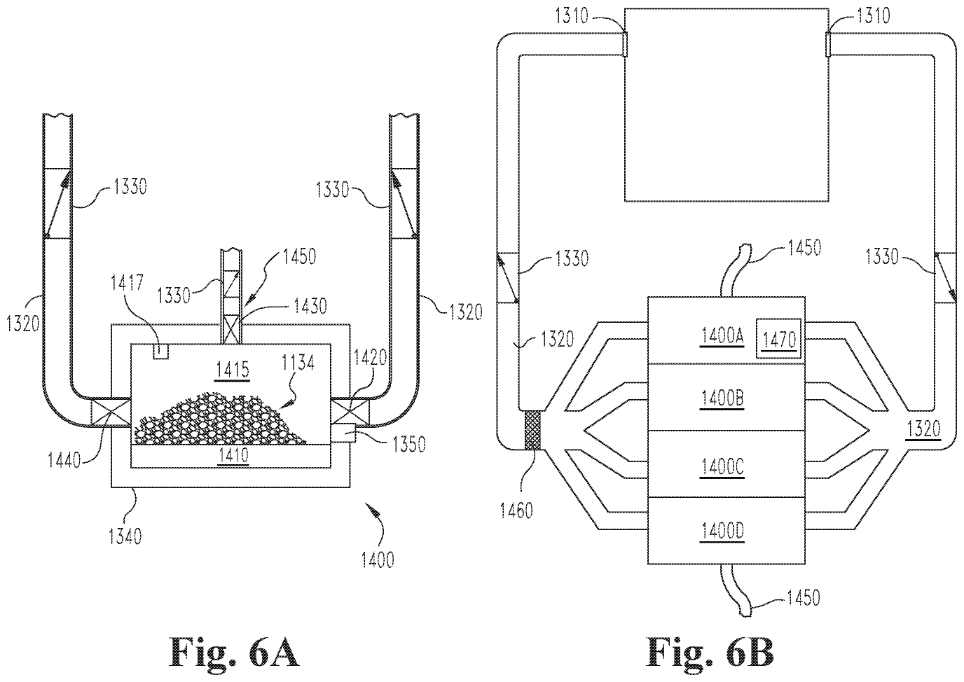

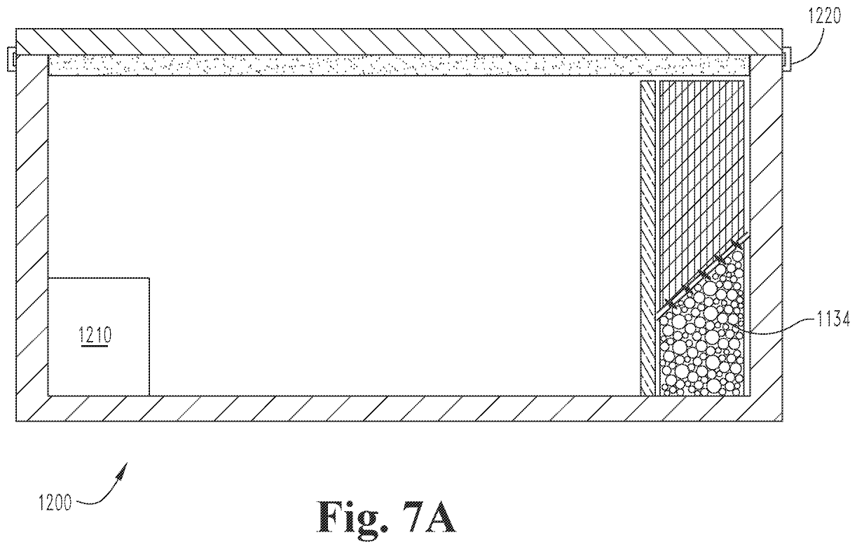

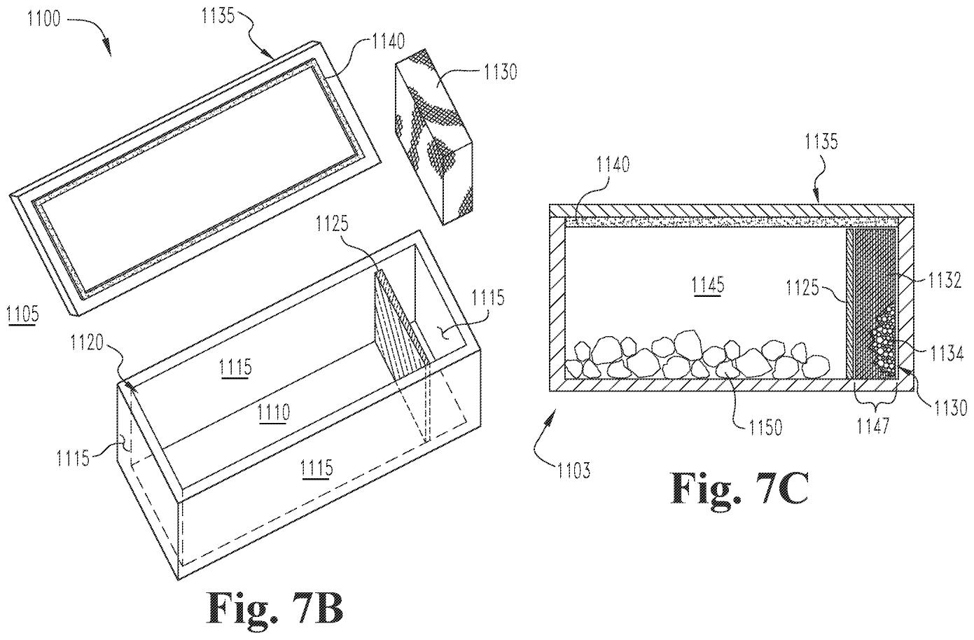

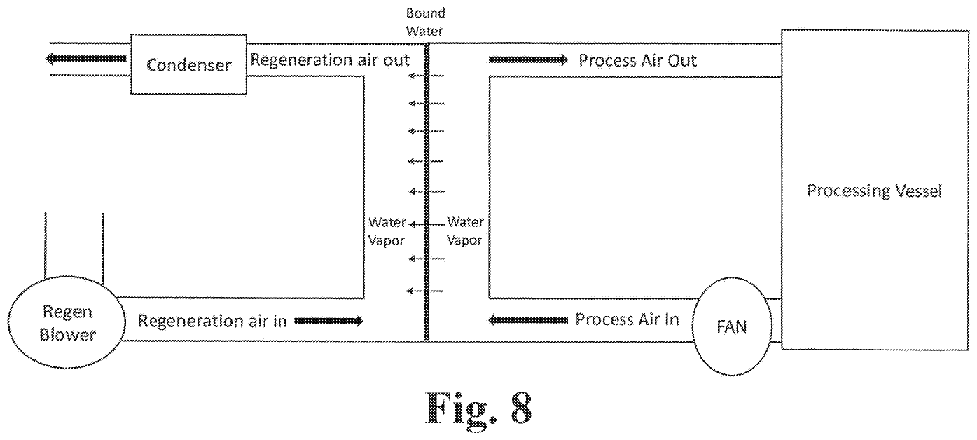

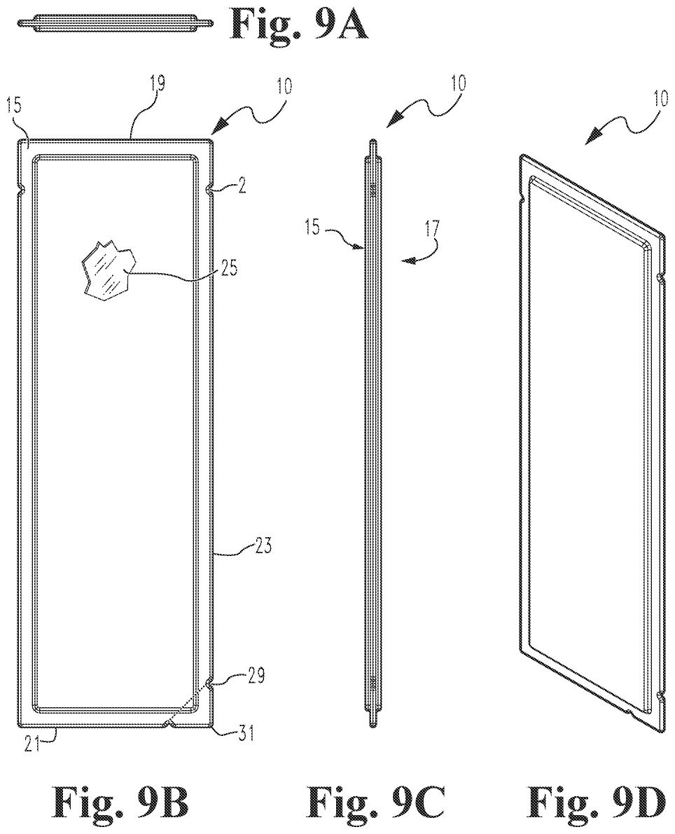

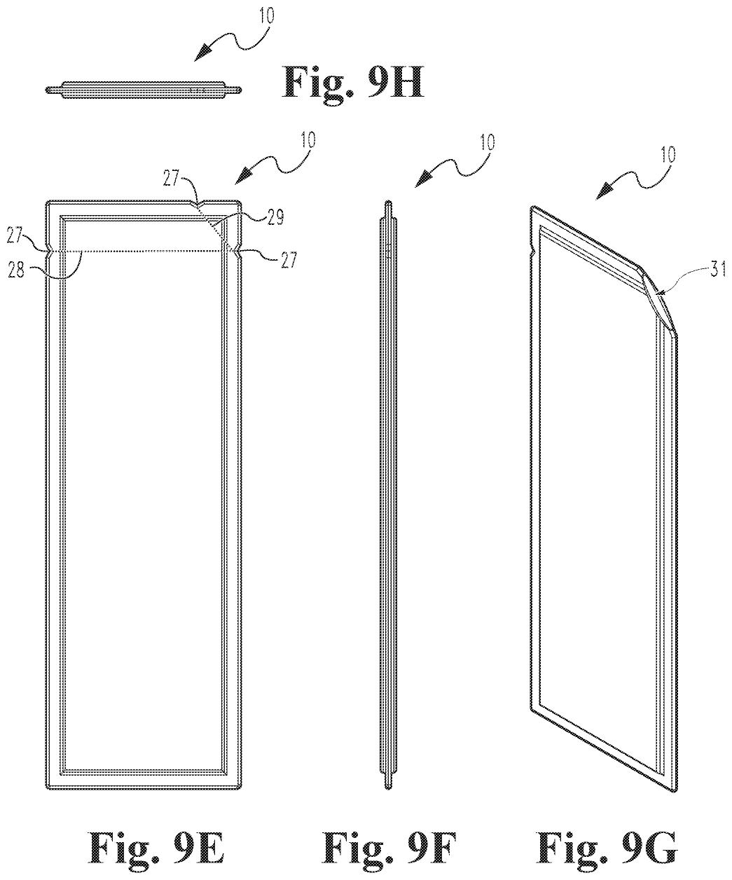

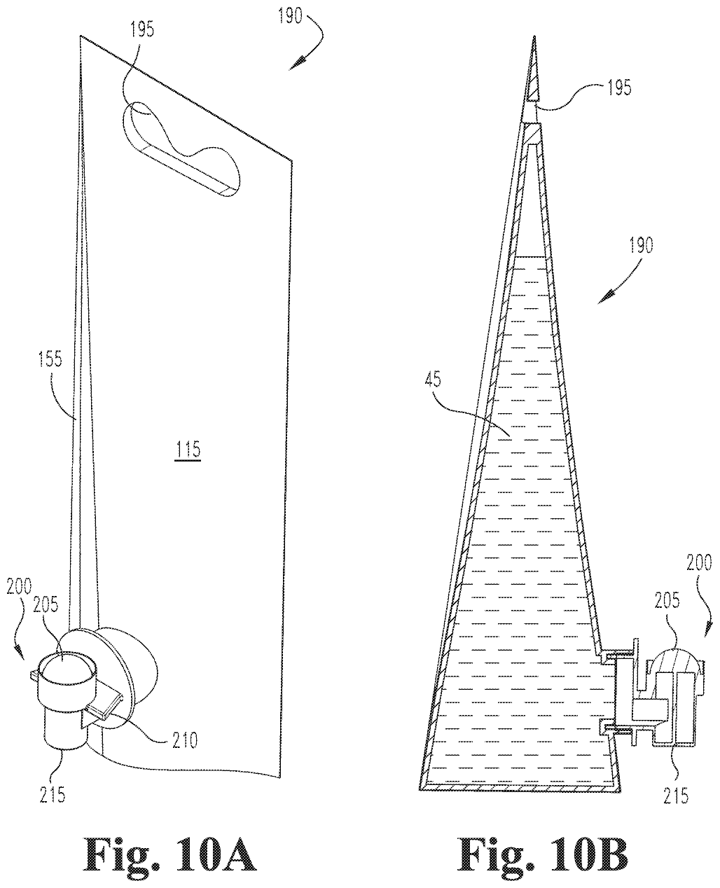

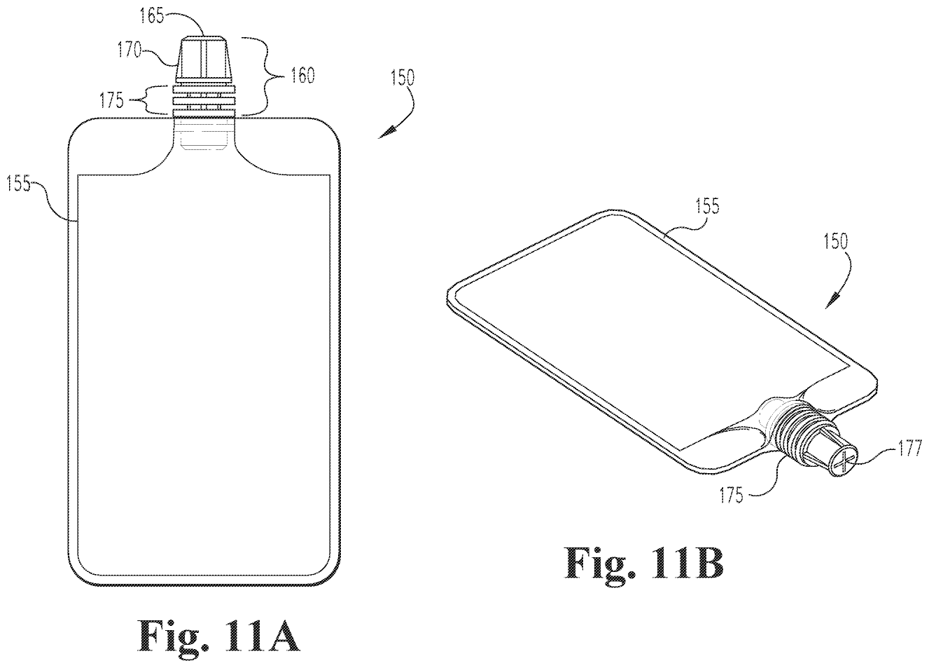

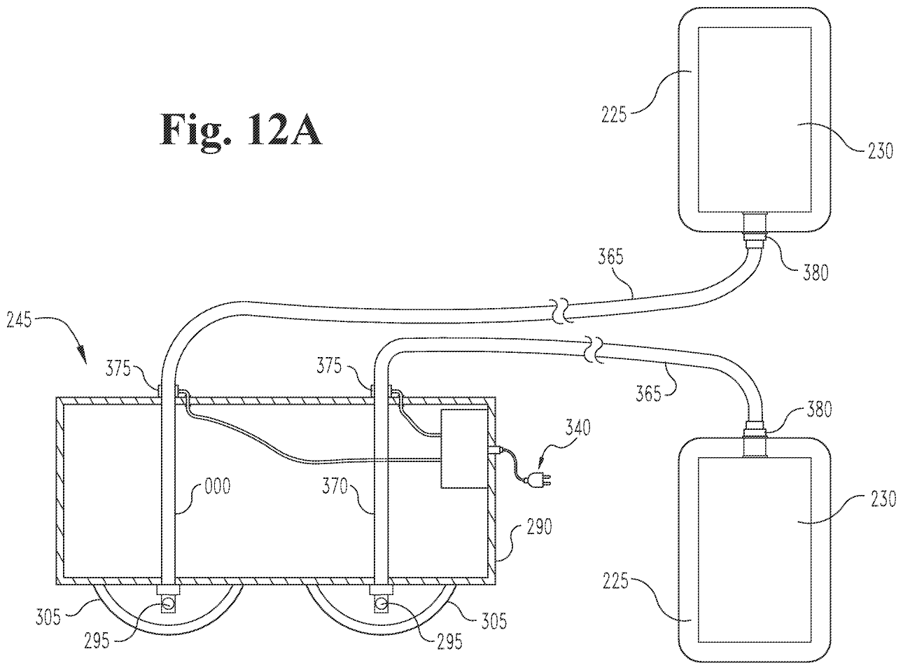

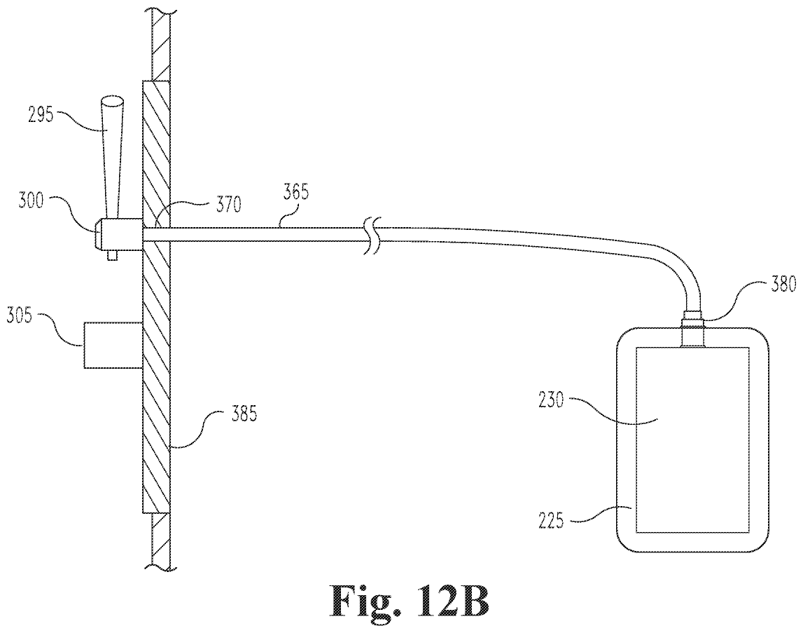

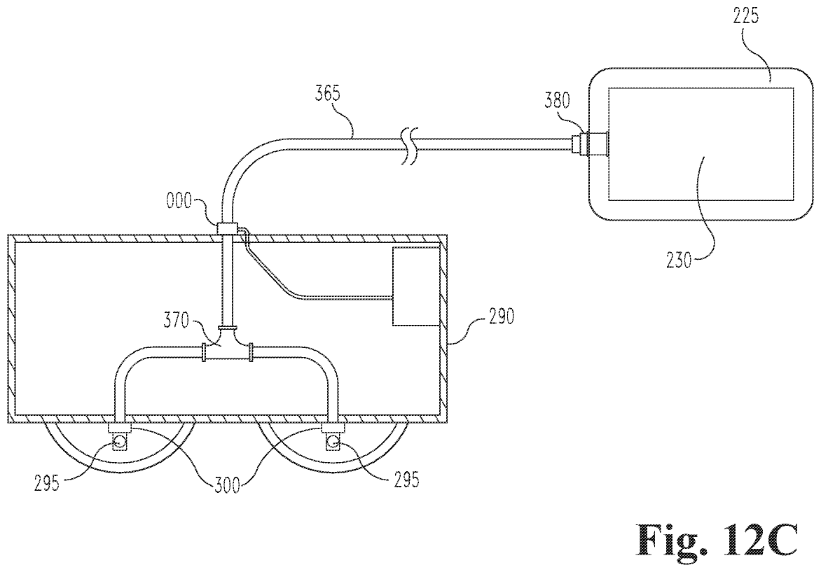

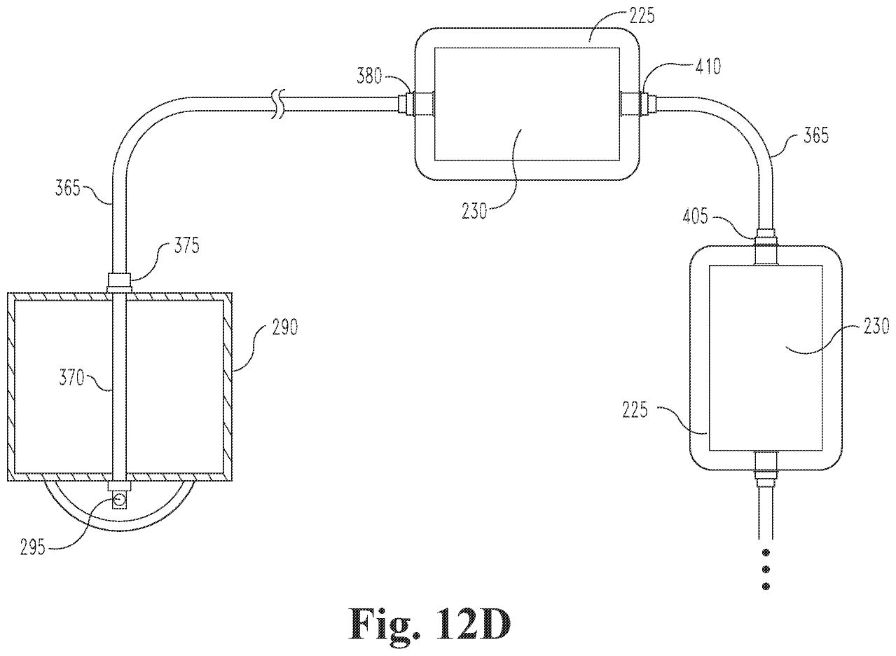

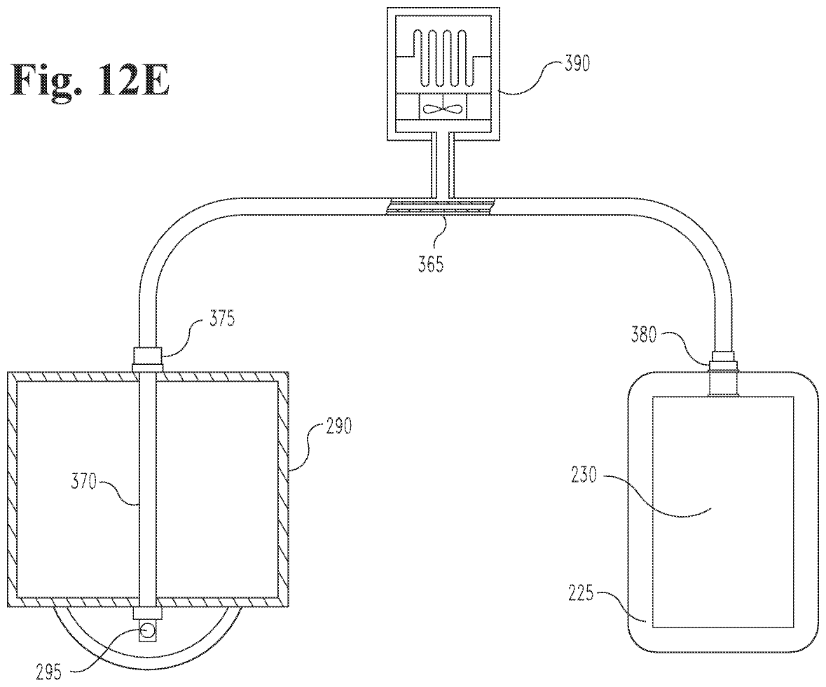

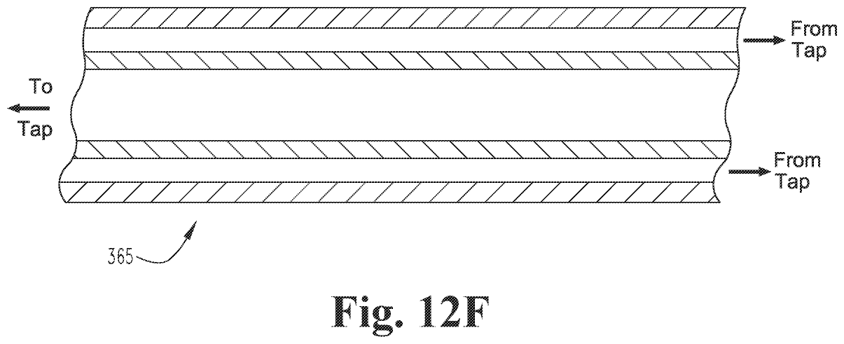

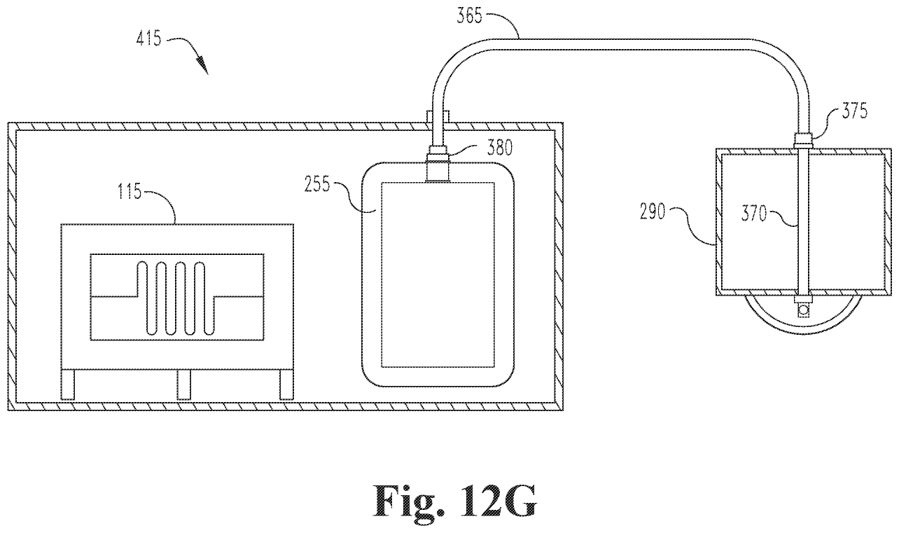

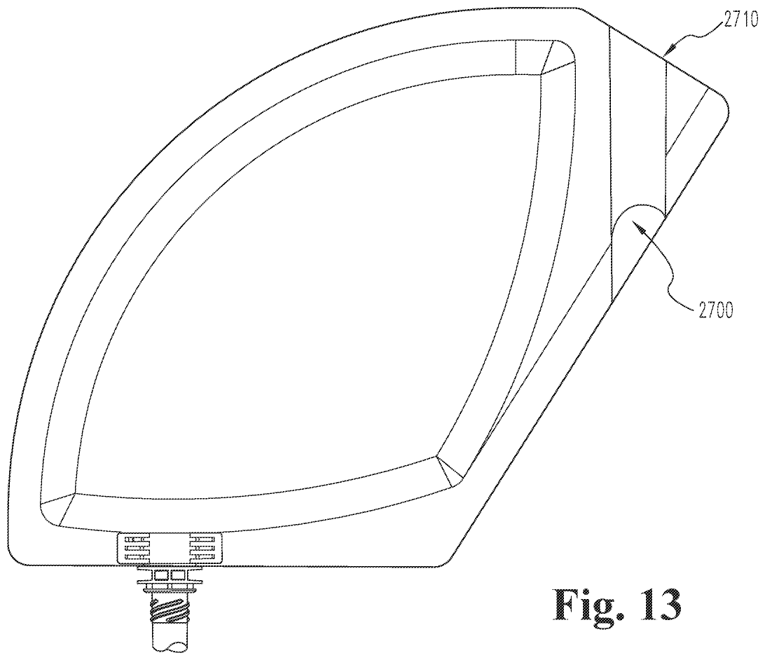

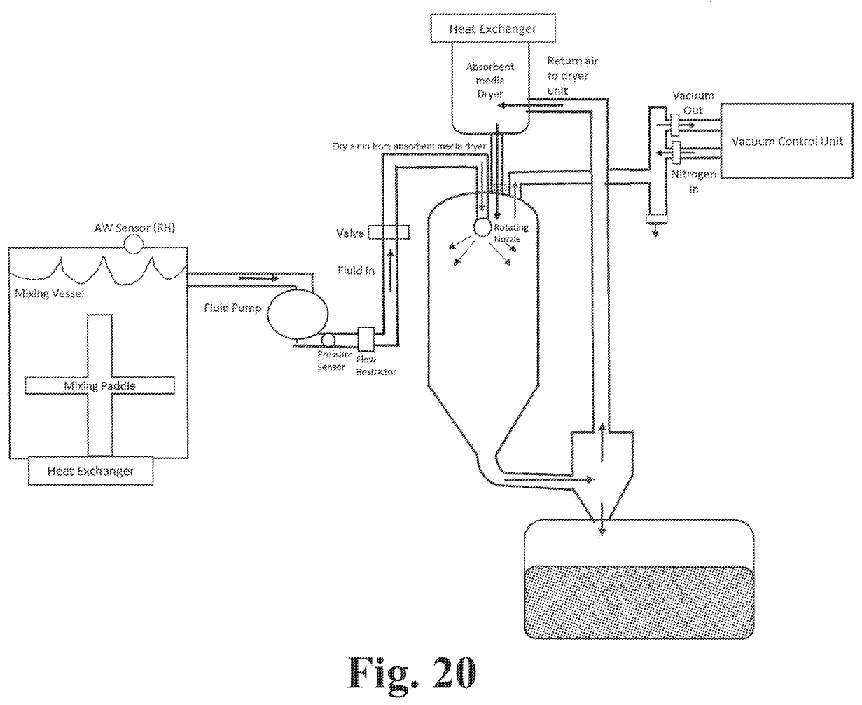

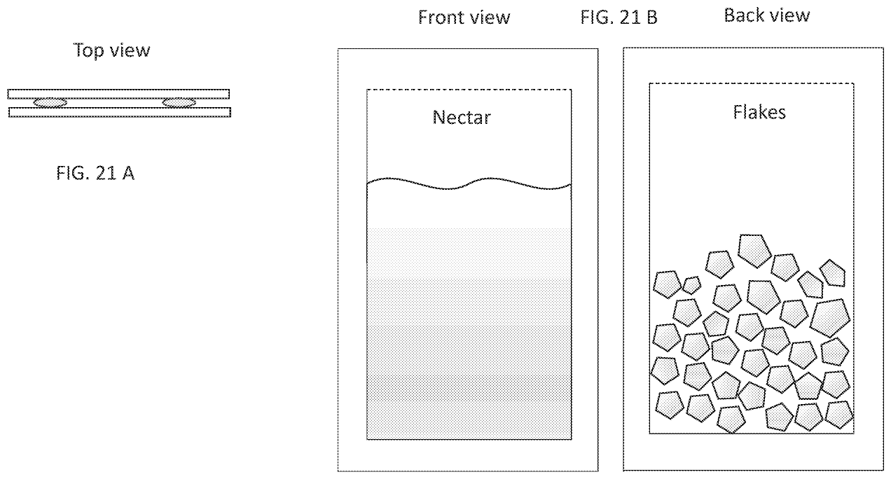

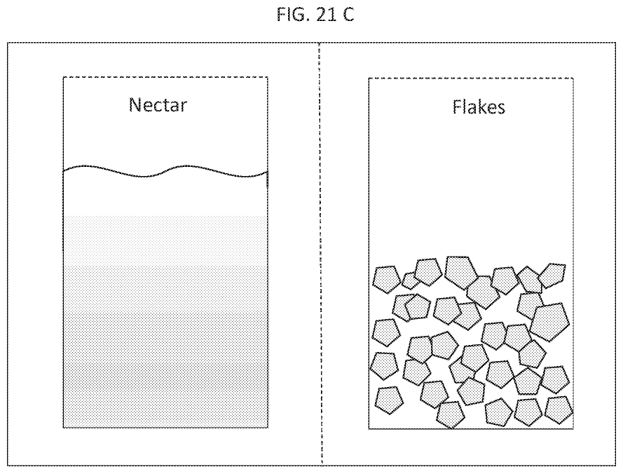

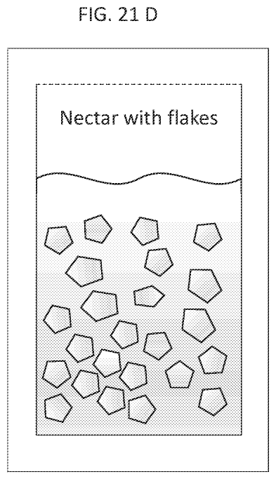

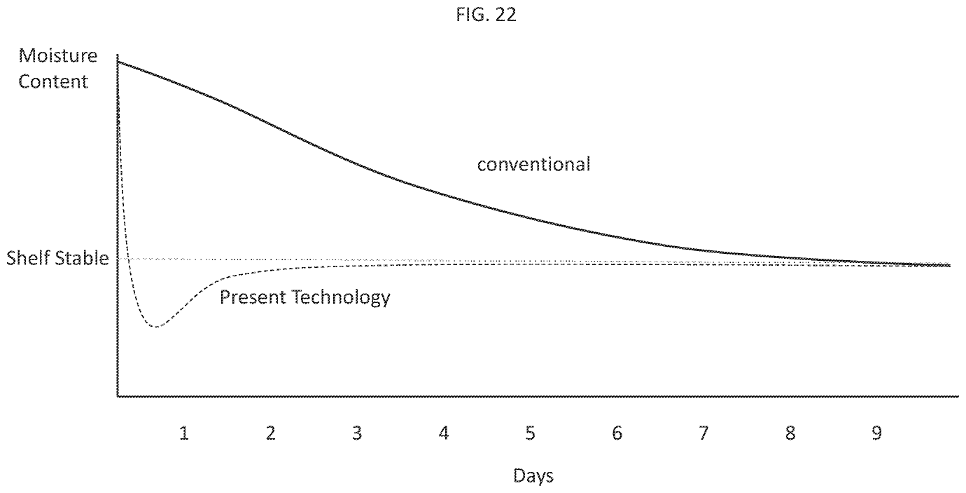

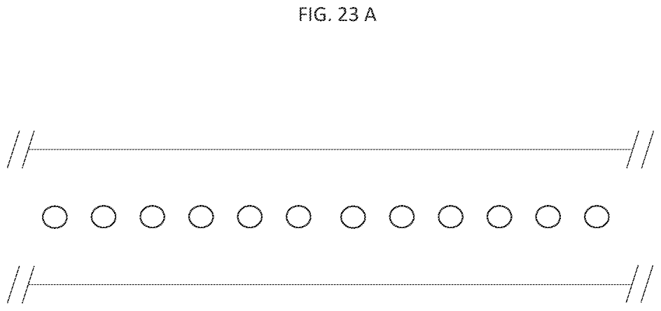

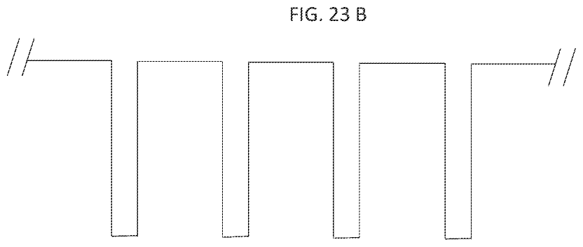

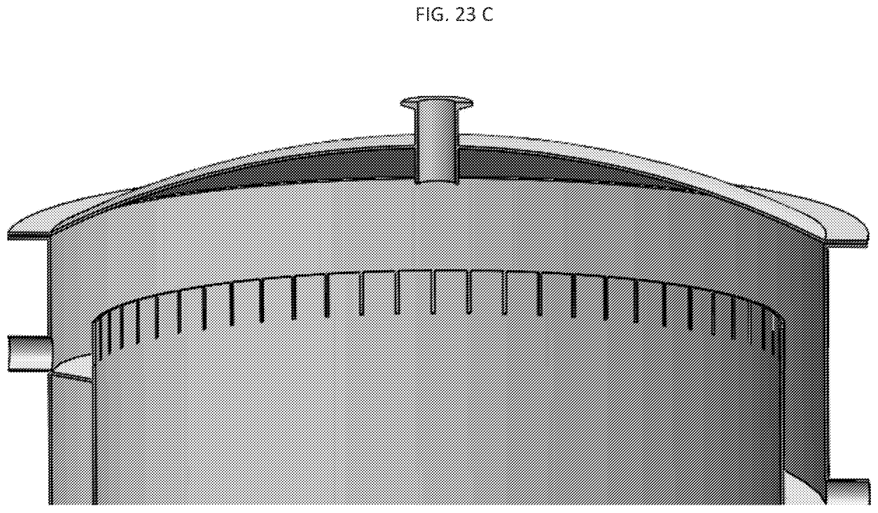

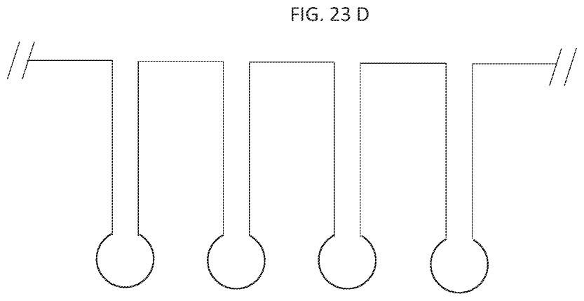

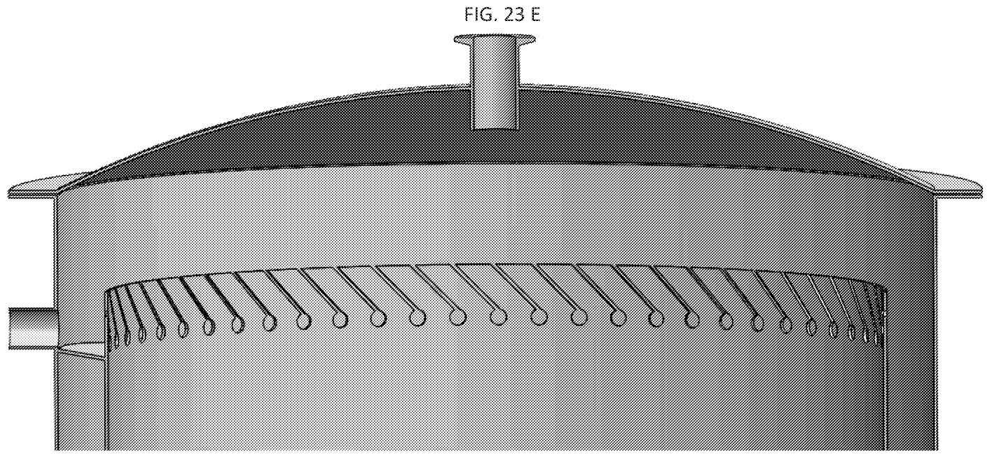

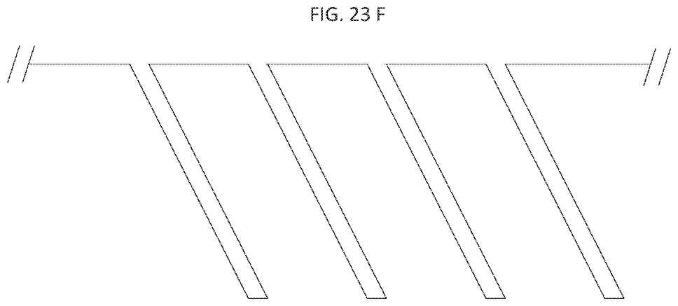

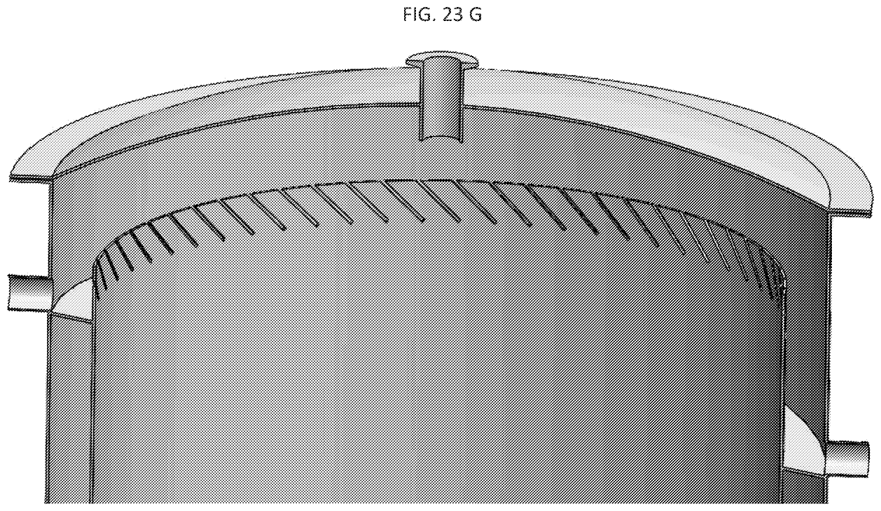

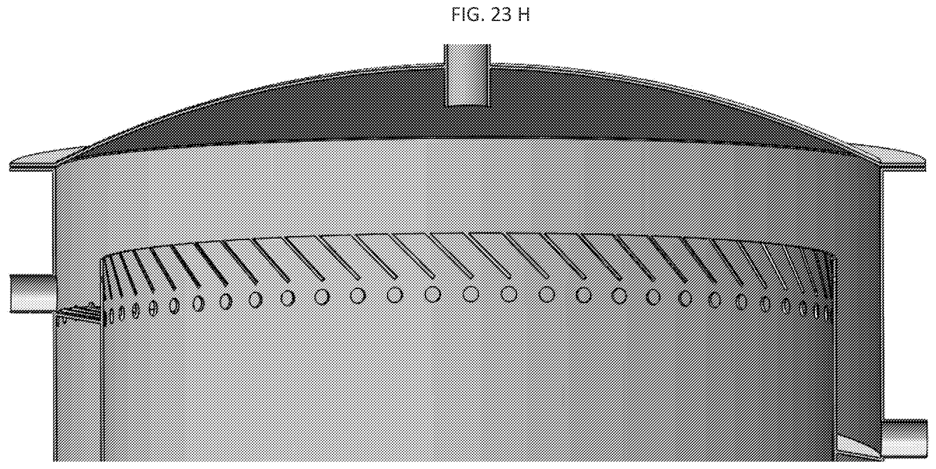

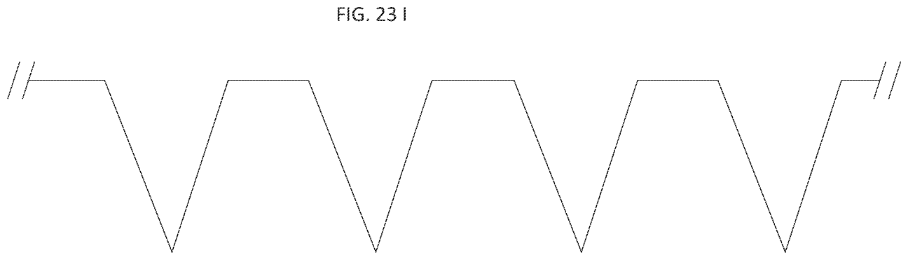

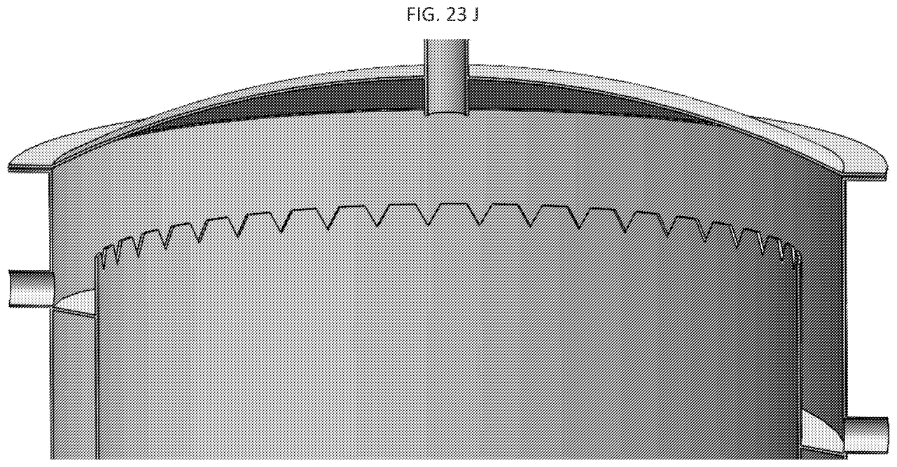

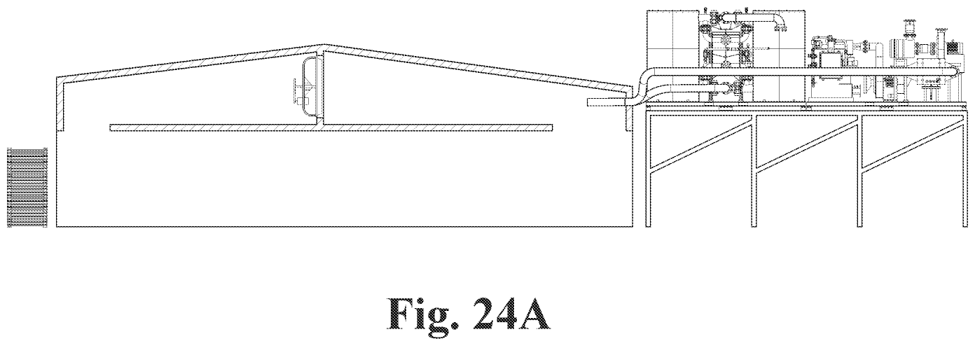

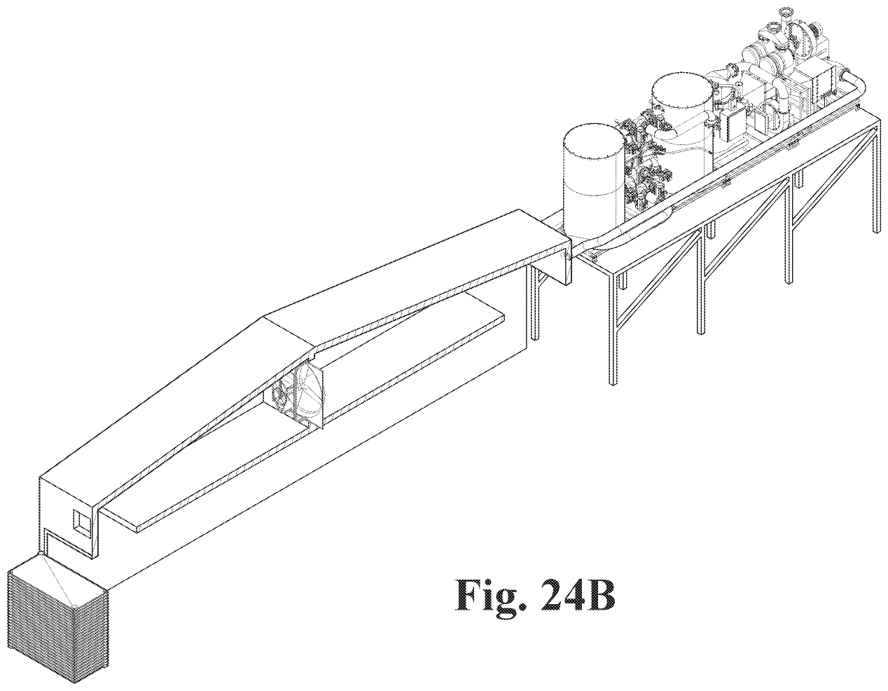

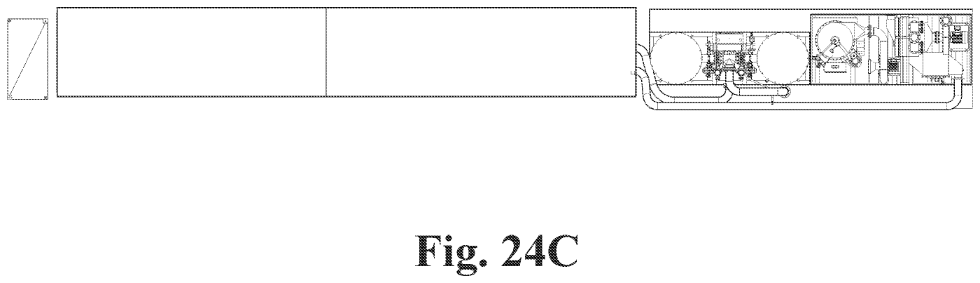

Drawing FIGS. 1-24C depict various non-limiting embodiments of the present novel moisture removal system, its application to condensing fruit juices and/or creating dry flake, powder or crystalline forms of agricultural products and/or dehydrating solid or cut plant and animal based agricultural products, and/or fermented agricultural products, while retaining virtually all of the flavorants, essential elements, oils and vitality, of the original product and/or implementations related to dehydration of seeds for storage while maintain viability, in various example embodiments. Embodiments of the moisture removal system typically allow precise and efficient moisture removal from materials without adversely affecting the inherent quality of those materials, which is useful for the processing of flavor sensitive materials and compounds, such as fruit juices, liquid to solid product conversion, solid food products, extracts and essences, and other agricultural products and alternatively maintaining viability of seeds. Elements such as flavor essences, oils, vitamins, and the like are not removed with moisture, and so remain in their original quantities and original ratios relative to one another, while some chemicals products that produce off-flavors are preferentially removed from the treated products. Consumers often describe the transient experience of flavor in three unique phases including the ‘start,’ ‘peak,’ and ‘finish,’ which follow the corresponding sensory mechanisms of taste, smell, and residual detection and molecular degradation. Each phase is dominated by specific sensory sources, and an over- or under-expression of flavor and aroma during each phase may determine the overall desirability of the food. Consumers initially begin with taste of the food or beverage on the tongue where they may experience a combination of tasting notes that may include sweet, sour, bitter, savory, fatty, and salty. Tasting notes are detected by multiple types and variants of receptors (commonly referred to as taste buds) primarily found on the tongue. While some tasting notes are governed by a single receptor type, other tasting notes, such as bitterness, may be perceived through a combined signal of more than twenty-five receptor variants. An over- or under-expression of any one of the receptors may cause alarm to the consumer and thereby decrease the food's perceived positive organoleptic properties. As a result, consumers often refer to organoleptically desirable foods or beverages as ‘balanced’.

During consumption, taste may almost immediately be followed by smell, often described as the peak, as volatile aromas travel back down the throat and up into the olfactory cavity. The additional time needed for volatile compounds to travel from the oral cavity to the olfactory cavity creates the perceived time lag between the start and peak of a consumer experience. Smell is transmitted primarily through G-protein coupled olfactory receptors, with nearly one thousand different olfactory receptors responsible for smell, each which is highly sensitive to a particular molecule. Olfactory receptors are particularly selective to esters, such as ethyl acetate, a certain class of organic molecule that consumers often refer to as ‘essences’. The senses of taste and smell differ in their sensitivities. For comparison, tastes may typically discern concentration changes in parts-per-hundred, while smell may discern changes in concentration of as little as parts-per-million. As with taste, the organoleptic properties of a food or beverage may be determined by the balance of smell experienced through a combination of receptors. An over- or under-expression of any one receptor may cause the perceived balance of a food or beverage to decrease, resulting in a less desirable product.

The finish in foods and beverages is more complicated than the start or the peak. During the finish, molecules in the oral cavity begin to degrade through various mechanisms, such as hydrolysis and catalysis, volatile compounds promoted through the heat and convection in the oral cavity continue to evaporate from the oral cavity and travel to the olfactory cavity, and the cellular equilibrium of the oral cavity itself begins to alter as a result of the food or beverage. Foods or beverages that drastically alter the oral cavity during consumption often have a finish described as ‘sharp’, ‘hot’, or ‘biting’ (examples are hot sauce, shelf-stable condiments, or spirits). In low concentrations, these undesirable experiences may be described as ‘rough’, ‘heavy’, astringent, full of tannins, or the like. On the other hand, foods and beverages that maintain the taste, smell, and cellular equilibrium as they dilute on the palate are often referred to as having a ‘fresh’, ‘savory’, ‘crisp’, ‘smooth’, ‘delicate’, or ‘refined’ finish, and are typically considered more desirable.

As foods or beverages rot, bacteria and fungi digest the composition and produce byproducts, and the ability to detect rotten food is key to survival. Fermentation is an anaerobic form of rotting that is often used to preserve some of nutrients in foods and beverages, while aiding in the digestion and absorption of other nutrients. Some examples of desirable fermentation are the Lactobacillus digestion of cabbage in the production of Sauerkraut, chili fermentation in the production of hot sauce, and Saccharomyces cerevisiae digestion in the production of wine, beer, and spirits. Fermentation stops once all nutrients are digested, or more commonly, once the fermentation byproducts reach levels toxic to microorganisms. As a result, remaining nutrients may be preserved without fear of further biological degradation resulting in a shelf-stable food or beverage. Unfortunately, since fermentation is also a form of rotting, some fermentation byproducts decrease the desirability and organoleptic properties of foods or beverages due to their association with rotten food. Younger consumers often have more severe aversions to these byproducts, and sensitivity tends to decrease as consumers age. Consumers may also grow a tolerance to certain fermentation byproducts through repeated exposure, leading to the ‘acquired taste’ often associated with certain cheeses, spirits, and fermented cabbage.

Removal of some or all of the unwanted compounds in a food composition may be desired because the unwanted congener(s) are inherently toxic or because the unwanted congener(s) (in their present concentration(s)) contribute an unpleasant or negative organoleptic experience. One congener found in food compositions, particularly those that have undergone fermentation during storage or manufacturing processes, is ethyl acetate (also referred to herein as “EA”). Ethyl acetate is an ester molecule formed through the esterification of ethanol (alcohol) and acetic acid (vinegar). Ethyl acetate is also a polar, aprotic solvent with amphipathic properties. As a result, consumers are highly sensitive to small changes in ethyl acetate concentration both in the olfactory reception, which may cause a rough peak and sharp bite in the finish, and in the cellular equilibrium which may cause a solvent-like burn on the rear of the oral cavity. In fact, it is the ethyl acetate concentration that controls the perceived “bite” characteristic in the peak and finish of fermented foods and beverages. Since ethyl acetate also serves as a polar-aprotic solvent during consumption, it may aid in the detection of other flavor molecules. As a result, an ethyl acetate concentration too low may inhibit a consumer's ability to detect other desirable flavors and aromas.

Proper balancing of ethyl acetate concentrations at the parts-per-million levels is necessary to optimize the organoleptic properties of foods and beverages. For example, ethyl acetate in very low quantities operates on certain combinations of specialized G protein-coupled olfactory receptors to yield a pleasant or enhanced organoleptic experience, while at greater concentrations ethyl acetate operates on those same receptors to generate an unpleasant or negative organoleptic experience. Such a negative organoleptic experience may be characterized by a bite, throat burn, bitterness, a metallic taste, a lingering aftertaste, head recoil, involuntary shudder, triggering of the gag reflex, and combinations thereof. Reduction or removal of ethyl acetate may eliminate these negative organoleptic experiences, and reduction of ethyl acetate concentration to certain levels may actually enhance the already desirable organoleptic properties of the food product.

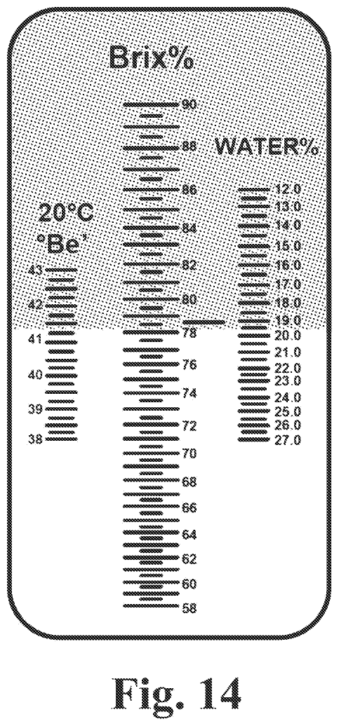

Food compositions can be characterized in terms of their water content, Brix, and/or water activity. For example, shelf-stable juice typically is concentrated to about 10% to 23% water content, with a water activity of less than 0.60, and with above about 77° Brix. Herein, the water content for compositions having at least 10% water content can be measured by placing a sample sufficient to cover the viewing lens of a high-Brix portable analog optical refractometer at 20° C., and viewing the correlative optical scale provided with the high-Brix analog optical refractometer. FIG. 14 illustrates a representative correlative optical scale of the kind provided with high-Brix analog optical refractometers that can be used to determine the water content that corresponds to a given measured Brix value. Herein, water activity values refer to values measured by filling the bottom of a Rotronic PS-14 sample cup with sample sufficient to cover the bottom of the cup and placing the sample in a Rotronic HP 23-AW handheld meter with a HC2-AW probe at 21° C., where the water activity can be determined by determining the partial pressure of water vapor in the sealed sample volume until an equilibrium is formed (ROTRONIC is a trademark registered to Rotronic AG Aktiengesellschaft SWITZERLAND Grindelstrasse 6 CH-8303 Bassersdorf SWITZERLAND, registration number 5139539). As a further example, a typical juice concentrate is in the 55° to 70° Brix range with water content around 30-60 percent and must remain frozen until reconstitution.

Traditional concentration of juice by evaporation through application of heat and/or vacuum efficiently removes water but also removes flavorants, vitamins, and essential oils along with the water. Essences may be collected and refined from the volatile stream, stored, and reintroduced (enrichment) before or during reconstitution of the concentrate, but these processes add steps and expense to the process.

In some embodiments, the method of the present disclosure removes water from juice and other agricultural products without the necessity of applying heat and/or vacuum to the food product. Most freshly squeezed or harvested juice is about 80% to 90% water, with a Brix reading typically between 5° to 20° Brix, and a water activity of about 0.85. Herein, Brix values refer to values measured by placing a sample sufficient to cover the viewing lens of a high-Brix portable analog optical refractometer at 20° C. Suitable analog optical refractometers include, but are not limited to, those used for measuring honey sugar content in the field (e.g., outside of a laboratory environment). Other methods to determine Brix are known in the art and include, but are not limited to, specific gravity measurements correlating density of a known volume to Brix, digital optical refractometry, and infrared absorption. Although it is to be understood that, as they are referred to herein, water activity values refer to values measured as described above (i.e., by placing a sample sufficient to cover the viewing lens of a high-Brix portable analog optical refractometer at 20° C.), it is also to be understood that water activity values refer to the partial pressure of relative humidity of the air immediately above a sample. For example, a sample having a water activity of 0.80 has a vapor pressure 80% of that of pure water.

Some embodiments of compositions described herein are defined as being shelf-stable. As used here, “shelf-stable” compositions refer to compositions that remain biostatic and do not support the cultivation of additional fungus, yeast, and/or bacteria (as measured by concentration counts of fungus, yeast, and/or bacteria in aged samples of the composition compared to initial sample(s) of the composition) for at least 6 months following open environmental exposure of the composition for at least 60 seconds with an open top at 21° C. before resealing and storing at 21° C. As a non-limiting example, honey with a water activity of less than 0.60, with 15 to 23 percent water, and with 75° or more Brix is a shelf-stable composition.

Embodiments of methods disclosed herein avoid the removal of flavorants and the like during the condensation process. In some embodiments, where the disclosed method is applied to juice, the product of the disclosed method is a fruit juice concentrate having a viscosity of from 1,000 to 25,000 Centipoise at 21° C., such as from 2,000 to 20,000 Centipoise at 21° C., from 2,500 to 15,000 Centipoise at 21° C., or from 3,000 to 12,500 Centipoise at 21° C., having a water activity of less than 0.60, such as from 0.5 to 0.595 or from 0.55 to 0.59, having a water content of from 10% to 23%, such as from 15% to 20% or from 17% to 19%, and having 76° Brix or more, such as from 78° to 83° or 79° to 81°. For the avoidance of doubt, it is to be understood that the viscosity, water activity, water content, and Brix values refer to those measured using the techniques described elsewhere herein (i.e., for Brix values, by placing a sample sufficient to cover the viewing lens of a high-Brix portable analog optical refractometer at 20° C.; for water content, by placing a sample sufficient to cover the viewing lens of a high-Brix portable analog optical refractometer at 20° C., and viewing the correlative optical scale provided with the high-Brix analog optical refractometer; and for water activity, by filling the bottom of a Rotronic PS-14 sample cup with sample sufficient to cover the bottom of the cup and placing the sample in a Rotronic HP 23-AW handheld meter with a HC2-AW probe at 21° C., then determining the water activity by determining the partial pressure of water vapor in the sealed sample volume until an equilibrium is formed). Viscosity is determined through qualitative comparison against standardized references. For example, in some embodiments, application of embodiments of the disclosed method to juice results in a fruit juice concentrate having at least 78° Brix, a viscosity of 5,000 to 20,000 Centipoises at 21° C., and a water activity of less than 0.60.

In some embodiments of fruit juice concentrates prepared according to methods of the disclosure, one or more of the desirable organoleptic properties of the fruit juice concentrate are substantially similar to those of the fruit juice from which the fruit juice concentrate was derived. Exemplary, non-limiting desirable organoleptic properties include a clean start with clear, differentiated flavors, a bright peak where delicate nuances may be detected, and a clean finish with minimal residual lingering caramel or oxidation notes. In some embodiments, one or more of those desirable organoleptic properties are present in a fruit juice concentrate prepared according to methods of the disclosure. In some embodiments, one or more of those desirable organoleptic properties are present in a fruit juice concentrate prepared according to methods of the disclosure and, additionally, those one or more desirable organoleptic properties are substantially similar to those of the fruit juice from which the fruit juice concentrate was derived. In some embodiments of fruit juice concentrates prepared according to methods of the disclosure, the fruit juice concentrate does not possess one or more undesirable organoleptic properties, such as those resulting from the removal of one or more flavorants, vitamins, or essential oils. In some embodiments, the fruit juice concentrate does not possess one or more undesirable organoleptic properties, such as those that result when fruit juice is processed using conventional methods involving the application of heat and/or vacuum. In some embodiments, the fruit juice concentrate is free of refined sugar, free of added salt, free of added preservatives, and/or free of added acid.

In some embodiments, a fruit juice concentrate prepared according to methods of the disclosure retains one or more agents selected from vitamins, sugars, salts, acids, oils, and flavor essences in amounts substantially equal to the amounts at which the one or more agents were present in the fruit juice from which the fruit juice concentrate was derived. In some embodiments, a fruit juice concentrate retains said one or more agents without being enriched (e.g., enriched in the amount of one or more agents) and/or without being fortified (e.g., fortified with quantities of one or more agents). In some embodiments, said flavor essences are esters having at least four carbons (e.g., having four to twelve carbons, such as from four to eight carbons or four to six carbons). In some embodiments, at least 70%, at least 80%, at least 90%, or at least 95% of said flavor essences are esters having at least four carbons. In some embodiments, such fruit juice concentrates are shelf-stable. In some embodiments, such fruit juice concentrates contain greater concentrations of certain components than did the fruit juice from which the fruit juice concentrate was derived. For example, in some embodiments, fruit juice concentrates may contain a greater concentration of sugar, as determined based on the Brix measurement of the fruit juice and the fruit juice concentrate. For example, in some embodiments, fruit juice concentrates may have a Brix measurement that is at least two times, at least three times, at least four times, at least five times, at least ten times, at least fifteen times, at least twenty times, or at least twenty-three times the Brix measurement of the fruit juice from which the fruit juice concentrate is derived. In some embodiments, such fruit juice concentrates are derived from a single fruit juice or from a blend of fruit juices. In some embodiments, such fruit juice concentrates are derived from a blend of fruit juices that includes apple juice.

In some embodiments pectinase enzyme is used to reduce the viscosity of the juice concentrate to develop ultra-concentrated fruit products, also called nectars, with a BRIX value of at least 77 when dehydrated using the present method. Based on the total mass of the raw ingredients needed to create a finished product, 0.01-2.5% weight by weight of the pectinase enzyme is added to a predetermined amount of water less than 3% of the total volume of the juice or juice concentrate. The amount of water is determined by the starting amount of liters of raw ingredients. For every 15-20 liters of raw ingredients, 0.8-1.2 liters of deionized water is used to solubilize and activate the pectinase. The water and pectinase solution are agitated with a whisk until the enzyme is fully activated and the mixture becomes homogenous. Once homogeneity is achieved, the solution is then pumped into the vessel at the same time as the raw ingredients and is dehydrated to a shelf-stable product, thereby resulting in a low pectin juice concentrate and/or nectar. The process is applicable to unfiltered or unclarified juices such as citrus, apple cider, pear, carrot and other similar juices.

In general, nectars may be prepared from any non-clarified juice, including fruit juices (citrus and non-citrus), some vegetable juices, and the like. Nectars are typically prepared from high-pectin juice sources. Nectars are typically in the range of 71°-80° Brix (more typically 77°-80° Brix, and still more typically 78°-80° Brix) and have a water activity of 0.7-0.5 (more typically 0.6-0.7, still more typically 0.65-0.60, and yet more typically 0.63-0.60). Typically, the juice precursors to nectar have a pH lower than 4. Depending on the combination of Brix level and water activity, the nectars are typically shelf-stable (immune and/or resistant to mold and fungus growth, biological contamination, and/or chemical/flavor degradation) or at least quasi-shelf stable so as to benefit from refrigeration, but not requiring freezing, to resist mold and fungus growth, biological contamination, and/or chemical/flavor degradation. Nectars are typically characterized as being made from juice precursors, having a room temperature (20 degrees Celsius) dynamic viscosity of between 13000 and 15000 mPa·s, a room temperature kinetic viscosity of about 10,000 mm²/s, 75°-80° Brix, water activity of 0.7-0.55, with relatively high pectin and sugar concentrations.

In some embodiments, fruit preservatives are produced under raw conditions at a temperature of less than 26° C., such as by placing fruit juice contents and, optionally, sugar and/or a jellying agent, such as added pectin, in a vessel and directly dehydrating the contents to a sufficient water activity level. In some embodiments, raw products may be dehydrated to lower relative water activity levels, such as 0.50 to 0.75, to compensate for the lack of a thermal sanitization step (e.g., Pasteurization, etc.) in the process. While some bacteria may survive this process, fruit products produced according to such embodiments and having a water activity from 0.50 to 0.60 may be maintained at ambient temperature (e.g., 20° C. to 25° C. such as 23° C.) for a reasonable time until consumed, and fruit products produced according to such embodiments and having a water activity above 0.60 may be maintained at 4° C. (e.g., under refrigerated conditions) for a reasonable time until consumed.

In some embodiments, the fruit juice nectar (also called fruit juice concentrate or fruit juice condensate) produced by the disclosed methods is non-crystallizing at room temperature and pressure and/or is shelf-stable. A non-crystallizing juice concentrate typically will resist crystallite formation for at least 6 months under undisturbed temperatures of 21° C. For example, a non-crystallizing juice concentrate of less than 0.60 water activity may be produced through the addition of at least 10% apple juice by weight, such as from 10% to 30% apple juice by weight, from 15% to 25% apple juice by weight, or from 18% to 22% apple juice by weight, as measured using optical refractometry, often included in Brix refractometers. For example, a non-crystallizing blueberry juice concentrate with a water activity of 0.58 may be produced from a blend of 20% of 70° Brix apple juice concentrate and 80% of 70° Brix blueberry juice concentrate. Blends of concentrates of different Brix levels may be adjusted mathematically to achieve equivalent Brix levels ratios by adjusting dilution to a common Brix number. In another example, a non-crystallizing juice concentrate may be achieved by introducing, to the juice concentrate, three or more types of sugars selected from the group consisting of sucrose, maltose, glucose, and fructose, wherein the three most abundant sugars have a relative abundance of at least 5%, at least 10%, at least 15% of the total. In some embodiments, a fruit juice concentrate produced by the disclosed methods is biostatic, meaning that it is resistant to the growth or multiplication of organisms, such as microorganisms.

In some embodiments, a fruit juice concentrate includes at least 10% apple juice by weight, at least 15% apple juice by weight, at least 20% apple juice by weight, at least 25% apple juice by weight. In some embodiments, a non-crystallizing fruit juice concentrate includes a mixture of fructose, glucose, and sucrose, with fructose making up at least 45% of the mixture by weight, at least 50% by weight, or at least 55% by weight, with sucrose and glucose making up the difference in weight. In other embodiments, the non-crystallizing fruit juice concentrate includes a mixture of fructose and two other sugars, with fructose being the primary sugar component and making up at least 45% of the mixture by weight, at least 55% of the mixture by weight, or at least 65% of the mixture by weight. The other sugars may be selected from the group consisting of sucrose, glucose, maltose, galactose, and lactose.

In some embodiments of the present invention juice components are separated to further enhance shelf stability. Fruit juices with high sugar contents ranging from 9° to 15° Brix in their natural juice concentration, such as apple juice, pear juice, blueberry juice, orange juice, or the like, are typically acidic with a pH ranging from 2.5 to 4.0 at their natural juice concentration and typically form a glassy quasi-liquid nectar state in the water activity range of 0.50 to 0.60 upon dehydration under the present methods, as further described herein.

Vegetable juices with low sugar contents ranging from 1° to 9° Brix in their natural juice concentration, such as kale, celery, ginger, red beets, carrots, spinach, cucumber, and the like, typically have a pH ranging from 4.5 to 6.5, with the most common range between 5.0 and 5.5, and typically during dehydration bypass the quasi-liquid nectar state to form solid crust-like sheets, which may be further broken into flakes. Flakes are typically characterized as solid, substantially flat asymmetric pieces formed through the dehydration and cracking or pulverizing of sheets of vegetable juice concentrate, and typically have a water activity of 0.2 to 0.5, more typically 0.2 to 0.4, still more typically 0.2 to 0.3, and still more typically approximately 0.25. By producing flakes, the surface area to volume ratio of a shelf stable vegetable juice is substantially decreased when compared to a spray-dried or pulverized powder with substantially spherical dimension of less than 0.2 mm. While flakes may be made from a single vegetable juice source, the rehydration and dissolution of flakes may be substantially enhanced by combining at least two, more typically at least three of the following ingredients comprising tomato, kale, celery, spinach, cucumber, ginger, red beets, golden beets, carrots, turmeric, horseradish, wasabi prior to processing the juice to a flake. Flakes, as described herein, typically are 0.1 to 2 mm in thickness, substantially planar, and range from 2 to 20 mm in maximum cross-sectional dimension as measured across the planer surface of the flake. Likewise, through further extension of the dehydration process, shelf-stable food powders may be produced, including the nectar and flake precursors listed above, as well as prepared foodstuffs, such as sauces (Alfredo, soy, barbeque, and the like) and like foodstuffs.

In one embodiment, viscous nectar is produced from fruit and/or vegetable juices as described herein and characterized by a room temperature (20 degrees Celsius) dynamic viscosity of between 13000 and 15000 mPa·s, a room temperature kinetic viscosity of about 10,000 mm²/s, 75°-80° Brix, water activity of 0.7-0.55. The nectar is stored in commercial containers, such as 55-gallon drums, shipping containers, or the like. The commercial containers define an interior storage volume and typically include a polymer or like liner. The liner may be integral with the storage container, or, more typically, may be provided as a removable bag.

Mixed juice drinks containing high sugar juices combined with vegetable juices are commercially in high demand. Unfortunately, during the concentration of vegetable juices when combined with high-sugar content fruit juices, the iron in the chlorophyl typically oxidizes at the lower pH conditions resulting in discoloration from green to orange-brown within the first 4 hours of mixing, and typically results in off-putting organoleptic notes and thereby preventing the creation of a shelf stable nectar containing both components in their fresh-pressed green state. Ginger and turmeric juice flavors may also decrease in organoleptic potency over time during storage in shelf-stable nectar forms and may also benefit from the storage in flake form. Herein is a composition, method, and kit for creating natural, cold-pressed juice bar style drinks, in a shelf stable form that may be dehydrated, stored, and reconstituted with minimal oxidation of the chlorophyl. A flake may be formed by first dehydrating the juice in a recirculated dryer to a Brix of at least 40°, more typically at least 50°, still more typically at least 60°, and placed on inert flat surfaces, such as silicone-lined sheet pans, prior to continued dehydration to the desired water activity.

One embodiment is a kit including a first sealed pouch of fruit juice nectar, such as apple-lime nectar, with a water activity of 0.50 and 0.595, more typically 0.525 and 0.575, and still more typically approximately 0.550 at the maximum desired storage temperature, which is typically 20° C. to 40° C., more typically 20° C. to 30° C., and still more typically approximately 25° C., and a second sealed pouch including dehydrated vegetable flakes typically comprising at least two ingredients, more typically at least three ingredients of the following list comprising kale, celery, spinach, cucumber, ginger, red beets, golden beets, carrots, turmeric, horseradish, wasabi, wherein the first sealed pouch and the second sealed pouch are sold as a packaged kit. In another embodiment of the present kit, the sealed pouches are connected by a mechanical adhesive along their flat axis. In another embodiment of the present invention, the pouches are linked by a common material with two sealed chambers.

In one embodiment, a shelf-stable composite material capable of storing chlorophyl in a nectar matrix without substantial oxidation comprising a fruit juice nectar, such as apple-lime nectar, or pear nectar, with a water activity of 0.50 and 0.595, more typically 0.525 and 0.575, and still more typically approximately 0.550 at the maximum desired storage temperature is combined with vegetable flakes with a water activity of 0.2 to 0.5, more typically 0.2 to 0.4, still more typically 0.2 to 0.3, and still more typically approximately 0.25 to form a nectar-flake composite material with a combined water activity of 0.45 and 0.575, more typically 0.5 to 0.55 at the desired storage temperature, which may typically be 20° C. to 40° C. more typically 20° C. to 30° C., and still more typically approximately 25° C. wherein the ratio of nectar mass to flake mass is at least 3:1 more typically at least 5:1, still more typically at least 10:1, and still more typically at least 18:1. A nectar-flake composite may subsequently be reconstituted in water to form a hydrated nectar-flake drink with limited oxidation during the composite storage phase, which may be up to several months or years.

In another embodiment, a non-oxidizing vegetable sugar source including tree sap, such as maple sap or hickory sap, beet juice, beet sugar, cane juice or cane sugar is used as a high pH source of sugar that may produce a nectar, or alternatively combined with a vegetable juice base prior to concentration without oxidizing the chlorophyl to form a uniform vegetable juice nectar with a water activity of 0.45 and 0.575, more typically 0.5 to 0.55 at the desired storage temperature, which may typically be 20° C. to 40° C., more typically 20° C. to 30° C., and still more typically approximately 25° C. A vegetable nectar, or vegetable nectar-vegetable juice nectar composite may have a pH as pressed above 4.5 more typically above 5.0, and still more typically between 5.1 and 6.2, and when combined with vegetable juices containing chlorophyl, it may provide sufficient sugar to enable uniform nectar with substantially non-oxidized chlorophyl.

In some embodiments, ascorbic acid is added in small amounts as an antioxidant. The ascorbic acid, also referred to as vitamin C, is present in the range of 0.5 to 2.0 mg/g, such as from 1.0 to 1.5 mg/g, in each case represented as a mass ratio in the final concentrate with a water activity of less than 0.60. In some embodiments, the added ascorbic acid does not contribute to the flavor of the juice concentrate.

In some embodiments, (a) juice as harvested and having a Brix value of from 3° to 25° Brix, such as from 3° to 15°, (b) partially concentrated juice having a Brix value of from 15° to 75° Brix, such as from 30° to 70° Brix, and having a water activity above 0.70, or (c) a combination thereof, is/are placed in a vessel and hermetically sealed therein out of communication with the ambient atmosphere. The vessel is put in pneumatic communication with an absorbent media, such that the juice is in indirect contact with the absorbent media through a gaseous (typically air) medium; thereby avoiding cross contamination of both the juice supply and the sieve elements. The absorbent media and recirculating process air under the present system and method are typically within 10° C., and more typically within 5° C. of the juice process temperature during processing. This prevents condensation of volatile compounds on the external surfaces of the absorbent media through secondary unintentional physical absorption mechanisms (for example clay affinity in molecular sieves). Process air temperature may be regulated utilizing a high surface area heat exchanger, wherein a fluid, such as water, is circulated through the heat exchanger that is in thermal communication with the process air, and wherein the fluid is, in some embodiments, within 15° C., 10° C., or 5° C. of the gaseous process air temperature. In some embodiments, gaseous process air temperatures range from 5° C. to 100° C., from 15° C. to 65° C., or from 37° C. to 57° C.

In some embodiments, a recirculating water absorption system includes a hermetically sealed vessel within which an open juice supply may be positioned. In some embodiments, the vessel further includes a pair of pneumatic ports formed therethrough. Pneumatic lines (typically known in the art) then connect ports to an absorption unit of the present disclosure, which may be constructed of composites, plastics, stainless steel, and or the like, may be pneumatically sealed, and may contain at least one chamber containing absorbent media. Some implementations may include one or more check valves in pneumatic lines to maintain unidirectional airflow. Moisture-laden air (having acquired moisture from the juice in communication with the gaseous process air) may be drawn from within vessel, passing through at least one pneumatic line, entering an absorption chamber, passing through absorbent media, wherein absorbent media absorbs moisture from the air resulting in dried air (still full of flavorants), and then returning the dried process air through pneumatic at least one pneumatic line back into vessel where the dried air acquires more moisture from the open juice supply and the cycle repeats. In some embodiments, flavorants that volatilize during this process reach saturation within the process airstream, which retards further volatilization during the dehydration process and results in a homeostatic condition where the rate of volatilization equals the rate of condensation. As a result, in some embodiments, the majority of the flavorants are retained in the initial juice. In some implementations, a pump or vacuum unit may be used to urge air through pneumatic lines and/or be used as blower unit to ingress/egress air through pneumatic lines, absorption chamber, and absorbent media.

Non-limiting examples of absorbent media for use in the disclosed methods include absorbent media that absorbs moisture via chemical reaction, such as where an oxidation state of the molecular component, such as lithium, magnesium metal, and/or the like, is altered during absorption, and/or through physical absorption methods, such as where a chemical, such as calcium oxide, calcium chloride, magnesium chloride, zinc chloride, and/or the like forms a molecular hydrate thereby removing moisture from the process air. Alternatively, or in addition, absorbent media may contain physical barriers, such as through the formation of crevasses or pores, that prevent physical or chemical absorption of molecules above a certain average molecular size, thereby enabling them to be atomically selective. Atomically selective absorption media may contain silica gels, zeolite structures, and/or the like, which may be bound together by using a clay, plastic, or other conventional binding material forming a moldable macroscopic structure, such as a molecular sieve ball or tube. In some embodiments, the present system may use molecular sieves sized from one to twenty-five angstroms zeolite pore size, such as from two to ten angstroms zeolite pore size, three to five angstroms zeolite pore size, or three to four angstroms zeolite pore size. In some embodiments, said molecular sieves, such as molecular sieves sized from three to four angstroms, are employed to selectively absorb water. In some embodiments the zeolite may comprise potassium sodium aluminosilicate, which may be formed from sodium aluminosilicate subjected to an ion exchange process. In some embodiments the sodium potassium aluminosilicate crystals may be combined with a clay binder to form molecular sieves, which may subsequently be kiln fired to produce a stable structure. In some embodiments, the sodium to potassium ion ratio is at least 30% potassium, at least 50% potassium, or at least 66% potassium. The minimum cross-sectional diameter of the zeolite media may be from 1 mm to 6 mm, or from 2.5 mm to 5 mm. In some embodiments, molecular sieves sized from five angstroms or greater (e.g., from five Angstroms to twenty-five Angstroms) are employed to selectively remove molecular acids, such as acetic acid. In some implementations, the molecular sieve may be ion exchanged potassium sodium aluminosilicate with a high potassium substitution content resulting in a mixed medium with a pore size between 3 to 4 Angstroms. In this embodiment, water vapor may be absorbed as a solid without a liquid transition, thereby preventing flavorant absorption and/or loss from the process food or juice.

In some embodiments, a hydrophilic membrane, such as polyamide or an ionic polymer sheet or film, is used to selectively absorb water vapor from the recirculating process air at a first air-membrane interface, transport the absorbed water across the membrane, and release the air into the environment at the second air-membrane interface where it may travel to a condenser, or out into the environment. A polyamide multilayer film, such thin 20-70 nm polyamide layer supported on a polysulfone (PSU), polyethersulfone (PES), Polyphenylene sulfone (PPSU) support, may enable greater water conductivity for a given surface area. Water migration across the membrane is driven by diffusion where a moisture gradient may promote migration of water selectively across the membrane, through thermal gradients where a temperature differential across the membrane promotes migration of water selectively across the gradient, or electrically where an electric current may promote ionic constituents of water selectively across a membrane. In each case, water may be driven from isolated process air to the ambient environment without significant transmission of flavorants. In the case of electrical migration, alternating hydronium and hydroxide conducting materials, such as tetrafluoroethylene sulfonic acid co-polymers, aliphatic or aromatic polymers including poly(sulfone)s, poly(arylene ether)s, poly(phenylene)s, poly(styrene)s, polypropylene, poly(phenylene oxide)s, poly(olefin)s, poly(arylene piperidinium), and poly(biphenyl alkylene)s with different cationic groups, such as quaternary ammonium, guanidinium, imidazolium, pyridinium, tertiary sulfonium, spirocyclic quaternary ammonium, phosphonium, phosphatranium, phosphazenium, metal-cation, benzimidazolium, and pyrrolidinium, and the like may enable water to be split on one side of the system and recombined on the opposite side through electrical excitation. In some embodiments, molecular sieves as absorbent media may typically absorb the excess water but will leave volatile compounds that make up the complex flavors of juice contents (e.g., apple, orange, blackberry, blueberry, raspberry, and/or the like). Molecular sieves typically may also be regenerated between 200° C. and 290° C. under a flow of air exchanged with the environment for a period of one to two hours to remove water and other absorbed molecules, and to restore initial conditions to maintain efficiency and prevent batch contamination. Molecular sieves may alternatively be regenerated at ambient temperature via vacuum swing desorption, such as at pressures less than 5 torr or less than 1 torr. In some implementations, the absorption unit also may include absorption media regeneration capabilities. For example, one or more desiccant regeneration methods (e.g., heating absorbent media to vaporize absorbed water at atmospheric or partial vacuum conditions, etc.) are used to recharge media. In this implementation, a heater is operationally connected to the chamber in thermal communication with the absorption media, such that energization of the heater provides sufficient heat to the absorption media to drive off moisture and like absorbed molecules. The absorbent media is maintained hermetically isolated from process air and juice process vessel during regeneration. In another implementation, the absorption system may have more than one bay of media in the absorption unit (and/or one or more chambers, each having one or more media bays), which may be actuated between. For example, the unit may have a plurality of bays of absorbent media, each bay being selectable via open/close valves, blast gates, electronically actuated gates, rotating ports, and/or the like, and the system may allow process air recirculation to flow through the first bay until the first bay's media is saturated. At this point, the unit may close the first bay and open the second bay, while also activating a recharging system in the first bay to desaturate the first bay's media. In some embodiments, a bay or chamber in the present disclosure is used to describe an enclosure that contains absorbent media and connected via pneumatic lines. Bays and chambers are thermally isolated and connected only through pneumatic tubing that is regulated through one or more valves or diverters or may be mechanically connected where they share physical walls between hermetically isolated spaces. This process may then continue through the various bays, and the system are scaled (e.g., having two, five, ten, etc. bays/absorption chambers) to maintain saturation and/or recharge rates while keeping vessel volume air at a sufficiently low water content and in quasi-continuous pneumatic isolation from the surrounding environment.

In some embodiments, the absorption system and/or media are manually recharged. For example, as above, one or more media bays may be available, and/or one or more media trays are removable/replaceable. Thus, as one tray is saturated, an operator may halt airflow through vessel(s), temporarily breach the hermetic seal with the environment, remove one or more media trays, place said one or more media trays in an oven to recharge the media, and then replace said one or more recharged media trays into the system. More than one media tray may be used to maintain quasi-continuous dehydrating conditions. Further, in some implementations, one or more air filtration elements are used to prevent dust and/or debris from exiting absorption bay and returning to vessel volume and mixing with food or juice contents. For example, such an air filter element is typically less than ten (10) micrometers, more typically less than five (5) micrometers, and still more typically less than one (1) micrometer for particle size filtration.

In some embodiments, the aqueous composition collected during or from the concentration of materials, such as fruit juice, are collected. In some embodiments, such aqueous compositions are commercially valuable and/or viable in their own right. In some embodiments, an aqueous composition obtained from the concentration of fruit juice is collected, wherein the aqueous composition comprises water and fruit essence. In some embodiments, the aqueous composition comprises water and fruit essence and has a content of one or more vitamins substantially identical to that of the source fruit juice (where it is to be understood that the source fruit juice is the starting fruit juice that is subject to concentration), an oil content substantially identical to that of the source fruit juice, a flavor essence content substantially identical to that of the source fruit juice, a salt to sugar ratio substantially identical to the source fruit juice, and an acid to sugar ratio substantially identical to the source fruit juice. In some embodiments, such aqueous compositions are obtained from the concentration of a source fruit juice that includes at least 10% apple juice.

In some embodiments, implementation may include one or more sensors (e.g., temperature sensors, airflow sensors, humidity sensors, dewpoint sensors, and/or the like) to measure airflow, water content, pressure, and/or the like of air flowing through lines, through ports, through vessel(s), and/or the like. Measured sensor data may then be used to trigger alarms (e.g., to change one or more media trays, switch one or more media bay actuators, and/or the like), automatically open/close ports and/or valves, actuate to new media, initiate/stop recharging of media, and/or the like. Airflow rate sensors may also be used to determine the flow rate of the cooling air. In some embodiments, a moisture meter is placed in the incoming and outgoing process air streams (e.g., on lines) and a sensor is used to measure the flow rate of the process air. From these data, the approximate mass of moisture is calculated, and the specific amount of moisture is removed from vessel.

In some embodiments, implementation may utilize one or more controllers to control system components. For example, a controller may receive and analyze sensor readings, actuate valves, turn on recirculation units, energize heaters, and/or the like. Controllers may operate using predefined profiles and routines, or controllers may operate using machine learning and/or adaptive logic routines to optimize and maintain system operation.

In some embodiments, airflow rate sensors may also be used to determine the flow rate of the process air. In some embodiments, a moisture meter is placed on the incoming and outgoing process air streams (e.g., in lines) and a sensor is used to measure the flow rate of the air. The mass of moisture typically may then be calculated by multiplying the airflow rate by the difference of the water content between the inflow and outflow. If the data is totalized over time, then a specific mass of moisture may be determined and removed by the system. Thus, a nonlimiting embodiment of a disclosed method comprises placing ingredients in a vessel; sealing the vessel from the external environment and beginning a flow of dry air; measuring the airflow rate and water content of the incoming and outgoing air streams; continuing the dehydration process until a desired mass of moisture is removed; and closing port(s) and isolating condensed juice from drying media to maintain desired moisture level.

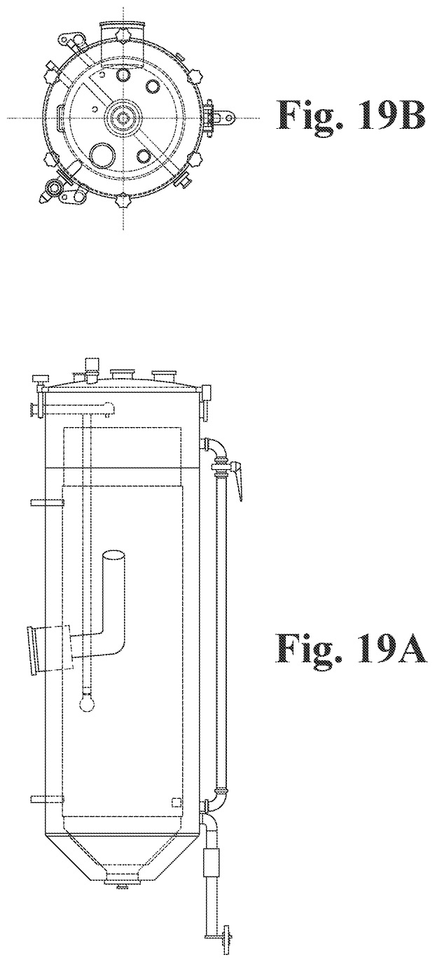

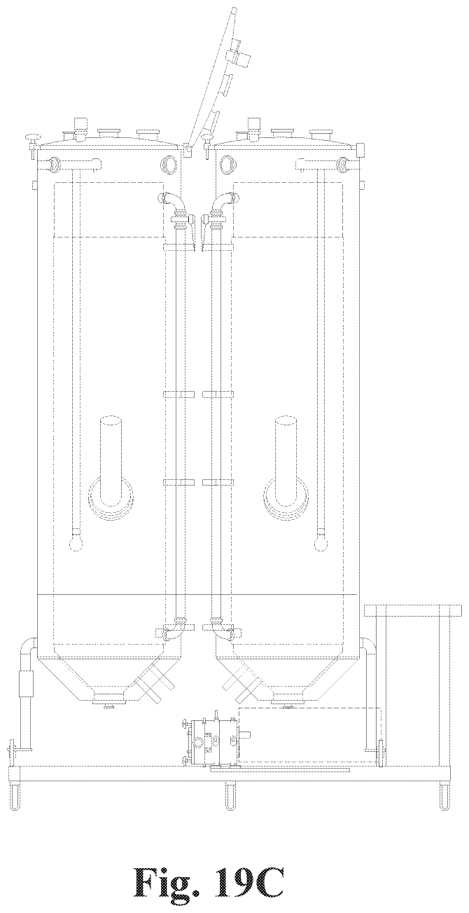

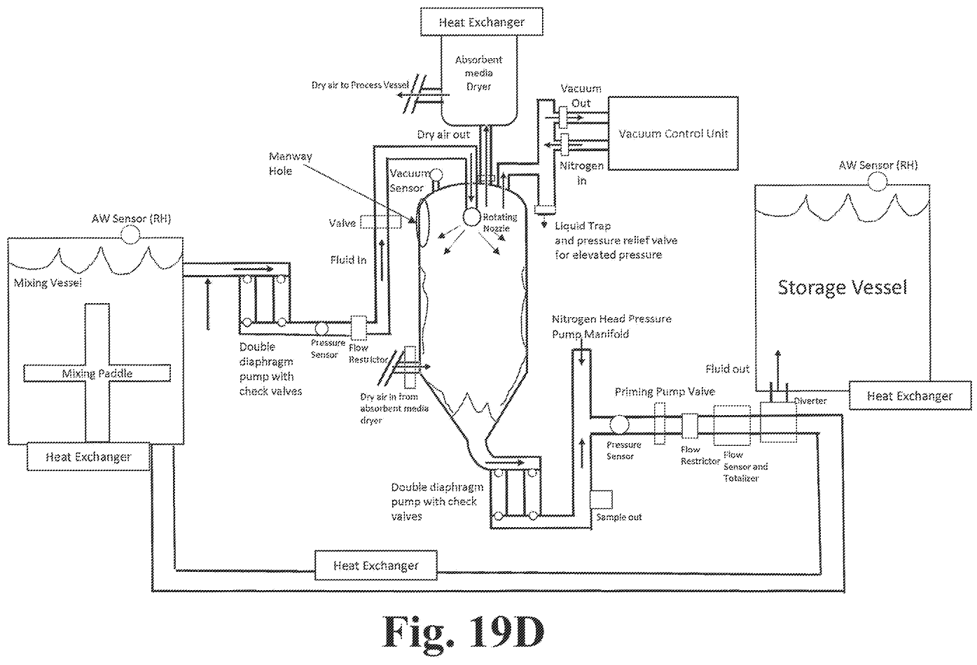

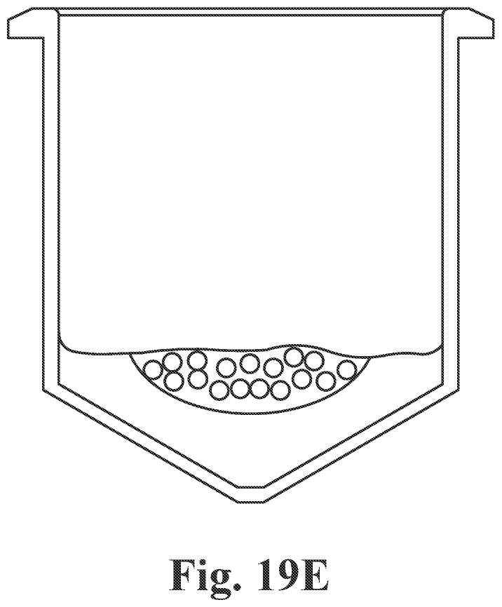

In some embodiments, the initial dew points of the dry process air entering the vessel may range from −60° C. to 50° C., such as from −50° C. to 20° C. or from −45° C. to −20° C. In some embodiments, moist air returning from the vessel to the air dryer may have a dew point ranging from −20° C. to 50° C., such as from −10° C. to 25° C. or from −5° C. to 15° C. The vessel is typically cylindrical and has one process gas inlet and outlet. The vessel has an inner diameter of at least 10 cm, at least 15 cm, at least 25 cm, at least 30 cm, or at least 45 cm. Inner diameters may be greater than 10 cm, such as at least 15 cm, at least 25 cm, at least 30 cm, or at least 45 cm to aid in the formation of a bubble net and/or decrease the entrainment of air bubbles in the viscous concentrate. As shown in FIG. 19E, the bubble net of the present disclosure is a semi-flexible film that forms at the surface of the standing liquid comprising latent bubbles that have risen to the liquid surface combined with a solid film of over-dehydrated juice or other liquid. The formation of the bubble net enables the juice or other liquid traveling down the inner wall of the vessel to transition seamlessly without folding over and trapping air bubbles. If the inner diameter of the vessel is too small, the bubble net will be entrained into the falling liquid and mixed in resulting in a folding transition and a lower density juice concentrate due to suspended air bubbles. This process gas, typically air, is used to help facilitate the evaporation of water from the product fluid and transport the evaporated water out of the vessel. The process gas inlet and outlet are typically at opposite ends of the vessel so that the process gas flows across the product fluid surface within the vessel. The inlet process gas typically has a dew point temperature of about −40° C. and a dry bulb temperature of about 38° C., though these values may vary during the course of a process cycle and between embodiments. The inlet air may pass through a nozzle or other discharge orifice at the exit of the inlet. In one embodiment of the juice concentration technology, the inlet pipe is about four inches in diameter, has a process gas bulk flow velocity of about 21.59 meters per second, and a volumetric flow rate of about 0.0425 cubic meters per second; the exit of the inlet pipe forms a nozzle which contracted to a 2.54 cm diameter, accelerating the process gas. Therefore, in this embodiment, the bulk velocity of the process gas at the inlet into the vessel is about 85 meters per second.

The vessel typically has a diameter greater than the inlet pipe, so that the bulk velocity therein is less than the bulk velocity of the process gas discharging from the inlet pipe. In the embodiment referenced above, the vessel internal diameter is about 56 cm. Therefore, in this case, the bulk velocity of the process gas in the vessel is about 0.1778 meters per second. As the process gas passes over the product fluid, water evaporates and transfers into the process gas, and is transported through the vessel to the process gas outlet.

As the process gas travels through the vessel and accumulates evaporated water, the moisture content increases, and the temperature typically decreases. The outlet process gas dew point temperature is typically about 4.4° C. and has a dry bulb temperature of about 32° C., though these values may vary during the course of a process cycle and between embodiments.

In some embodiments, atmospheric pressure process air (approximately 760 torr) returning to the vessel from the dryer unit is at a dew point of −40° C. at a temperature of 37° C., which may correspond to approximately 0.0896 grams of water per cubic meter. A dew point of 10° C. and a process air temperature of 37° C., which corresponds to approximately 8.57 grams of water per cubic meter, may result during active dehydration of a semi-dehydrated food product as measured by the process air returning to the dryer unit. A typical flow rate through a 340 L vessel is between 0.142 to 1.42 cubic meters per minute. Therefore, at 1.42 cubic meters per minute, a system with a dry air dew point of −40° C. and a returning dew point of 10° C. may remove approximately 12.05 grams of water per minute. If 20 kilograms of cacao nibs with initial water content by weight of six percent are to be dehydrated to a final water content of one and a half percent, then 900 grams of water must be removed, which would take approximately seventy-five minutes using the novel system.

The dehydration process of the present disclosure may be applied continuously to the process liquid, or it may be applied intermittently to allow moisture levels of the 1 to equilibrate under an isolated environment between dehydration cycles. Isolation periods of the present technology for producing semi-dehydrated goods, such as fruit juice concentrate and other agricultural products as presented herein, may be from one to sixty minutes, such as from two to twenty minutes or from four to fifteen minutes. Multiple process intermediates may form during juice processing and may be characterized by their water activity. Juice concentrate products may be produced from fresh juice solely by the methods of the present disclosure, or they may be produced using methods of the present disclosure in combination with traditional dehydration techniques, such as thin film or falling film evaporation. As a non-limiting example, commercially obtained juice concentrate having a Brix value of from 15° to 70° Brix, such as from 35° to 70° Brix, may be added to a vessel and concentrated according to the present method to achieve a water activity of less than 0.60 at 21° C. In another non-limiting example, a combination of fresh pressed juice having a Brix value of from 1° to 25° Brix may be combined with one or more juice concentrates having a Brix value of from 15° to 70° Brix to achieve a pre-process blend of fresh and concentrated juice, which may then be processed according to the disclosed methods to achieve a water activity of less than 0.60 at 21° C. Quasi-stable process intermediates may be characterized in accordance with their biological activity, where intermediates certain water activity levels can be expected to resist biological contamination. For example, methods of the present disclosure may provide, as process intermediates, compositions with a water activity of less than 0.95 that resist E. coli contamination, compositions with a water activity of less than 0.93 that resist Bacillus cereus contamination, compositions with a water activity of less than 0.85 that resist Staphylococcus aureus contamination and/or Aspergillus clavatus contamination, compositions with a water activity of less than 0.78 that resist Aspergillus flavus contamination, and/or compositions with a water activity of less than 0.62 that resist Saccharomyces rouxii contamination.

In some embodiments, the present system may undergo a thermal sanitization process prior to the introduction of ingredients. The process may include the following operations: 1. Isolating the desiccator system and process chamber from the surrounding ambient environment, 2. Increasing the temperature of the process vessel to at least 57° C. for at least 10 minutes thereby creating an aseptic environment, 3. Decreasing the vessel temperature and/or process air temperature to the desired production temperature; and 4. Introducing aseptic ingredients into vessels to initiate aseptic processing. In some embodiments, ingredients are introduced to the aseptic environment via a UV sanitization system fluidically connected to an aseptic process vessel to preserve organoleptic features while decreasing biological contaminants.

Embodiments of methods of the present disclosure uniquely enable moisture of fruit juice concentrate to be determined during isolation periods, during which equilibrium atmospheric moisture levels are determined and used to calculate water activity levels, which may correlate directly to the water content of the food contents. For example, for fruit juice concentrate, a moisture level of fifteen to nineteen percent by weight is desirable, which corresponds to a water activity level of approximately 0.50 to 0.62, or fifty to sixty-two percent relative humidity of the isolated atmosphere in equilibrium.

In some embodiments, a discontinuous dehydration process is used to maintain a specific water activity level within a desired juice product during dehydration where water is continuously released due to evaporation. Under the prior technology, a juice with a reasonably high-water content is added to the vessel and dried rapidly via application of heat and/or vacuum under an initial phase to reach a desired water activity level/water content/degree Brix. In contrast, with the present system the rate of moisture removal is limited by moisture release at the juice/air interface, the ratio of dehydration time to isolated equilibrium resting time may be from one:one to one-hundred and fifty:one, such as from two:one to one-hundred and twenty:one or from three:one to fifty:one, until a desired initial water activity level is obtained. In some embodiments, a second dehydration phase with an intermittent dehydration cycle using a dehydration time to resting time ratio of from one-tenth:one to five:one, such as from one-half:one to two:one or six-tenths:one to one:one, may be used during particle size reduction to maintain a desired maximum water activity level to limit food chemistry that may degrade contents.

The dewatered contents (e.g., processed juice) may then be discharged from a spout (e.g., drain member, lip, etc.) and the system may be reset for another batch of contents. It may be preferred to heat the dewatered contents to a temperature of 37° C. to 75° C. immediately prior to discharging contents from the vessel to decrease the viscosity of the dewatered contents, sanitize the dewatered contents, and/or increase the batch yield. Thus, this method typically enables dewatered juice contents to be produced to a desired moisture level in a one batch refining and mixing system to a desired and highly tailored specification.

In some embodiments, the process of measuring and adjusting water activity may occur continuously during the drying processing without removing content samples by monitoring the relative humidity of an isolated atmosphere in fluidic communication with a portion of the recirculating process juice or other liquid. The temperature of the isolated atmosphere as well as the process of juice may also be monitored to provide a more accurate reading. The isolated atmosphere may be in a holding tank or a portion in line with the process tubing. Such an automated process may, as noted above, utilize one or more moisture and humidity sensors, as well as airflow sensors, to determine the water activity of contents, actuating ports to selectively dry air and contents using drying media until a specified water activity level and/or threshold is achieved. The process may continue under steady state conditions until the desired water activity level is achieved, at which time the samples are transferred to commercially acceptable storage containers.

In some embodiments, two vessels are used to continuously recirculate and dehydrate a food product, such as fruit juice, by holding a first volume of food product in a first vessel that has a vessel airspace, wherein the first vessel and vessel air space are maintained substantially atmospherically isolated from the surrounding environment, and wherein a humidity sensor is in atmospheric communication with the first vessel airspace, and a second vessel fluidically connected and maintained in atmospheric isolation to the first vessel, wherein the second vessel is in atmospheric communication with a absorbent media, and where fluid from the first vessel is transferred to the second vessel where it is partially dehydrated through the interaction with the second vessel headspace and then transferred back to the first vessel where it may reach an equilibrium with the first vessel airspace. Under this method fluid is continuously dehydrated and monitored in either a batch or continuous flow process until the desired water activity is reached at which time the food product is discharged. Intermediate compositions may be extracted during this process, having water content from 25 to 75 percent, water activities from 0.60 to 0.95 and less than 70° Brix while retaining the original levels of sugars, oils, essences, vitamins, and the like. The first vessel of this embodiment may further contain a mixing paddle to help maintain an even mixture of dehydrated product, and product may be motivated between first and second vessel via fluidic tubing using a series of pumps and check valves, flow control orifices, and/or the like.

A mixing paddle of the present invention may be an agitator, such as a vibratory agitator, or other such mechanical device used to perturb the equilibrium of a fluid in a vessel, thereby increasing the homogeneity of the material. An agitator may directly perturb the material or may indirectly perturb the material through secondary mechanical contacts (such as vibrating the vessel walls). A mixing paddle or agitator may span the full dimension of a vessel, where the paddle helps to liberate material from the vessel walls, or it may only span a portion of the vessel volume.

A vacuum control system may be used to regulate the pressure of a vessel under continuous flow operations within a very narrow pressure window. Vacuum control systems of the present technology may be analog in nature, comprising a series of high surface area pressure regulators that use mechanical pressure gradients across a valve to regulate vacuum or positive air flow conditions within a vacuum chamber. These may be adjusted manually and calibrated according to a pressure meter located directly, or more typically indirectly to the vacuum and pressure lines, and in communication with the inner vessel atmosphere. More typically a vacuum control system of the present technology utilizes a digital pressure meter in communication with a pressure controller that typically houses a digital user interface. The controller or vacuum control unit may then actuate one or multiple vacuum valves to decrease atmospheric pressure within the chamber or vessel, and also one or multiple air valves, that may enable the flow of air, more typically an inert atmosphere such as nitrogen or argon, to enter the vessel and increase the pressure. Still more typically a vacuum control unit may control a coarse vacuum valve, fine vacuum valve, coarse air valve, and fine air valve independently. A series of coarse and fine valves of each type may further be used to provide greater level of control over specific vacuum control rates. During operation the control may activate the coarse vacuum valve in atmospheric communication with a vacuum pump, until the vessel pressure reaches within 10%, more typically within 5%, still more typically within 1%, and still more typically until the desired vacuum level is reached. Then a fine vacuum adjustment valve is used to iterate to the desired vacuum level at a decreased rate, thereby providing greater precision. A fine air valve is used to provide additional atmospheric pressure that is less than the desired pressure level. By constantly monitoring and controlling the coarse and fine vacuum and air valves, a vacuum control unit may regulate the pressure of a vacuum chamber to within a narrow range under dynamic, quasi-steady state conditions with a typical pressure tolerance of within 5 Torr, more typically within 3 Torr, still more typically within 2 Torr, and still more typically within 1 torr of the desired setpoint enabling close control of the flavor of foods.

Spray nozzles are used to direct fluid to the vessel wall while controlling atomization and spray angle. Typical spray nozzles may be fixed or may rotate during operation. In some embodiments, spray nozzles may have an unusually narrow spray angle, such as an angle that is less than 60 degrees, less than 45 degrees, or less than 30 degrees. The fluid may also be atomizing, in the case of the production of fruit juice powders, or may be non-atomizing, in the case of alcohol, coffee, or fruit juices for concentration and/or vacuum processing. A nozzle may have a relatively horizontal spray pattern within, for example, 45 degrees of the horizon, such as within 30 degrees of the horizon. The process fluid may then dehydrate or outgas while airborne and may also dehydrate or outgas as it travels down the walls of the vessel. Vacuum pressures may be elevated during outgassing through the use of a spray nozzle, where typical outgassing pressures may, in some embodiments, be from 30 to 95 Torr, such as from 35 to 85 Torr, or from 45 to 80 Torr.

In some embodiments, a low-bubble nozzle is used to decrease the air entrapment during dehydration as well as vacuum processing. In some embodiments, the liquid inlet port may empty onto one end of a ramp where juice pumped from a source tank spreads into a thin layer or sheet and flows downhill to pool at the other end of the ramp. Dry processed air may then enter the port and directly blow across the falling juice, transferring the moisture to the process air before the air leaves the port. Juice solutions with reduced water content may then be pumped out of process vessel and into a collection vessel, or they may be recirculated for additional dehydration. In some embodiments, inlet ports are less than 50 mm, less than 25 mm, or less than 10 mm from the vessel wall. In some embodiments, use of inlet ports that are less than 50 mm, less than 25 mm, or less than 10 mm from the vessel wall may result in a smooth fluidic transition substantially void of air bubbles.

In some embodiments, fluid may transition from the wall to a standing fluid reservoir at an obtuse angle to further limit entrapment of air bubbles. During operation, a minimum process fluid reservoir may be used to collect incidental air bubbles trapped during operation. The process fluid reservoir is typically at least 75 mm thick, such as 150 mm thick, or 250 mm thick between the atmospheric interface and the fluid pump. In some embodiments, the fluid transitions from the side walls of the process vessel to the fluid reservoir without entrapping air. Undisturbed fluid at the center of the process vessel forms as the flow from the side walls pushes to a common point while dry air forms a crust at the surface of the process juice. As a result, a bubble trap forms and collects additional bubbles separated hydrostatically by the weight of the fluid reservoir and prevents them from recirculating in the process pump. The bubble trap may then be collected prior to discharging vessel contents to prevent the bubble from mixing into the process juice. This step may remove downstream deaeration steps and further enhance product quality.

In some embodiments, methods disclosed herein use a liquid inlet body that enables liquid accumulation prior to injection. In some embodiments, liquid enters a manifold, such as a large tube, at least partially encircling the upper lip of the vessel. The manifold may contain a plurality of inlet ports positioned facing the vessel wall, such that fluid would leave the manifold under pressure and spray on the inner wall of the vessel. The cross-sectional area of the inlet ports in this embodiment are typically small relative to the manifold body and may be less than 7.5 mm in diameter, such as less than 5 mm in diameter or less than 3 mm in diameter. In another embodiment, the liquid inlet body may comprise bilateral pieces that may or may not be incorporated into the lid of the vessel. Bilateral separation may be used to enable rapid disassembly.

In some embodiments, the pump output manifold is held at twice the pressure difference between the vessel pressure and the atmosphere, thereby enabling simple flow restrictor plates to be used on the vessel intake and pump return valves with approximately equal pressure. A pressure regulator is used to regulate the pump actuator pressure such that the resultant head pressure equals the desired pressure. In this configuration, the pump may stall if the output valve is closed, resulting in check valve actuation, and thereby preventing the leakage of processed product back into the process vessel.

In another embodiment, liquid enters the vessel and is collected in a trough. Once the trough has filled, liquid will pour over the trough and sheet down the sidewalls toward a sump. The trough may fill to a level defined by a lip until it flows over the lip forming a sheet of liquid across the vessel wall. A secondary outlet tube may serve as a trough drain and density separator, where the lower density and higher moisture concentrate may spill over the trough lip, while the higher density liquid may drain from the trough bottom. The trough also may be slanted to further promote flow around the vessel lip to the trough drain.

In one non-limiting example, (see FIGS. 19A-19C) a vessel may comprise an elongated generally tubular form, typically constructed of stainless steel, with an inner layer, a water jacket in thermal communication with the inner layer, and an outer layer surrounding the water jacket, wherein the inner layer forms the food contact surface. The tube may be vertically terminated by a manway cover, further comprising a plurality of ports, such as sanitary light ports, sight glasses, air outlet ports, pressure relief valves, and air inlet valves. Centrally located air outlet ports may further enhance uniform airflow and separation of high velocity rotating dry air from low velocity centrally located air. The air inlet tube may also be on the side of the vessel wall to enable permanent placement and operation independent of lid orientation. The air inlet tube may be terminated by an air nozzle to further enhance the formation of an air vortex within the vessel and enhance the dehydration rate across the surface of the falling juice. The air inlet may be above a trough line, as shown in FIG. 19A, or below the trough line. In the case of below the trough line, the ferrule may protrude into the vessel volume at an upward angle to prevent the falling fluid film from dripping past the opening. A trough may be placed at the higher portion of the vessel with an inner diameter consistent with the vessel wall, and an outer diameter larger than the vessel wall. The trough may have a width from 5 cm to 15 cm and a depth gradient beginning at 2 to 5 cm and sloping to at least 10 cm or at least 15 cm with a slope of at least 4%, 5%, 7.5%, 10%. A trough return port may be located at the bottom portion of the sloped trough and may serve as a return channel for high density juice concentrate or excess juice concentrate during discharge. The vessel may also contain a clean in place system, that may pump and spray water or other cleaning solutions into the vessel for easy maintenance. The tank may have a bottom collection port of a first diameter that tapers to a port of a second diameter, wherein the port may provide easy serve and maintenance access, while still maintaining limited tubing size during operation. During operation the fluid may be placed below the air discharge tube, that may protrude from the side or the top. Fluid is pumped from the bottom of the tank to the trough where it forms a continuous falling sheet of liquid over the inside of the vessel wall. Air from the inlet enters the vessel and recirculates across the fluid, thereby extracting moisture, until it reaches the outlet port. As the fluid dries, it loses thermal energy that may be replenished by the vessel wall and recirculating water jacket. The water jacket may comprise one or multiple sections that may be individually plumbed to allow different temperature control zones.

Alternatively, the trough may also contain a gap at the junction with the sidewall resulting in a ‘leaky’ trough that would result in a uniform sheet of liquid forming along the sidewall as it drains from the bottom of the trough. A gap in the trough may be less than 7.5 mm, such as less than 5 mm or less than 3 mm, to enable a thin, uniform flow free of air entrapment. As shown in the drawings, an alternative ‘leaky’ trough may comprise a series of holes in the trough that may also enable a uniform sheet of liquid to form in the inner wall of the vessel and thereby create an evenly wetted surface. A hole of the present embodiment may be 2.5 mm to 15 mm in diameter, more typically 3 mm to 10 mm in diameter, and still more typically 3.1 mm to 6 mm in diameter. The holes may be generally evenly spaced around the circumference of the upper lip of the trough with average spacing with a spacing of 5 mm to 40 mm more typically 10 mm to 30 mm, still more typically approximately 25 mm. The holes may be located an even distance from the top lip of the trough or may be slanted. The holes are typically located at least 10 mm from the top lip, still more typically at least 15 mm from the top lip, and still more typically at least 25 mm from the top lip. A series of slits may alternatively be used or may be used in combination with a series where the slits may be separated or may be connected to form a slit terminated by a circular opening, to further create an evenly wetted surface on the inner wall of the vessel during operation while also enabling variable flow rates as the trough fill level fluctuates. The slits may be below the top lip or may alternatively continue to the top lip and terminate with an open end, thereby forming a ‘comb’ design with open ends facing upward towards the top lip of the trough. The slits may be oriented such that they are parallel to central axis of the tube, or they may be cut at an angle thereby creating a series of overlapping slits. The angle of the slit as measured from the terminal end closest to the top lip of the trough and a line drawn parallel to the central axis may be between 0° to 75°, more typically 0° to 60° and still more typically 0° to 4°. The angled slits may be spaced such that the top of one slit overlaps with the bottom of a second slit as you travel down the trough inner wall along a line parallel to the central axis of the trough. The slits may have a width of 2.5 mm to 15 mm in, more typically 3 to 10 mm, and still more typically 3.1 to 6 mm. The slots may have a length of at least 10 mm, still more typically at least 15 mm, and still more typically at least 25 mm. The slots may be spaced 5 mm to 40 mm more typically 10 to 30 mm, still more typically approximately 25 mm. Angled slits may alternatively be alternating, such that they form triangular sections removed from the top lip.

The inner wall of the vessel may further comprise a textured surface to enhance the wetting and even flow of the falling film. The texture may be ball peened, hammered, or etched, such that the surface comprises a series of ridges and valleys that may direct the angular transition of the fluid across the surface and help promote a continuous wetted surface as the liquid falls along the surface. One benefit of ball peened or hammered surfaces is that they may maintain a fine surface finish and polish while also including bulk surface distortions. As a result, the self-wetting textured surface may still serve as a sanitary surface with relatively few surfaces for harboring food particles and/or bacteria. A ball peened or hammered surface may have a peened surface with average peen diameters ranging from 0.5 mm to 50 mm, more typically 1 to 26 mm in diameter.

In another embodiment, the present invention relates to a method for dehydrating juices, where the juice to be dried or dehydrated is maintained at a relatively low temperature during the dehydration process, so as to retard bacteria growth therein. This may be done by cascading the juice down a chilled interior wall, wherein the wall is connected in thermal communication with a water jacket or the like. The wall, and thus the juice, are maintained at a relatively low temperature, such as between 34 degrees F. and 42 degrees F. (1 degree Celsius to 6 degrees Celsius). Warm dry air is circulated over the surface of the flowing juice sheet or film, as the capacity of dry air to pick up and carry moisture increases with temperature. The warm dry air is maintained at a temperature of between 60- and 115-degrees F. (15 and 46 degrees Celsius). A thermal gradient is maintained between the juice and the dehydrating air during the dehydration process, and the system is in thermal disequilibrium.

In another embodiment, cooling of the liquid being processed may be accomplished by placing a water jacket or like cooling assembly in thermal communication with the produce media. The water jacket may typically circulate water at some reduced temperature, such as 1° C. to 5° C. The dry air circulating over the produce media typically has an RH of about 25% to 55% and may be at any convenient temperature, such as from about 15° C. to 45° C. (more typically at a temperature of at least 20° C.). This method may increase water removal rates by more than 10 times while depressing bacteria growth due to the refrigerated condition of the vessel contents.

The above embodiments may be equally applied to liquid agricultural products (present as, for example, falling films, cooled to 1° C. by thermal communication with a chilling apparatus and wherein the dehydration process gas in thermal communication therewith may be dry air at a temperature of 24° C.) or to solids (agriculture products on a cooling tray with a warm dry air circulated thereover)

In some embodiments, a pump may be used to motivate fluid collected in the vessel under reduced pressure operation to return back to atmospheric environments. Variable displacement pumps including, but not limited to, lobe pumps, screw pumps, gear pumps, diaphragm pumps, and the like, are particularly well suited for such applications; however, they typically have a significantly higher minimum intake pressure than fixed displacement pumps, such as a rotary turbine, in part due to the activation requirements of the pump check valves. While this is not a problem under atmospheric conditions, vacuum conditions remove any available environmental head pressure, leaving the mass of the fluid as the sole source of intake head pressure. In some embodiments of methods disclosed herein, the vacuum output pump is mounted in an inverted fashion, such that the check valves naturally reach an open condition under the assistance of gravity, enabling the check valve mass to aid in the intake pressure activation of the pump, thereby enabling greater throughput and low vacuum vessel level requirements along with significantly reduced vertical displacement relative to the vacuum vessel (a decrease of 1 or more meters of height). While this is effective at initiating the initial chamber intake pressure, this results in a second problem, where the pump output check valves also try to open, thereby removing any head pressure from the pump output. In some embodiments, methods disclosed herein include a second pump manifold that may include a pressure regulator, pressure buffering liner or headspace, and a flow control orifice or valve, to enable the pump output to operate under atmospheric or even elevated pressures without leakage.

Systems of the present technology may be cleaned between production runs using conventional chemical cleaning agents. The low angle spray nozzle of the present technology may be used as a clean-in-place nozzle or may be replaced with a high angle clean in place nozzle to cover a wider process vessel surface area. Cleaning solutions may be added to the mixing vessel and circulated through the process vessel until the surfaces are sufficiently cleaned. The fluid may then be discarded. Pressure sensors, vacuum valves, process dry air lines, and the like may be isolated from the vessel environment by closing valves or removing connections during cleaning to prevent contamination or damage. Process air may then be circulated through the process vessel until conditions are sufficiently dry.

In some embodiments, the present system may operate under ambient atmosphere, or under anaerobic conditions, such as under an inert atmosphere, such as under nitrogen or argon. In some embodiments, the present system may purge the process vessel and lines with a positive pressure of nitrogen while venting to the environment to dilute the ratio of atmosphere to inert gas. In such embodiments, the inert gas may be purged for 10 minutes, 5 minutes, or 3 minutes. Bays or chambers of regenerated media may also be purged with nitrogen prior to enabling communication with the vessel atmosphere. Alternatively, the vessel may be vacuumed and then purged with inert atmosphere to accelerate the process. Under such a process the vessel may be vacuumed to a pressure of less than 60 torr, less than 30 torr, less than 10 torr, or less than 3 torr prior to reintroducing inert atmosphere into the process chamber. A bleed off valve may be used to prevent over pressurization of a vessel during processing.

Another embodiment of the present system may enable the production of food powders with a water activity below 0.30 and a water content less than 10% while retaining the original quantities of sugars, oils, essences, vitamins, and the like found in the source food. Conventional freeze-dried foods and food powders have a water activity less than 0.20, which may be due to the direct vacuum driven sublimation of water, while conventional food powders dried through convection dehydration may have a water activity between 0.4 to 0.75. Unlike freeze dried foods or convection dried foods, foods produced using methods of the disclosure may have a water activity from 0.20 to 0.60, such as from 0.15 to 0.600, from 0.20 to 0.595, from 0.20 to 0.590, from 0.20 to 0.585, from 0.20 to 0.580, from 0.20 to 0.575, from 0.20 to 0.570, from 0.25 to 0.595, from 0.25 to 0.59, from 0.30 to 0.59, from 0.20 to 0.58, from 0.25 to 0.57, from 0.30 to 0.595, from 0.40 to 0.595, from 0.50 to 0.595, from 0.55 to 0.595, or from 0.55 to 0.59, and/or a water content of from 1% to <10%, such as from 2% to 8% or from 2.5% to 7% by weight, where, for compositions having water contents <10% (such as these), water content can be measured by gravimetric methods determining initial and dry weight following thermally assisted dehydration. In some embodiments, methods of the disclosure may be applied to foods to achieve maximum shelf life while retaining sufficient moisture to maintain sorption of the volatile essences. Food products produced under the present method may have enhanced organoleptic properties compared with conventional powdered products, particularly, higher concentrations of volatile food essence. These powders may be held in a first vessel and pumped to a process vessel where they reach an atomizer. The atomizer may then spray a fine mist of the liquid in the vessel under a flow of dry process air and carry it down to a discharge tube where it may be transported to a cyclonic separator or particle filter. The process air may then return to the dryer unit to be redried. Utilizing a closed system would uniquely enable the process vessel to retain volatile flavors typically lost during open system powder production where the air enters the environment once it passes through the food mist. The process may also enable anaerobic conditions to further enhance flavor preservation. Unlike conventional techniques that may use an evaporator to condense water droplets in closed circuit, the present system enables a direct water vapor to solid water transition, thereby removing any detrimental effects caused by flavor absorption and degradation through liquid water interactions. In some embodiments, methods disclosed herein result in products with superior organoleptic properties compared to products of conventional systems, such as products having levels of one or more volatile compounds that are at least as high as the levels of the corresponding one or more volatile compounds in the starting fresh food compositions, that are twice as high as the levels in the starting fresh food composition, or that are three times higher than the levels in the starting fresh food composition, as determined by gas chromatography-mass spectrometry.

In one specific embodiment relates to a method of making maple and other like juice sugars. The sugars fructose, sucrose and maltose will crystallize, while glucose does not. Air bubbles are whipped into the liquid in the horizontal axis while agitation relative to the direction of the pull of gravity yields a waterfall. The air bubbles facilitate nucleation allowing automatic separation of components without the need for mechanical grinding. Small particles are separated from large ones using air as a mechanical separation step, wherein light enough particles are carried out by an air stream. The resultant viscous liquid is dehydrated and allowed to rest to facilitate seed crystallization, after which the resultant mixture may be further dehydrated.

In some embodiments, where a product is dehydrated using a two-vessel batch process, the pressure of the second vessel may be decreased to remove dissolved air, remove partial fermentation byproducts, and/or remove other non-desirable volatile compounds prior to packaging. In some embodiments of this process, the second vessel pressure is decreased to a determined setpoint, and fluid is pumped through the vessel, thereby releasing volatile gases, and then is collected at the bottom of the tank and pumped back to atmospheric pressure where it may be packaged. In some embodiments, this embodiment combining a mixing/monitoring vessel and an evaporator/vacuum vessel in closed circuit uniquely enables food products to dehydrate, mix and allow the end product to rest, outgas, and prepare for packaging.

In another embodiment, the present integrated dehydration system may be used in a method of preserving food compositions (e.g., making raw preserved food compositions), such as jam, fruit-derived concentrate, or the like, where the preserved food compositions have higher concentrations of one or more volatile essences compared to the starting food contents. In embodiments of such a method, the moisture of a process food product is tested to approximately twenty-seven to thirty-three percent. In embodiments of the method, food contents, such as fruit juice contents, may be introduced to a vessel, which may contain a mixing member and/or additional grinding media. The contents may be heated to at least 37° C., such as at least 57° C., or at least 65° C., or less than 95° C., or less than 80° C., to dissolve the sugar and sanitize the fruit contents; then the contents may be dehydrated until a water activity level of 0.75 to 0.85 is reached; then the dehydrated contents may be discharged from vessel to provide the preserved food composition. In some embodiments, the method provides preserved food compositions that retain the original quantities of essences, flavorants, oils, vitamins, sugars, and/or the like found in the initial food contents. Thus, in some embodiments, such a method may not trend toward a specific particle size or reduction using media but rather be used to target a desired consistency and water content in the dehydrated food contents.

In some embodiments of making preserved food compositions, the food contents may alternatively be dehydrated at least partially at lower temperatures than those described above. For example, in some embodiments, food products may be dehydrated at a temperature of from 4° C. to 27° C., such as by rapidly lowering the food content temperature from a temperature of above 57° C. to from 27° C. to 32° C., lowering the temperature at a rate of at least one degree Celsius per minute, dehydrating the food contents in an initial phase for a period of less than three hours, further lowering the food content temperature to a temperature of from 0° C. to 4° C., and further dehydrating the food products in a second phase of the process until the desired food content consistency and specification (e.g., water content) are achieved.

In some embodiments, preserved food compositions have a water activity level of less than 0.60 (such as from 0.50 to 0.60), a water content of from 27% to 33%, and/or a fructose content of at least 55%. In some embodiments, preserved food compositions according to the disclosure are shelf-stable. In some embodiments, preserved food compositions according to the disclosure are non-crystallizing at standard room temperature and pressure.

Volatile flavors in jam typically degrade at temperatures above 65° C. However, in the industry, jams typically are produced at 104° C. to achieve the proper water activity level, which substantially, if not completely, degrades the jam product of volatile flavor compounds. The present disclosure thus provides methods for maintaining flavor compounds of fruit and/or vegetable products that meet sanitation requirements while maintaining these vital flavor compounds.

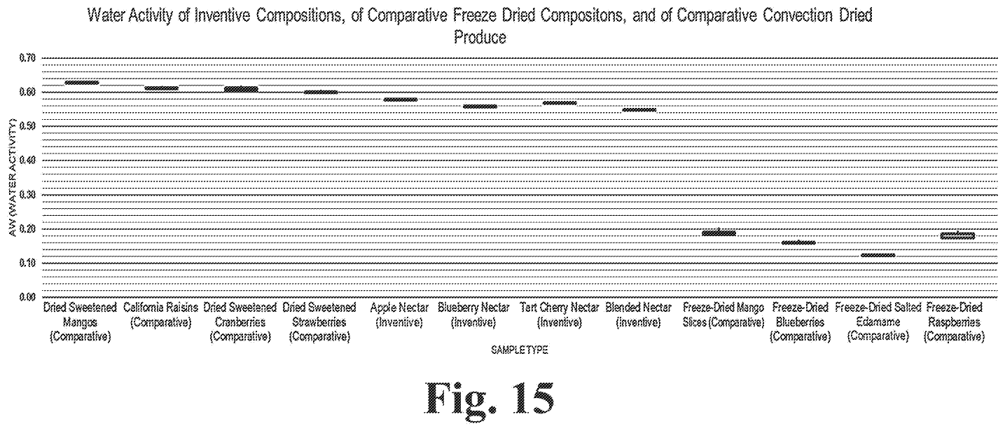

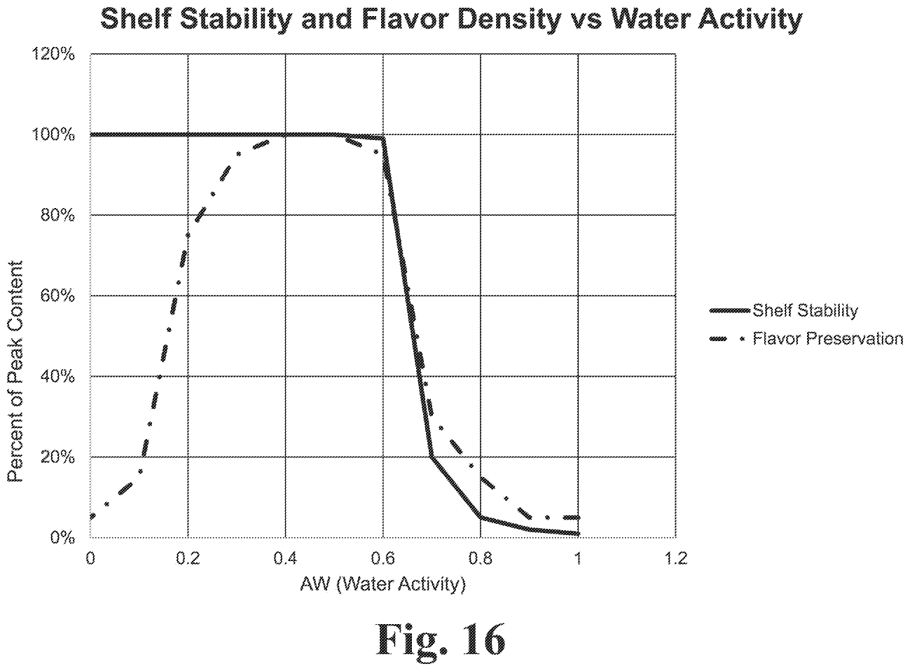

Another embodiment relates to the preservation of agricultural products using the present novel technology. In some embodiments, a fruit, meat or vegetable may be dehydrated in whole form, without disturbing the cuticle. This method may be utilized in the applications of dehydrating leafy green vegetables, herbs, meat and/or spices. In some embodiments, dehydration rates may be limited by cellular membrane and cuticle transport; however, in some embodiments, industrially significant production rates may be achieved for high surface area products without disturbing the basic structure. In some embodiments, the disclosed methods may be applied to dehydrated agricultural products like meat, fruit and/or vegetables. Thus, in some embodiments, the disclosed methods may be employed to dehydrate one or more meat, fruits and/or vegetables to obtain a dehydrated fruit product and/or a dehydrated vegetable product having a water activity of from 0.10 to 0.60, such as from 0.15 to 0.600, from 0.20 to 0.595, from 0.20 to 0.590, from 0.20 to 0.585, from 0.20 to 0.580, from 0.20 to 0.575, from 0.20 to 0.570, from 0.25 to 0.595, from 0.25 to 0.59, from 0.30 to 0.59, from 0.20 to 0.58, from 0.25 to 0.57, from 0.30 to 0.595, from 0.40 to 0.595, from 0.50 to 0.595, from 0.55 to 0.595, or from 0.55 to 0.59. In some embodiments, application of such methods results in a high degree of flavanol retention in a shelf-stable material. For example, it has been determined qualitatively that flavor vapor pressure significantly increases at a water activity of less than 0.20, such as less than 0.15 or less than 0.10. Typical freeze-dried produce may have a water activity of from 0.05 to 0.20 as a result of the vacuum sublimation process. Such freeze-dried produce may suffer from limited flavor content and/or poorer organoleptic qualities compared to starting produce and/or other embodiments of dried produce. Conversely, embodiments of produce dehydrated using methods of the present disclosure exhibit achieve higher flavor content and/or enhanced organoleptic qualities when compared to freeze dried produce. To this end, FIG. 15 depicts the measured water activities of different inventive and comparative food compositions. As shown in FIG. 15, four comparative, conventionally-dried (convention dried) food compositions (Dried Sweetened Mangos, California Raisins, Dried Sweetened Cranberries, and Dried Sweetened Strawberries) had water activities of 0.63, 0.61, 0.61, and 0.60, respectively. As shown in FIG. 15, four comparative, freeze-dried food compositions (Freeze-Dried Mango Slices, Freeze-Dried Blueberries, Freeze-Dried Salted Edamame, and Freeze-Dried Raspberries) had water activities of 0.19, 0.16, 0.12, and 0.19, respectively. As shown in FIG. 15, four inventive examples (Apple Nectar, Blueberry Nectar, Tart Cherry Nectar, and Blended Nectar) had water activities of 0.58, 0.56, 0.57, and 0.55, respectively. The inventive examples are compositions that were dehydrated using methods of the disclosure. For each of the comparative and inventive compositions, water activity was determined using a Rotronic HydroPalm water activity meter at a temperature of 23° C. The reported water activity is the average of three trials. (ROTRONIC is a trademark registered to Rotronic AG Aktiengesellschaft SWITZERLAND Grindelstrasse 6 CH-8303 Bassersdorf SWITZERLAND, registration number 5139539). Thus, FIG. 15 illustrates, methods of the disclosure can be applied to dehydrated food compositions to a water activity that is greater than 0.20 but less than 0.60. In some embodiments, dehydrating food compositions to a water activity that is greater than 0.20 but less than 0.60 is desirable because it provides a food composition that is shelf-stable but preserves the flavor of the starting food composition (e.g., the process retains desirable flavor compounds in organoleptically-desirable amounts). For example, FIG. 16 depicts a graph of water activity versus shelf stability and flavor preservation (expressed as a percent of peak content, where peak content is understood to be the peak concentration of flavor per unit volume). As shown therein, for example, although shelf stability can be maintained when water activity is less than 0.20, flavor preservation decreases when water activity is less than 0.20. As also shown therein, for example, both shelf stability and flavor preservation decrease when water activity is greater than 0.60. Accordingly, in some embodiments, dehydrating a food product (such as meat, fruits and/or vegetables) to a water activity of from 0.20 to 0.60 (as by using methods disclosed herein) is desirable because the process not only yields a product that is shelf-stable but also because the process preserves the flavor of the food product.

In one non-limiting example, carrots may be dehydrated using the present system. Carrots are typically washed, peeled, dried whole, or sliced or diced, and placed in bulk dehydrating vessels, on sheet pans, or in storage bins and dried under recirculating air in communication with a dehydrating component of the present system until the water activity reaches from 0.2 to 0.6, from 0.2 to 0.4, from 0.2 to 0.3, or approximately 0.25. Bulk dehydrating vessels may be fluidized from the inlet air, agitated, or form continuous moving surfaces, such as drums or belts. The dried carrots may then be collected and placed in an airtight container with a solid vapor barrier, such as aluminum foil or glass to ensure stability of volatile compounds. In some embodiments, the volume may decrease by from 70% to 85%, such as by from 70% to 75%, from 70% to 80%, or from 80% to 85%, and the mass may decrease by 90% to 96%.

In another non-limiting example, celery may be dehydrated using the present system. Celery stalks may be separated, washed, dehydrated whole, peeled, sliced, diced, ruffle cut, waffle cut, shredded, macerated, pureed, or the like, and placed in bulk drying vessels, on sheet pans, or in storage bins and dehydrated under recirculating air in communication with a dryer of the present disclosure until the water activity reaches from 0.2 to 0.6, from 0.2 to 0.4, from 0.2 to 0.3, or approximately 0.25. Recirculating air temperatures typically have an inlet air humidity of from −40° C. to −10° C. and a temperature from 10° C. to 46° C., such as from 35° C. to 45° C. The dehydrated produce may then be collected and placed in an airtight container with a solid vapor barrier, such as aluminum foil or glass to ensure stability of volatile compounds. In the present example the volume may decrease by 70% to 85%, such as by from 70% to 75%, from 70% to 80%, or from 80% to 85%, and the mass may decrease by 90% to 96%.

As further non-limiting examples, onions, peppers, such as sweet peppers or jalapeno peppers, turmeric, ginger, lettuce, broccoli, blueberries, grapes, cucumbers, strawberries, kiwi, garlic, sweet potatoes, beets, green beans, coconut flesh, parsnips, shiitake mushrooms, hops, sprouted grains, meat and lentils and the like may similarly be processed, and may result in dehydrated, raw, shelf stable produce with long shelf life and high packing density. If placed in flexible packaging, dehydrated produce may subsequently undergo high pressure pasteurization, UV pasteurization, or irradiation, to further limit biological contamination and increase shelf stability. Fruit nectar may similarly be processed by placing pureed fruit, vegetable, or combinations thereof on nonstick flat surfaces, such as silicone glazed sheet pans, in a uniform layer typically from 1 to 10 mm thick, such as from 2 to 7 mm thick and pass dehydrated air recirculating from the present system over the surface. A rotating drum may also be used to create uniform fruit leathers via multiple passes through a standing puree. Herbs, such as basil, mint, thyme, oregano, cilantro, rosemary, or the like, spices, such as cinnamon, saffron, peppercorns, nutmeg, cloves, cardamom, or the like, and cannabinoid-containing compositions, such as marijuana, hops, hemp, or the like may similarly be processed by placing whole or lightly processed produce in a hermetically sealed vessel in fluidic communication with a drying system of the present disclosure.

In the previous example, ginger root, turmeric, garlic, and the like may be ground and/or powdered and dehydrated under recirculating air in communication with a desiccant dryer of the present disclosure until the water activity reaches from 0.2 to 0.6, from 0.2 to 0.4, from 0.2 to 0.3, or approximately 0.25. Recirculating air temperatures typically have an inlet air humidity of from −40° C. to −10° C. and a temperature from 10° C. to 95° C., such as from 35° C. to 65° C. Monoterpenes remain present in the dried produce at greater than 150 ppm, greater than 200 ppm, greater than 500 ppm, greater than 800 ppm, greater than 1000 ppm, greater than 1500 ppm, greater than 2000 ppm. Citrols remain present in the dried produce at greater than 15 ppm, greater than 150 ppm, greater than 300 ppm, greater than 500 ppm, greater than 600 ppm, greater than 750 ppm.

In the case of ginger dehydrated as detailed above, the resulting single ingredient ginger spice product, as derived from a natural ginger root source without any additives or additional ingredients, is characterized by monoterpenes remaining present at greater than 100 ppm, greater than 150 ppm, greater than 200 ppm, greater than 250 ppm, greater than 300 ppm, greater than 350 ppm, greater than 400 ppm and citrols remaining present at greater than 15 ppm, greater than 50 ppm, greater than 100 ppm, greater than 200 ppm, greater than 300 ppm, greater than 500 ppm. The resultant ginger spice product has a bolder, more vibrant color (bright or even iridescent yellow as opposed to pale yellow or yellow-brown of common commercial ground ginger, and is characterized by RGB values of R of 230, G of 203 and B of 141 and L*a*b values of L of 83, a of 1.834 and b of 35. More broadly, R may range from 225 to 235, G may range from 195 to 210, and B may range from 135 to 145.

The single ingredient ginger spice product is further characterized by an average gingerol content of 4588 μg/g ginger and an average shogaol content of 3203 μg/g ginger, as compared to an average gingerol content of 897 μg/g ginger and an average shogaol content 673 μg/g ginger for fresh ginger and an average gingerol content of 2880 μg/gr ginger and an average shogaol content 1873 μg/g ginger for generic brand ground ginger. In some embodiments, the novel ginger spice product has a 6-gingerol content of 6200 μg/g ginger and a 10-gingerol content of 675 and a 6-shogaol content of 3750 μg/g ginger and a 10-shogaol content of 500 μg/g ginger. More broadly, the total gingerol content may range from 2000 to 8000 μg/g ginger, 3000 to 7000 μg/g ginger, 4000 to 7000 μg/g ginger, 4000 to 6000 μg/g ginger, 4500 to 5500 μg/g ginger. The 6-gingerol content may range from 1500 to 7000 μg/g ginger, 1750 to 6500 μg/g ginger, 2000 to 6000 μg/g ginger, 3500 to 5500 μg/g ginger, 4000 to 5000 μg/g ginger. The 8-gingerol content may range from 400 to 3000 μg/g ginger, 700 to 2750 μg/g ginger, 1000 to 2500 μg/g ginger, 1500 to 2250 μg/g ginger, 1750 to 2000 μg/g ginger. The 10-gingerol content may range from 100 to 700 μg/g ginger, 150 to 600 μg/g ginger, 200 to 550 μg/g ginger, 300 to 500 μg/g ginger, 400 to 450 μg/g ginger. The 6-shogaol content may range from 2000 to 5000 μg/g ginger, 2500 to 4500 μg/g ginger, 3000 to 4000 μg/g ginger, 3250 to 3750 μg/g ginger, 3300 to 3500 μg/g ginger. The 8-shogaol content may range from 100 to 700 μg/g ginger, 200 to 650 μg/g ginger, 300 to 600 μg/g ginger, 350 to 500 μg/g ginger, 400 to 450 μg/g ginger.

In the case of turmeric dehydrated as detailed above, the resulting single ingredient turmeric spice product, as derived from a natural source without any additives or additional ingredients, is characterized by monoterpenes remaining present at greater than 200 ppm, greater than 350 ppm, greater than 500 ppm, greater than 750 ppm, greater than 1000 ppm, greater than 2000 ppm, greater than 3000 ppm and sesquiterpenes remaining present at greater than 200 ppm, greater than 500 ppm, greater than 800 ppm, greater than 1000 ppm, greater than 2000 ppm, greater than 3000 ppm, greater than 5000 ppm.

In other embodiments of drying fruits and/or vegetables using the methods of the disclosure, the cellular cuticle may be disturbed through mechanical disruption, such a puncturing or cutting the surface, chemical disruption, through the addition of a solvent, such as acetic acid, and/or through mechanical expansion, such as freeze cycle or hot fluid perforation techniques. In some embodiments, application of such methods results in a high degree of flavanol retention in a shelf-stable material.

In one embodiment of the present technology cannabis, hops, or the like may be first dehydrated with recirculated air passed over a desiccant dryer, as described in the present invention at a temperature of 18° C. to 40° C. at a dew point of −40° C. to 5° C. for a period of 5 to 40 hours, thereby resulting in a dehydrated product with a water activity at 20° C. of 0.25 to 0.62, more typically 0.30 to 0.55, more typically 0.35 to 0.55. The product may then be rehydrated to a water activity of 0.55 to 0.62 measured at 20° C. by exposing the product dehydrated under the present method to a temperature of 18° C. to 25° C. and a humidity of 50% to 62%, more typically 55% to 60% to produce a product that achieves the same mass, but was able to prevent mold formation due to the rapid dehydrated phase as compared with conventional systems. Airflow rates under the present embodiment may be between 0.2 and 2.0 M/S in a recirculating room.

In one embodiment, cannabis, as well as meats, seeds and other sensitive plant matter, may be dehydrated at refrigerator conditions comprising extracting a parcel of air from a generally closed room, absorbing moisture from the air via a desiccant material, passing the dehydrated air over a heat exchanger between −5° C. and 5° C., and finally returning the parcel of air to the room as cool air with a controlled moisture content. In one embodiment of the present invention, the parcel of air may be split into two parcels, where one parcel passes through the dehydrating media and the other parcel bypasses the dehydrating media, in order to achieve a dewpoint above the thermodynamically driven minimum of the dehydrating media or desiccant, such as −40° C. for a 3 A potassium sodium aluminosilicate molecular sieve. In this embodiment the average dew point of the generally closed room may range from −11° C. to 2° C. with a relative humidity between 55% to 62%. As a result, terpene vapor pressure and case hardening of the leaves during dehydration may be dramatically reduced.

In one embodiment of the present invention the desiccant may be a desiccant wheel, silica gel, or the like, that may achieve the necessary relative humidity; however, these desiccants are known to absorb terpenes and other volatile molecules from the air. In a further embodiment a desiccant with less than 5 A pore size, more typically less than 4 A pore size may be used to selectively absorb water while allowing terpene vapor pressure to climb and reach homeostasis with the material being processed. The present technology is advantageous compared to the prior art in that it enables terpene retention. Terpenes are volatile aromatic compounds that are naturally present in cannabis, are generally desirable in the end product, and help retard the process of case hardening. The novel technology slows down the biological degradation of said terpenes during a 9-day cure phase, thereby resulting in increased terpene retention.

Another embodiment of the present technology involves a method for preventing case hardening in desiccant-dehydrated environments. When drying at high temperatures, the surface of the product may be over-dried while the inside of the product remains wet. Case hardening is another undesirable side effect of conventional drying technologies that typically occurs when drying at high temperatures. Case hardening is characterized by the formation of a microlayer of highly dehydrated skin on the outside of the product, cracking of the product, or both. Case hardening results in degradation of product quality, or in the worst-case scenario, loss of the product. By operating at a lower dewpoint, the novel technology enables cannabis, hops, or the like at temperatures to be dehydrated below 13° C., typically between −1° C. and 7° C., more typically between 1° C. and 7° C., and still more typically between 1.5° C. and 5° C., while maintaining a relative humidity of 60%. Decreasing the moisture level uniformly over time results in a higher quality, uniform product.

In some embodiments, the present novel technology relates to a method and apparatus for preventing case hardening of produce in desiccant dehydrated environments. Case hardening occurs when the outer portion of a piece of dried produce becomes hard, dry and leathery while the inner portion remains soft and moist. While it is generally thought that case hardening is the result of drying the produce at too high a temperature, case hardening results from drying the outer portion or layer of the produce at a rate exceeding the rate of diffusion of moisture from the interior portion to the outer layer, resulting in an overly dried outer layer that increasingly resists diffusion of water therethrough, thus escalating the problem and resulting in a case hardened piece of partially dried produce. According to the present novel technology, case hardening is avoided by cooling the produce during dehydration to allow the diffusion rate of water within the produce to meet or exceed the evaporation rate at which water is removed through the produce surface. Evaporation of water from the produce surface is driven by the circulation of dry air thereover. The produce remains in thermal disequilibrium during dehydration.

In one example, a dehydrating apparatus includes a sealable chamber having an entry port, and exit port, and an interior volume in communication with the entry and exit ports. A water jacket or like cooling device, as described in paragraph 105, is positioned in thermal communication with the chamber and the interior volume. A dry air source is connected in pneumatic communication with the interior volume. The dry air source provides dry air at temperatures below 115° F., typically in the range 30° F. to 115° F., more typically 25° F. to 60° F., 30° F. to 50° F., 32° F. to 45° F., 34° F. to 100° F., and still more typically 34° F. to 41° F. with an RH of less than about 63%, typically 20-63%, more typically 25-60%, and still more typically 30-55%. Humidity variance is typically less than plus or minus 10%, 8%, 5%, 3%, 2% relative humidity.

The dehydrating apparatus further includes sensors, such as moisture, temperature, and RH sensors, operationally connected to the interior volume and to the water jacket, as well as to a microprocessor operationally connected to the water jacket and to the dry air source for controlling the dehydrating operation.

In another embodiment, the present invention relates to a method for dehydrating solid agricultural produce at low temperatures. Similar to the above-described method for preventing case hardening, prepared produce is positioned in a drying chamber or volume that is connected in thermal communication with a cooling device, such as a water jacket. The cooling device is engaged to maintain the produce at a decreased temperature, such as between 34 degrees F. and 45 degrees F., while dry air at a constant temperature, such as between 34- and 55-degrees F., is circulated thereover. Once the produce has dehydrated a predetermined amount, the temperature of the dehydrating air or process gas is raised such that the dry air has a relatively high capacity to hold and carry away water vapor and more quickly complete the dehydrating process, while the produce is maintained at a lower temperature conducive to retention of freshness as well as retardation of bacteria growth and rot.

In another embodiment, the present invention relates to a method for dehydrating hops, seeds, cannabis, and the like at low temperatures. In this embodiment, the produce media to be dehydrated (hops, seeds, cannabis, or the like) is maintained at a constant and relatively low temperature of between about 34 degrees F. and 40 degrees F. while the atmosphere thereabout is maintained at a predetermined constant low humidity, such as by the flow thereover of a dry process gas. The dehydrating process is complete after 5-10 days, while the relatively low temperatures are conducive to the retention of relatively volatile essential oils, terpenes, flavonoids, cannabinoids, and the like.

The above embodiments may be equally applied to liquids (present as, for example, falling films, cooled to 35 degrees F. by thermal communication with a chilling apparatus and wherein the dehydrating process gas in thermal communication therewith may be dry air at a temperature of 75 degrees) or to solids (produce on a cooling tray with warm dry air circulated thereover).

In one embodiment, the present invention relates to a dry air composition including a first quantity of nitrogen a second quantity of oxygen, a third quantity of carbon dioxide, a fourth quantity of water vapor, and a fifth quantity of outgas/vapor generated by dehydrating produce media, wherein the outgas/vapor may include ethyl acetate, essential oils, congeners, and the like and combinations thereof.

In another embodiment, the present invention relates to a method for curing fruits and vegetables at low temperatures. The fruits and/or vegetables (produce) may be dehydrated at ambient temperatures or cooled as described above. Dry air is circulated over the produce, typically having an RH of about 25% to 55% and maintained at any convenient temperature, such as from about 34° F. to 45° F. The curing process is driven by the low moisture content of the circulated air and not by the temperature of the air. The produce or other media to be cured (such as pet food) may be agitated during the curing process, such as being positioned in a rotatable bin, while the dry air is circulated over and throughout the agitated media.

Another embodiment relates to a method for gradually decreasing moisture of seeds and other sensitive products. In this method, seeds to be dehydrated are positioned in a sealable chamber having an entry port, and exit port, and an interior volume in communication with the entry and exit ports. The seeds are maintained at a first temperature of about 10° C. to 15° C. and an atmosphere characterized by a first RH of about 50%-60% for a first period of time of about 1 to 3 hours The seeds are subsequently maintained at a second temperature of about 12° C. and under an atmosphere having an RH of about 55% for a second period of time of about 10 hours. Finally, the seeds are maintained at a temperature of about 10° C. and under an atmosphere having an RH of about 60% for an extended period of time.

In one example seed drying and storage may be greatly improved through the use of the present technology. Seeds are conventionally dried under late season agricultural conditions, where parched plants remove the majority of the seed moisture prior to destemming and collection. In some cases, seeds need further mechanical dehydration prior to storage. Conventionally, seeds are collected and stored in silos, where forced air, often heated to reduce the relative humidity, may be further circulated to decrease moisture. Unfortunately, conventional dehydration means may denature seeds and decrease seed viability due to the hot drying environments. Cell viability may also decrease in under-dried seeds, where elevated moisture content may result in fungal growth, bacterial growth, or premature germination.

Under the present technology seeds may be dehydrated according to the following method. First, seeds, grains, or the like, may be placed in a vessel in fluidic communication with a desiccant dehydration system according to the present technology. Next, air may be conditioned to a temperature of 0° C. to 20° C., more typically 0° C. to 15° C., more typically 0° C. to 10° C., more typically 0° C. to 4° C. with a dewpoint of −15° C. to 10° C., more typically −13° C. to 8° C., more typically −8° C. to 0° C. at an air flow rate of 0.1 to 60, more typically 0.2 to 30, more typically 0.5 to 15, more typically 1 to 10 cubic meter per minute per cubic meter of stored seeds.

Conditions may be maintained under the present method indefinitely to promote seed storage following dehydration. In some cases, temperatures of 10° C. to 20° C. may be used in combination with dewpoints of −8° C. to 0° C. to promote initial dehydration for periods of 6 to 100 hours, more typically 12 to 72 hours, more typically 18 to 36 hours prior to decreasing temperatures to storage conditions. The present method enables dewpoint conditions below the temperatures of conventional operating ranges of vapor-compressor systems, where coils ice over and lose operational efficiency, and may enhance seed germination over conventional methods.

Another embodiment relates to a method of creating an aroma saturated environment during cold dehydration comprising subjecting produce to temperature and atmospheric RH conditions conducive to saturating or nearly saturating the local atmosphere with evolved flavonoids without concurrently saturating the atmosphere with moisture, essentially yielding a water/flavonoid vapor pressure inversion. In other words, the system is maintained outside thermal equilibrium with regards to water and flavonoid kinetics. Even though the flavonoids are more volatile than the water in the produce, there is so much more water present in the produce that even with a large differential in evaporation or evolution rates, substantially more water is evolved into the atmosphere than flavonoids under normal conditions. The RH of dry air circulated over the produce is selected to keep the evaporation of water from the produce into the atmosphere to a minimum, while the temperature of the dry air is selected to urge the flavonoid evaporation into the atmosphere while not urging any appreciable evaporation of water thereinto.

Diced, sliced, or crushed agricultural products may also be dehydrated using methods according to the present disclosure. In some embodiments, samples may be placed on solid sheets, such as PTFE or silicone, open mesh surfaces, such as silicone-coated mesh, wire mesh, expanded nylon, polypropylene mats, and the like, or mechanically suspended, such as skewered or clipped in place. Dehydration may commence in batch-based processors or continuous tunnel processors, until the desired water activity level (from 0.2 to 0.3, such as approximately 0.25) is achieved. In other embodiments, samples may be placed on silicone coated solid or perforated sheet pans.

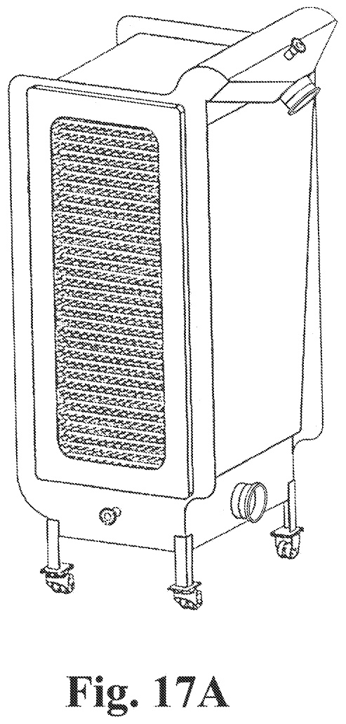

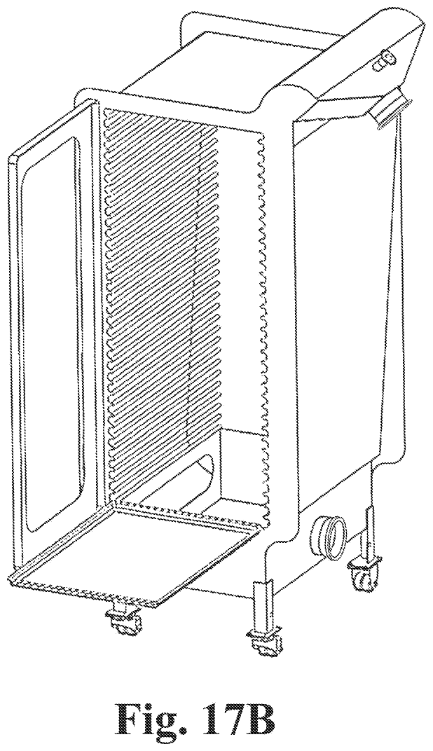

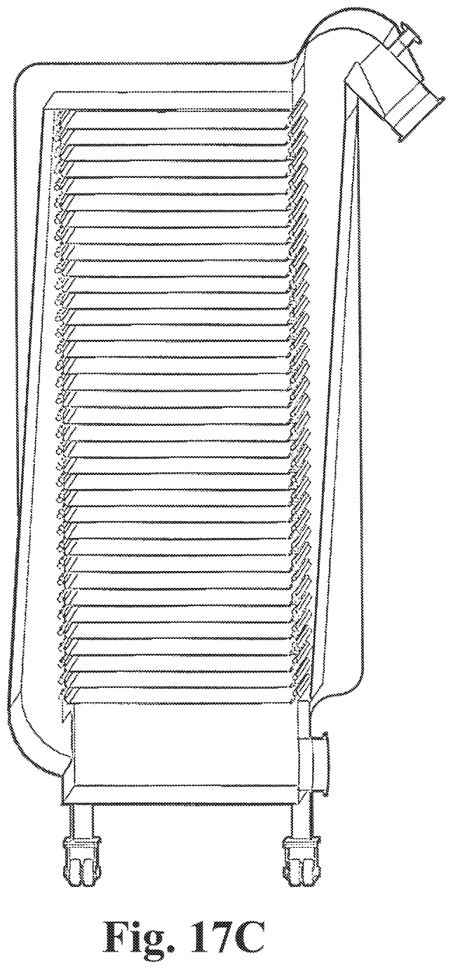

In one embodiment, a laminar flow horizontal box as shown in FIG. 17A-17C may contain a high density of sheet pans and allow even flow horizontally across multiple layers. These sheet pans may be perforated or solid. The horizontal laminar flow enclosure includes a dry process gas (typically air) inlet port fluidically connected to an inlet manifold to guide flowing air into the internal volume. A process gas (typically moist air) outlet port is likewise provided to allow flowing process gas (air) out of the internal volume, with an outlet manifold fluidically connected thereto. A plurality of sheet pans are stacked within the volume and connected in fluidic communication with the inlet and outlet manifolds, such that when the sheet pans are laden with produce to be dehydrated, dry process gas/air flowing across the interior volume from the inlet manifold flows over the laden sheet pans, picks up moisture, and moistened process gas/air flows through to the outlet manifold and out the process gas (air) outlet port. This configuration tends to dehydrate all of the laden produce evenly and at about the same rate. A supplemental recirculation blower may be installed fluidically in parallel to the dehydrating system to further increase airflow rates across the sheet pans while maintaining a constant air speed across the dehydrating media.

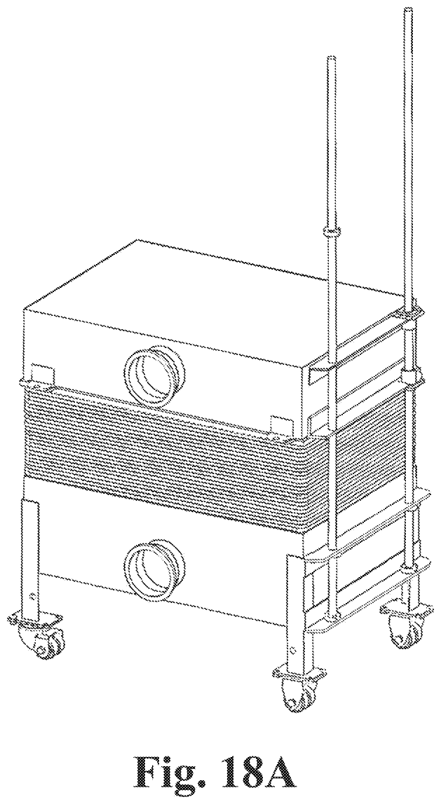

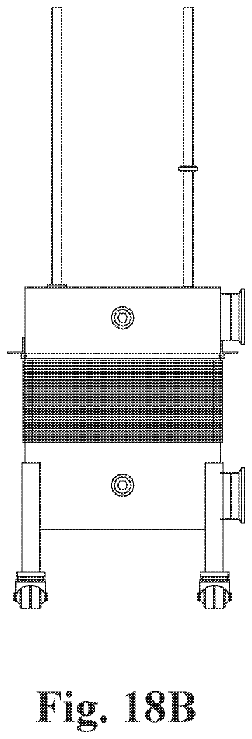

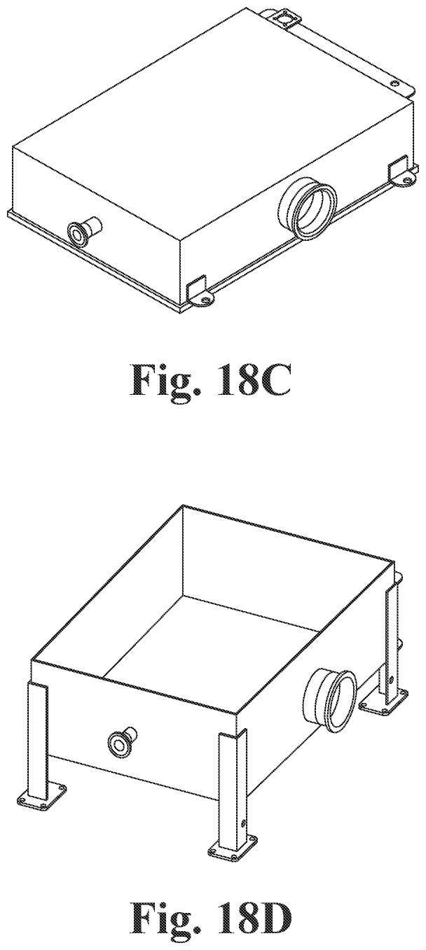

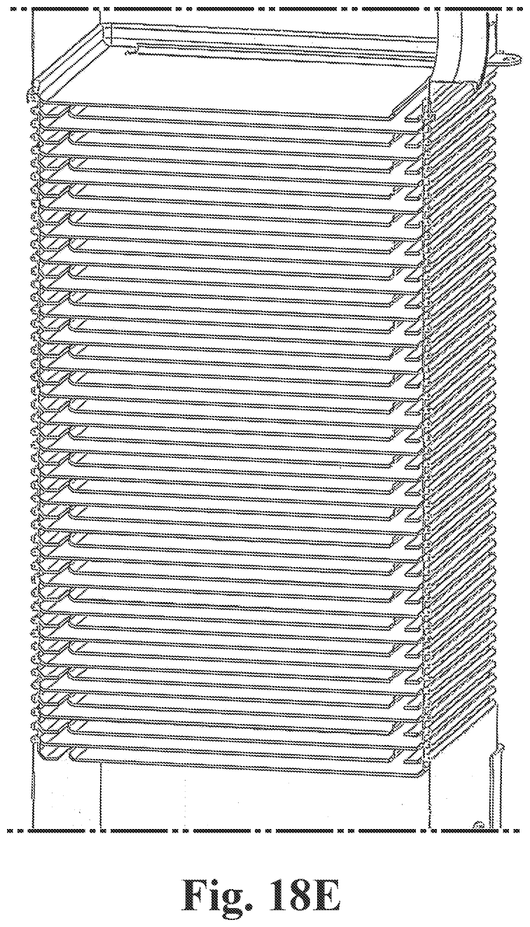

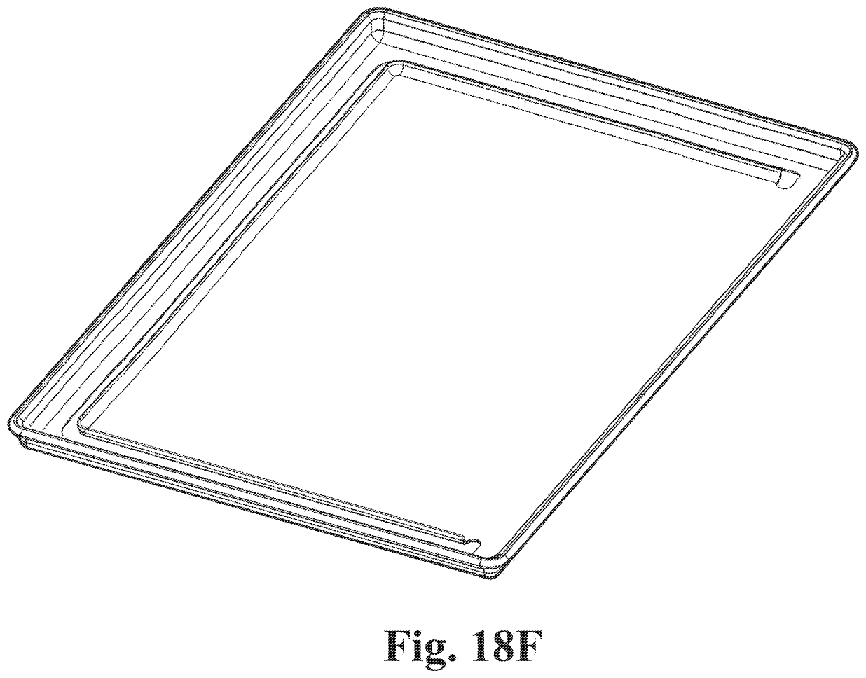

Similarly, produce may be dehydrated in a vertical flow system with a plurality of stacked sheet pans positioned between a bottom plenum and a top plenum, where process dry gas/air travels up from the bottom plenum or down from the top through each perforated layer, resulting in isobaric stages in series, and thereby creating an even gas flow between the layers (see FIGS. 18A-18F). Ruffle cutting or waffle cutting produce filling laden sheet pans may further increase dehydrating rates in an updraft or downdraft embodiment. Louvered trays may enable solid dehydration with a vertical flow if stacked apposing on each layer as the dehydrating gas flows over each pan as it moves from the inlet port to the outlet port. Typically, the sheet pans are removed and reinserted in reverse order (from top to bottom) as the pans closest to the inlet port tend to dehydrate faster than those positioned furthest away therefrom. Alternatively, the airflow rates may be reversed from an updraft to a downdraft to enable even dehydration over a dehydration cycle without removing the trays.

Likewise, the sheet pans may have perforated surfaces such that dry gas/air may flow vertically through the pans from the inlet port, picking up moisture as it progresses to the outlet port. Similarly, the pan orientation should be ‘flipped’ halfway through the dehydration process, or periodically during the dehydration process, to ensure even dehydration of all of the laden produce. Alternatively, the airflow direction may be ‘flipped’ halfway through the dehydration process, or periodically during the dehydration process, to ensure even dehydration of all of the laden produce. This configuration allows a high density of laden produce for dehydration.

In the above examples, the moistened outlet gas may be dehydrated (such as with a desiccant dryer of the present disclosure) and recirculated to the inlet port.

In embodiments of the methods disclosed herein, absorption systems may include one or more containers (to be separated from external environment) having one or more base members, side members, one or more open sides, one or more dividing members, one or more absorption cartridges, one or more cartridge walls, absorption media, one or more lid members, one or more lid gaskets, a container volume, a secondary volume, and/or trays for holding juice.

The one or more containers and/or trays may be constructed of composites, plastics, stainless steel, and or the like, with a base member as a lower face and side members extending therefrom to form sides, leaving open side uncovered and allowing fluidic transmission or communication between external environment and container volume. The one or more open sides may be closed and may be substantially sealed from external environment by placing lid member atop container at open side. In some implementations, the one or more lid members may further have one or more lid gaskets disposed between the one or more lid members and the container to further enable pneumatic sealing between the external environment and the container volume.

In some embodiments, the one or more dividing members may be constructed of similar materials as container and may divide container volume further into a secondary volume. Dividing members may also be vented, ported, and/or otherwise have perforations allowing fluidic exchange between container volume and secondary volume.

The one or more dehydration cartridges may be constructed of similar materials as the container and/or dividing walls, with cartridge walls enclosing and allowing fluidic communication with a quantity of absorption media.

In some embodiments, water from contents which may be located in the container volume may diffuse into air and then into absorption media, which may be within secondary volume. In other implementations, the container volume may encompass the entirety of container interior, omitting the secondary volume, and one or more cartridges may be placed in adjacent trays. In still further implementations, absorbent media may be placed directly into the container volume, omitting the one or more cartridges.

In another embodiment, an active absorption system typically may also have one or more active circulation members and/or latch members. Active circulation members may include, but not are not limited to, one or more fluid moving devices (e.g., fans, blowers, impellers, etc.) to increase fluid circulation within the container. For example, a circulation member may increase fluid flow through one or more dividing members, increase the exposed surface area of juice and/or media, increase the fluid flow through one or more cartridges, and/or the like. Such active flow may increase dehumidification rates and correspondingly decrease time to reaching desired dehumidification thresholds.

In some implementations, for example to increase the holding force between lid and container, one or more latch members may be used. Such latch members may be pivoted down and/or otherwise positively provide interference to hold a lid to the container. In some other implementations, the lid may screw onto the container, be secured using one or more fasteners, and/or otherwise attached to similarly increase the hold between lid and container. Such increased force may be useful where, for example, one or more circulation members and/or one or more recirculation members differentially pressurize the container volume and/or the secondary volume, which may decrease the pneumatic integrity of the container volume and/or the secondary volume.

In some embodiments, a recirculating, bulk absorption system, which may connect to the system via one or more ports (e.g., port members), may be employed. In some embodiments, this recirculating, bulk absorption system may be similar to a recirculating dehydration system. Pneumatic lines (typically known in the art) may connect said ports to an absorption vessel, which may be constructed of composites, plastics, stainless steel, and or the like, and may be pneumatically sealed and/or contain absorbent media and/or one or more cartridges. Some embodiments may include one or more check valves in pneumatic lines to help direct airflow. Moisture-laden air may be drawn from the container volume, passing through pneumatic lines, enter an absorption vessel, pass through absorbent media, wherein absorbent media absorbs the moisture from the air, and then return through pneumatic lines back into the vessel volume. In some embodiments, one or more recirculation members (e.g., one or more blower units, vacuum unit, and/or the like) may be used to pull air through pneumatic lines and/or be used as blower unit to ingress/egress air through pneumatic lines, absorption vessel, and absorbent media. In some embodiments, one or more active circulation members may act as, or in conjunction with, one or more recirculation members. In some embodiments, bypass recirculation blowers may be used to increase the airflow across the product media without adjusting the airflow rate across the absorption media.

In some embodiments, the absorption system also may include absorption media regeneration capabilities. For example, one or more desiccant regeneration methods (e.g., heating absorbent media to vaporize absorbed water, diffusing water via dehumidifier, etc.) may be used to recharge media. In some embodiments, the absorption system may have more than one bay of media in absorption vessel (and/or one or more vessels, each having one or more media bays), which may be actuated between. For example, the system may have a plurality of bays of absorbent media, each bay being selectable via open/close valves, blast gates, electronically actuated gates, and/or the like, where the system allows air to flow through the first bay until the first bay's media is saturated. At this point, the system may close the first bay and open the second bay, while also activating a recharging system in the first bay to desaturate the first bay's media and may then continue through the various bays. Such a system may be scaled (e.g., having two, five, ten, etc. bays/absorption vessels) to maintain saturation and/or recharge rates while keeping air in the container at a sufficiently low water content.

In some embodiments, absorption system and/or media may be manually recharged. For example, as above one or more media bays may be available, and/or one or more media trays may be removable/replaceable. Thus, as one tray is saturated, an operator may halt and/or airflow through vessel(s), remove media tray, place media tray in an oven to recharge media, and then replace recharged media tray into the system. In some embodiments, the vessel may be replaced entirely by disconnecting lines from depleted vessel and then connecting to new vessel.

In some embodiments, one or more air filtration elements may be used to prevent dust and/or debris from exiting absorption vessel and returning to the container to mix with the contents. In some embodiments, such an air filter element may be less than ten micrometers, less than five micrometers, or less than one micrometer for particle size filtration.

In some embodiments, one or more sensors (e.g., airflow sensors, humidity sensors, and/or the like) may be provided to measure airflow, water content, pressure, and/or the like of air flowing through lines, ports, valves, and/or vessel(s). Sensor data may then be used to trigger alarms (e.g., to change media tray, switch media bay actuators, and/or the like), automatically actuate ports/valves, switch to new media, initiate/stop recharging of media, and/or the like. Further non-limiting examples are described elsewhere in this application.

In some embodiments, airflow and moisture absorption typically may be correlated with the rate of moisture release from contents during processing. For example, as a particular herb is dehydrated at a linear rate, thus allowing the system to be sized and/or regenerated accordingly. In other implementations, the rate of dehumidification may exponentially decrease over time, and thus the system may be alternatively sized and/or regenerated accordingly.

In some embodiments, a regenerative system may include one or more regeneration units, media volume, one or more input valves, one or more exhaust valves, one or more output valves, one or more exhaust members, one or more filter members, and/or one or more access panels. The system may exist as an individual regenerative system or as a multiple regenerative system design.

Lines typically may be securely connected to valves, in fluid-tight connections as known in the art. Input valve typically may allow multiple directions of egress for incoming air from line (e.g., to media in media volume, to vessel, etc.), exhaust valve typically may receive multiple air ingress paths (e.g., from media volume, from vessel, etc.), and output valve typically may receive multiple air ingress paths (e.g., from media volume, from vessel, etc.). However, in other embodiments, valves may be otherwise configured. Vessel typically may be substantially fluid-tight except for input valve, output valve, and exhaust valve, which typically may be substantially fluid-tight when in a closed position. In some implementations, exhaust member may be fitted to or with exhaust valve to direct, diffuse, flow, and/or otherwise divert flow.

Filter members may include, but are not limited to, one or more air filters located before and/or after media to remove airborne particulates and/or media, which typically may extend the life of media, decrease maintenance, and/or maintain contents integrity. As above, in some embodiments, such filters may be less than ten micrometers, less than five micrometers, or less than one micrometer for particle size filtration.

An access panel may comprise one or more removable panels in a vessel to allow access to media, volume, and/or regeneration units. Panels may maintain a substantially airtight seal when in place, for example using one or more gaskets and/or retainer structures. Panels then may be removed for servicing system, in some implementations using locking retainers or the like, and replaced once serviced.

A regenerative system may be similar to a bulk recirculating system, but wherein media regeneration is further accomplished using one or more regeneration units in media volume. Lines may connect the system to the vessel and use one or more input valves to direct incoming air through the vessel and/or media volume. Air may then pass dried through output valve and into line back to container, and/or undried through vessel, output valve, and line before returning to the container.

In some embodiments, an input valve may direct air either fully into media volume or fully into vessel; however, in some implementations, partial flow redirection (i.e., where some air passes through media volume and where the rest passes undried through vessel) may be used when, for example, full humidification may overly dehydrate air, may outpace water output of juice contents, and/or the like.

When media is being used to dry incoming air, one or more input valves may allow air to pass through line, through media in media volume, and out through output valve. When media is saturated and/or media volume otherwise bypassed, one or more input valves typically may allow air to pass through vessel (i.e., around media area), and out through output valve. In some implementations, air may also be diverted from vessel and out exhaust valve and/or exhaust member as well. During such bypass operations, media may be removed, replaced, and/or otherwise maintained from media volume, which may be accessible through one or more access panels on vessel.

In some embodiments, when media is undergoing regeneration, one or more regeneration units may increase in temperature and raise the temperature of media and media volume above a desired temperature threshold. The increase in heat may then cause the saturated media to release the absorbed moisture into the media volume and then out through exhaust valve and/or exhaust member. One or more valves may be opened to the external environment upon the start of the regeneration process; however, in other implementations, one or more valves may be opened during the regeneration process (e.g., once temperature threshold is reached).

In some embodiments, regeneration may continue for a set period of time (e.g., where regeneration time is a known value) and then one or more valves may close, substantially sealing media volume from external environment, while in other embodiments, one or more sensors (humidistat, air flow sensors, thermostat, etc.) may be used to sense the dehumidification of media and control the regeneration unit, valves and, and/or the like. For example, sensors may detect humidity above a threshold (e.g., seventy-five percent, ninety percent, ninety-nine percent, etc.) and close one or more input valves. One or more regeneration units then may energize and begin heating up to a desired temperature threshold, and once sensor detects that desired temperature has been reached, one or more exhaust valves may be opened. Then, once one or more sensors detects that humidity has reached a floor threshold (e.g., zero percent, ten percent, twenty-five percent, etc.), the one or more regenerations unit may shut off, the one or more exhaust valves may close, and the one or more input valves may again open (and/or once sensor returns to operating temperatures, so as to not add excess heat to contents). Alternatively, one or more exhaust valves may open as soon as one or more input valves closes. In some further embodiments, some air may enter through an input valve while media is being regenerated to provide active air flow, while in other embodiments, regeneration may expel air through exhaust valves by thermal convection (e.g., using fluid bypass in a valve, using a concentric exhaust valve or exhaust member, and/or the like).

In some embodiments, a multiple regeneration design may be employed, wherein the multiple regeneration design comprises multiple regenerating systems, such as a first system, a second system, a third system, and a fourth system, where each system may be independently controllable. In such a design, air may be directed through every bay, a single bay, and/or any subset thereof.

In some embodiments, in operation, a bay may open its input valve and output valve, while the bays remain closed. Air may flow through the input valve, drying through media, and exiting through the output valve before returning to the container. Once bay media is saturated to a threshold level, input valve and output valve may close, exhaust valve may open, regeneration unit may energize, and regeneration of media may commence. At substantially the same time as a bay closes its valves, the bay may open its input valve and output valve to continue dehumidification while bay regenerates. Thus, a constant dehumidification process may be achieved, and the number of bays, volume of media, air flow rates, and/or the like may be tuned to optimize humidity removal and consistency.

In some embodiments, one or more bays may be opened through access panels to remove and/or replace media, service regeneration unit, and/or the like. For example, where one or more bays do not have a regeneration unit, media may be removed, regenerated in an external regeneration unit, and then returned to the bay for continued service.

Compared to methods that dry under heat and/or vacuum, as discussed above, embodiments of products output through methods disclosed herein, such as fruit juice concentrates, may be of much higher quality and far more representative of the input product than products obtained through other methods. In some embodiments, this may result because methods of the present disclosure do not drive off volatiles and/or scorch the food contents resulting, in some embodiments, enhanced organoleptic properties such as brighter, more concentrated flavor peak and a fresher and/or cleaner product finish with a minimal taste of caramelization or oxidation byproducts. In some embodiments, reintroduction of the removed water volume, with or without agitation, may be performed to reconstitute the original juice. Unlike conventional condensed and reconstituted juices, embodiments of reconstituted juice produced according to the present disclosure may retain one or more agents selected from vitamins, sugars, salts, acids, oils, and flavor essences in amounts equal to, or substantially equal, to the amounts at which the one or more agents were present in the fruit juice from which the fruit juice concentrate was derived. Thus, in some embodiments, the reconstituted juice is compositionally and/or organoleptically identical to or is compositionally and/or organoleptically substantially similar to, the original juice, without the need to be fortified and/or enriched with additions of flavorants, essences, oils, vitamins, sugars, salts, acids, and/or the like.

Additionally, in the case of conventional systems and methods using a vacuum to extract moisture, such vacuum removal may also act to simultaneously extract some of the desirable volatile compounds from contents, rather than only the moisture as occurs in embodiments of the methods of the present disclosure. Embodiments of the system of the present disclosure, conversely, may often operate at or near atmospheric pressure in order to reduce the diffusion of volatiles from contents under vacuum. Operating at or near atmospheric pressure typically may allow a relatively predictable rate of diffusion from contents into the fluid stream (e.g., a gaseous stream), and then into absorption media, while maintaining substantially all of the volatile compounds and characteristics of contents.

In some embodiments, such as where extra retention of volatiles from contents may be desired (e.g., exceptionally high-quality goods, very subtle/delicate volatiles, etc.), a system may be operated at a pressure above atmospheric pressure, such as from 761 to 1,500 torr, from 760 to 2,000 torr, from 760 to 3,000, or from 760 to 4,000 torr, to further reduce loss of volatiles from contents. Embodiments of such a configuration may limit diffusion of both moisture and volatiles from contents into the diffusing fluid (i.e., moving air in this instance) by driving moisture and volatiles into contents using the higher pressure and simultaneously reducing egress of the same. For what small amount of diffusive egress still may occur, the diffusive fluid may rapidly reach saturation of both the volatiles and moisture, thus resulting in net zero further diffusion once saturation is reached. However, due to the absorption media selectively removing the moisture (and leaving the volatiles), with the fluid flowing through the one or more input valves having a higher water content and the fluid leaving through the one or more output valves having a lower water content (due to flowing past absorption media), moisture may constantly be removed from the fluid and the fluid's moisture saturation point may never be reached, resulting in continual removal of moisture without any significant removal of volatiles from contents. Thus, embodiments of the system may further preserve the integrity and quality of contents through the dehydration process far greater than any current systems or methods.

In some embodiments, operation of a passive container or of an active container may comprise placing absorption media and juice contents in a container, energizing one or more circulation members (if equipped), sealing a container open side with a lid, allowing moisture of the contents to be absorbed by absorption media, replacing media if it becomes saturated and/or if the contents are not at a desired humidity threshold, and/or removing dehydrated contents from the container once the desired humidity threshold is reached. In some embodiments, dehumidification/dehydration of the juice content is conducted at ambient atmospheric pressure and room temperature, without additional heating and/or the application of vacuum. In some embodiments, dehumidification/dehydration of the juice content is conducted at reduced atmospheric pressure and/or elevated temperature, with the use of heat and/or the application of vacuum.

In some instances, a recirculating embodiment may include placing contents in a container and sealing the container with a lid, placing absorption media in an absorption vessel and sealing the absorption vessel, connecting the container to the absorption vessel with one or more pneumatic lines, energizing one or more recirculation members and allowing moisture of the contents to be absorbed by the absorption media, replacing media if it becomes saturated and/or the contents are not at a desired humidity threshold, and/or removing dehydrated contents from the container once the desired humidity threshold is reached.

In some instances, a regenerating recirculation embodiment may include placing contents in a container and sealing the container with a lid, placing absorption media in an absorption vessel and sealing the absorption vessel, connecting the container to the vessel using one or more pneumatic lines, energizing one or more recirculation members and allowing moisture of contents to be absorbed by absorption media, optionally switching to unsaturated media for saturated media if the media are saturated and the contents are not at a desired humidity threshold, and/or removing dehydrated contents from container once they reach a desired humidity threshold step.

In some embodiments, system components and/or subsets thereof described herein may be made available as one or more kits. For example, such kits may include container(s), dividing members, cartridges, absorption media, gaskets, contents, recirculation system, ports, lines, check valves, absorption vessels, recirculation units, bulk regenerating system, regeneration unit, sensors, valves exhaust member, filters, access panels, and/or the like.

In some embodiments, the above batch embodiment configurations may be adapted to run a continuous flow dehydrating/concentrating process by separating the treated food product (e.g., juice) by density and pumping out the densest portion from the bottom of the chamber into a separate system for continued processing. This separation process may be repeated several times until the densest portion pumped out of the last system in the chain has the desired density, viscosity, water activity, Brix degree, and/or other parameter for harvesting. Density gradients of juice with a variation of water content may also be assisted using by placing the food product through a rotational or centrifugation step. This process may be implemented in batch or continuous configurations.

Process control may be conducted on any of the above systems such as by periodically extracting a small sample of the juice content for measurement of water activity/water content, Brix number, and/or the like. Air flow, dehydration media replacement/recharging, treatment time remaining and like factors may be adjusted based on the measurements taken.

The fruit concentrate produced as described herein is shelf-stable and may be stored in any convenient containers, such as bottles, jars, barrels, or the like. In some embodiments, the present disclosure relates to a flexible individual serving pouch or packet system for containing and delivering fruit concentrate. The pouch system includes elongated, generally rectangular front and rear panels joined together at top, bottom, and side seals to define an internal containment volume. In some embodiments, one or more tear notches are formed through side seal(s) to act as stress concentrators for starting and directing a tear opening at or near the top seal. The tear notches do not intrude into the pouch interior product volume. In some embodiments, the sides are heat sealed together to define a seal width of, for example, from 3.175 to 9.525 millimeters (mm). In some embodiments, a packet may also include a partially perforated or otherwise weakened seam across a corner of the pouch to, once torn, define a pour spout. Thus, in some embodiments, actuation of a weakened tear notch produces a pour spout through which viscous shelf-stable fruit juice concentrate may be extracted from the pouch. However, this pre-weakened seam is not a necessary requirement and is sometimes used to simply define the shortest tear path between notches. In some embodiments, the pouch has a generally rectangular shape narrowing tail extending therefrom and in others, the pouch has a circular shape. In some embodiments, the pouch may have a predetermined geometric shape, such as a circle, a square, a rectangle, a triangle, a right circular cylinder, or the like.

In some embodiments, a pouch is made of a flexible, multilayer foil and/or film material, and may include an outer layer (such as PET (polyethylene terephthalate), polyester (e.g., coated polyester or the like) that is typically transparent, at least one binding layer (such as LDPE (low-density polyethylene), HPC (hydroxypropyl cellulose), EAA (ethyl acetoacetate), or the like) that may be printable (e.g., through an offset printing process) and/or have a white, transparent, natural, or colored background, a vapor barrier layer (e.g., a metal foil vapor barrier layer, such as aluminum foil, steel foil, copper foil, metal foil, or the like) for preventing loss of flavor by outgassing, dissolution, and/or like mechanism, and an inner layer (such as LLDPE (linear low-density polyethylene), nylon EVOH (ethylene vinyl alcohol), coex film, HDPE (high density polyethylene), EVA (ethylene vinyl acetate), metallocene, MDPE (medium density polyethylene), VLDPE (very low density polyethylene), LDPE (low density polyethylene, or the like) for directly contacting fruit concentrate, such as a layer of a low friction or high-slip film. This inner layer may also be referred to as an inner food contact layer. In some cases, low permeability vapor barriers, such as aluminized polyester may be used as barriers for low volatility products. Juice concentrate filling the inner volume is typically present as a liquid state. In some embodiments, the vapor barrier layer is disposed between the inner and outer layers. In some embodiments, the vapor barrier layer is disposed between the inner and outer layers and is a metal foil vapor barrier layer. In some embodiments, each of the outer layer, the inner food contact layer, the binding layer, and the vapor barrier layer are made of different materials. In some embodiments, each of the outer layer, the inner food contact layer, the binding layer, and the vapor barrier layer are made of the same material. In some embodiments, each of the outer layer, the inner food contact layer, the binding layer, and the vapor barrier layer are all made of aluminum. In some embodiments, the pouch is generally flat. In some embodiments, pouches containing food products with a water activity from, for example, 0.2 to 0.6, may further undergo high pressure pasteurization after being sealed in a pouch to further reduce and denature biological contaminants.

Juice concentrate contained in a pouch may be served in the concentrated viscous format or may be rehydrated to approximate its original juice format. For service of either format, the pouch may simply be torn open, such as along a predetermined solid access line, such as by applying torsional forces to the tear notch(es). The access line is typically positioned at a location of optimum cross-sectional opening within an extraction direction so as to enable the contents of the pouch to be easily removed without interference.

For reconstituted juice service, the contents of the pouch may be mixed with an appropriate volume of water and stirred or agitated until the contents are fully homogenized.

In some embodiments, a pouch is formed as a sachet, insofar as the seals operate to manage the tension on the panels to maintain the flat, rectangular shape of the packet when filled with fruit concentrate and to maximize the sachet surface area. The sachet is typically prepared in a ‘form, fill, and seal’ operation, more typically under an inert atmosphere, such as positive pressure N2, to yield fruit juice concentrate filled and sealed sachets. However, the pouch may have any other convenient shape, such as shown in the drawings, or such as cylindrical, if a single side seal is opted. In some embodiments, the sachet is generally flat.

In some embodiments, a sachet comprises a first multilayered sheet of a predetermined geometric shape sealed to a second identically shaped sheet to yield a deformable fluid-tight sachet defining an internal volume and an outer edge separating the internal volume from its external environment. In some embodiments, each of the first and second sheets comprises an inner food contact layer, an outer later, at least one binding layer, and a vapor barrier layer as described elsewhere herein. In some embodiments, each of the first and second sheets comprises an inner food contact layer, an outer later, at least one binding layer disposed between the inner and outer layers, and a vapor barrier layer as described elsewhere herein, where each layer in each sheet is the same or different from the corresponding layer in the other sheet. In some embodiments, each such vapor barrier layer is a metal foil vapor barrier layer. In some embodiments, in each of the first and second sheets, each layer is made of the same material. In some embodiments, in each of the first and second sheets, each layer is made of aluminum.

As discussed elsewhere herein, in some embodiments, a pouch or sachet comprises one or more tear notches. In some embodiments, a pouch or sachet comprises a first tear notch formed through an outer edge of the sachet that separates the internal volume from the external environment. In some embodiments, a pouch or sachet further comprises a second tear notch formed through the outer edge and spaced from the first tear notch. In some embodiments, a pouch or sachet further comprises a first weakened tear strip extending between the first tear notch and the second tear notch.

Additional single-serving pouch shapes, such as a stick packs or tetrahedron pouches, or multiple serving pouches, such as spouted pouches or bulk pack bags, may also be used to selectively dispense fruit juice concentrate of the present disclosure. While stick pouches may be formed on vertical form, fill, and seal systems, and may enable greater surface area to volume ratios thereby enhancing the utilization of packaging materials, most multi-serving pouches may be constructed as pre-formed pouches and may be filled either directly through the nozzle, or alternatively through a portion of unsealed film, which may then be sealed following filling. In the case of nozzle filling a vacuum may be applied to the pouch prior to filling, thereby removing excess headspace in the pouch resulting in high shelf life and low oxidation.

In the case of a multiple-serving pouch, the contents may be dispensed manually, pneumatically, or through mechanical depression of the vessel walls. Nozzles may contain non-drip tips, such as silicone cross-slit valves or peristaltic valves, to limit atmospheric exposure to remaining pouch contents. These pouches are typically between 0.1 and 3.5 L in internal volume, while bulk pouches may be 3.5 L to 1,000 L. In another embodiment of the present disclosure, a food-safe drum, such as a 5-gallon pail (approximately 19 L) or a 55-gallon drum (approximately 208 L), or a non-refrigerated tanker truck, such as a 30,000-gallon (approximately 113,562 L) tanker truck, may be used to store concentrated juice with a water activity of less than 0.60 under ambient temperatures without organoleptic degradation. The drum may be made of a solid vapor barrier and may be constructed as a reusable vessel.

In some embodiments, a serving of juice may be provided by partially sealing two multilayer sheets together to yield an open enclosure. The open enclosure is filled with a sufficient amount of fruit juice concentrate to yield a predetermined volume of reconstituted juice (such as, for example, 8 ounces), typically under an inert atmosphere. The two multilayer sheets are completed sealed together to fully enclose the fruit juice concentrate, yielding a sachet containing sufficient fruit juice concentrate to be reconstituted with added water to yield reconstituted fruit juice. For example, the open enclosure may be filled with a sufficient amount of fruit juice concentrate to provide, upon reconstitution with added water, at least one serving of reconstituted fruit juice, such as one serving, two servings, three servings, four servings, five servings, six servings, seven servings, eight servings, nine servings, or ten servings. The sachet is then transported (e.g., to a purchaser) at ambient temperature. In some embodiments, the fruit juice concentrate filled sachet is shelf-stable at ambient temperature for at least one year, at least three years, at least five years, at least seven years, or at least ten years.

In some embodiments, the pouch measures 130 mm by 65 mm by 5 mm, where the thickness refers to the thickness when filled with fruit juice concentrate within the fill volume. In some embodiments, the pouch measures from 70 to 200 mm in length and from 30 to 90 mm in width, with a thickness between 2 and 8 mm when filled. In some embodiments, the pouch shape, dimensions, thickness, and layer arrangement may be varied as desired.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may typically be integrated together in a single product or packaged into multiple products.

TABLE 1
Measured color data and associated conversion to RGB for reference

| | Commercial Ground | | | | Commercial Selection | | | | TEF Ground | | | |
|---|---|---|---|---|---|---|---|---|---|---|---|---|
| | Ginger 1 | | | | Ginger 2 | | | | Ginger | | | |
| Test 1 | L- | 53.63 | R- | 158.6 | L- | 48 | R- | 141.9 | L- | 83.36 | R- | 229.9 |
| | a- | 9.18 | G- | 121.2 | a- | 8.69 | G- | 107.5 | a- | 1.71 | G- | 204.5 |
| | b- | 28.63 | B- | 79.1 | b- | 26.84 | B- | 68.9 | b- | 35.32 | B- | 141.2 |
| Test 2 | L- | 53.72 | R- | 158.8 | L- | 47.87 | R- | 141.6 | L- | 82.89 | R- | 232.9 |
| | a- | 9.15 | G- | 121.5 | a- | 8.74 | G- | 107.2 | a- | 1.94 | G- | 203.1 |
| | b- | 28.59 | B- | 79.4 | b- | 26.78 | B- | 68.7 | b- | 35.22 | B- | 140.2 |
| Test 3 | L- | 53.7 | R- | 158.7 | L- | 47.85 | R- | 141.4 | L- | 82.78 | R- | 232.2 |
| | a- | 9.13 | G- | 121.4 | a- | 8.68 | G- | 107.2 | a- | 1.87 | G- | 202.9 |
| | b- | 28.59 | B- | 79.3 | b- | 26.66 | B- | 68.8 | b- | 34.64 | B- | 141.0 |

Thus, while the disclosure has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A single ingredient dehydrated spice, comprising:
a monoterpene level of greater than 100 ppm; and
a water activity of 0.2-0.6;
wherein the spice is selected from the group consisting of ginger, turmeric, and garlic.

2. The single ingredient dehydrated spice of claim 1 wherein the monoterpene level of greater than 300 ppm and wherein the water activity is 0.2-0.3.

3. A single ingredient dehydrated ginger spice, comprising:
a monoterpene level of greater than 250 ppm; and a water activity of 0.2-0.3.

4. The single ingredient dehydrated ginger spice of claim 3, wherein the monoterpene level is greater than 500 ppm; and wherein the water activity is 0.25.

5. The single ingredient dehydrated ginger spice of claim 3, wherein the color is bright yellow characterized by R of about 230, G of about 203 and B of about 141.

6. The single ingredient dehydrated ginger spice of claim 4, wherein the color is bright yellow characterized by R of about 230, G of about 203 and B of about 141.

7. The single ingredient dehydrated ginger spice of claim 3, wherein the color is bright yellow characterized by R of 225 to 235, G of 195 to 210 and B of 135 to 145.

8. The single ingredient dehydrated ginger spice of claim 3 and further comprising a gingerol content of 4590 μg/gr ginger and a shogaol content of 3200 μg/gr ginger.

9. The single ingredient dehydrated ginger spice of claim 3 and further comprising a 6-gingerol content of 6200 μg/gr ginger, a 10-gingerol content of 675, a 6-shogaol content of 3750 μg/gr ginger, and a 10-shogaol content of 500 μg/gr ginger.

10. A single ingredient dehydrated ginger spice, comprising:
a monoterpene level of greater than 250 ppm; a water activity of 0.2-0.3; a gingerol content greater than 4590 μg/gr ginger, and a shogaol content greater than 3200 μg/gr ginger.

11. The single ingredient dehydrated ginger spice of claim 10 and further comprising a 6-gingerol content greater than 6200 μg/gr ginger, a 10-gingerol content greater than 675, a 6-shogaol content greater than 3750 μg/gr ginger, and a 10-shogaol content greater than 500 μg/gr ginger.
